(19) United States
(12) Patent Application Publication
(10) Pub. No.: US 2013/0117111 A1
(43) Pub. Date: May 9, 2013

(54) COMMERCIALIZATION OPPORTUNITIES FOR INFORMATIONAL SEARCHING IN A GESTURE-BASED USER INTERFACE

(71) Applicants: Matthew G. Dyor, Bellevue, WA (US); Royce A. Levien, Lexington, MA (US); Richard T. Lord, Tacoma, WA (US); Robert W. Lord, Seattle, WA (US); Mark A. Malmud, Seattle, WA (US); Xuedong Huang, Bellevue, WA (US); Marc E. Davis, San Francisco, CA (US)

(72) Inventors: Matthew G. Dyor, Bellevue, WA (US); Royce A. Levien, Lexington, MA (US); Richard T. Lord, Tacoma, WA (US); Robert W. Lord, Seattle, WA (US); Mark A. Malmud, Seattle, WA (US); Xuedong Huang, Bellevue, WA (US); Marc E. Davis, San Francisco, CA (US)

(21) Appl. No.: 13/601,910

(22) Filed: Aug. 31, 2012

Related U.S. Application Data
(63) Continuation-in-part of application No. 13/251,046, filed on Sep. 30, 2011.
Application No. 13/251,046 is a continuation-in-part of application No. 13/269,466, filed on Oct. 7, 2011.
Application No. 13/269,466 is a continuation-in-part of application No. 13/278,680, filed on Oct. 21, 2011.
Application No. 13/278,680 is a continuation-in-part of application No. 13/284,673, filed on Oct. 28, 2011.
Application No. 13/284,673 is a continuation-in-part of application No. 13/284,688, filed on Oct. 28, 2011.
Application No. 13/284,688 is a continuation-in-part of application No. 13/330,371, filed on Dec. 19, 2011.
Application No. 13/330,371 is a continuation-in-part of application No. 13/361,126, filed on Jan. 30, 2012.
Application No. 13/361,126 is a continuation-in-part of application No. 13/595,827, filed on Aug. 27, 2012.
Application No. 13/595,827 is a continuation-in-part of application No. 13/598,475, filed on Aug. 29, 2012.

(51) Int. Cl. G06F 3/01; G06Q 30/02

(52) U.S. Cl. 705/14.54; 715/760; 705/26.1

(57) ABSTRACT

Methods, systems, and techniques for presenting sponsor supplied content associated with commercial opportunities in a gesture-based user interface are provided. Example embodiments provide a Gesture Based Content Presentation System (GBCPS), which enables a gesture-based user interface to determine and present sponsor supplied content associated with an opportunity for commercialization related to a portion of electronic input that has been indicated by a received gesture. In overview, the GBCPS allows a portion (e.g., an area, part, etc.) of electronically presented content to be dynamically indicated by a gesture. The GBCPS examines the indicated portion in conjunction with possibly a set of (e.g., one or more) factors to determine which sponsor supplied content associated with an opportunity for commercialization to present. Once the sponsor supplied content associated with an opportunity for commercialization is determined, it is then presented to the user in conjunction with the indicated topic, object, and/or action.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

### RELATED APPLICATIONS

For purposes of the USPTO extra-statutory requirements, the present application constitutes a continuation-in-part of U.S. patent application Ser. No. 13/251,046, entitled GESTURE BASED NAVIGATION TO AUXILIARY CONTENT, filed 30 Sep. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/269,466, entitled PERSISTENT GESTURELETS, filed 7 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/278,680, entitled GESTURE BASED CONTEXT MENUS, filed 21 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/284,673, entitled GESTURE BASED SEARCH SYSTEM, filed 28 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/284,688, entitled GESTURE BASED NAVIGATION SYSTEM, filed 28 Oct. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/330,371, entitled PRESENTING AUXILIARY CONTENT IN A GESTURE-BASED SYSTEM, filed 19 Dec. 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/361,126, entitled PRESENTING OPPORTUNITIES FOR COMMERCIALIZATION IN A GESTURE BASED USER INTERFACE, filed 30 Jan. 2012, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/595,827, entitled OFFERING OCCASIONS FOR OPPORTUNITIES FOR COMMERCIALIZATION IN A GESTURE-BASED USER INTERFACE, filed 27 Aug. 2012, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/598,475, entitled ANALYZING AND DISTRIBUTING BROWSING FUTURES IN A GESTURE BASED USER INTERFACE, filed 29 Aug. 2012, which is currently co-pending, or is an application of which a currently co-pending application is entitled to the benefit of the filing date.

### TECHNICAL FIELD

The present disclosure relates to methods, techniques, and systems for providing a gesture-based system and, in particular, to methods, techniques, and systems for automatically presenting commercial opportunities such as advertising based upon gestured input.

### BACKGROUND

As massive amounts of information continue to become progressively more available to users connected via a network, such as the Internet, a company intranet, or a proprietary network, it is becoming increasingly more difficult for a user to find particular information that is relevant, such as for a task, information discovery, or for some other purpose. Typically, a user invokes one or more search engines and provides them with keywords that are meant to cause the search engine to return results that are relevant because they contain the same or similar keywords to the ones submitted by the user. Often, the user iterates using this process until he or she believes that the results returned are sufficiently close to what is desired. The better the user understands or knows what he or she is looking for, often the more relevant the results. Thus, such tools can often be frustrating when employed for information discovery where the user may or may not know much about the topic at hand.

Different search engines and search technology have been developed to increase the precision and correctness of search results returned, including arming such tools with the ability to add useful additional search terms (e.g., synonyms), rephrase queries, and take into account document related information such as whether a user-specified keyword appears in a particular position in a document. In addition, search engines that utilize natural language processing capabilities have been developed.

In addition, it has becoming increasingly more difficult for a user to navigate the information and remember what information was visited, even if the user knows what he or she is looking for. Although bookmarks available in some client applications (such as a web browser) provide an easy way for a user to return to a known location (e.g., web page), they do not provide a dynamic memory that assists a user from going from one display or document to another, and then to another. Some applications provide “hyperlinks,” which are cross-references to other information, typically a document or a portion of a document. These hyperlink cross-references are typically selectable, and when selected by a user (such as by using an input device such as a mouse, pointer, pen device, etc.), result in the other information being displayed to the user. For example, a user running a web browser that communicates via the World Wide Web network may select a hyperlink displayed on a web page to navigate to another page encoded by the hyperlink. Hyperlinks are typically placed into a document by the document author or creator, and, in any case, are embedded into the electronic representation of the document. When the location of the other information changes, the hyperlink is “broken” until it is updated and/or replaced. In some systems, users can also create such links in a document, which are then stored as part of the document representation.

Even with advancements, searching, navigating, and presenting the morass of information is oft times still a frustrating user experience.

### BRIEF DESCRIPTION OF THE DRAWINGS

FIG. 1A is a screen display of example gesture based input indicating a topic, an object, and/or an action as performed by an example Gesture Based Content Presentation System (GBCPS) or process.

FIG. 1B is a screen display of a presentation of example gesture based opportunity for commercialization determined by an example Gesture Based Content Presentation System or process.

FIG. 1C is a screen display of an animated overlay presentation as shown over time of an example gesture based opportunity for commercialization determined by an example Gesture Based Content Presentation System or process.

FIGS. 1D1-1D8 are example screen displays of a sliding pane overlay sequence shown over time for presenting an opportunity for commercialization by an example Gesture Based Content Presentation System or process.

FIGS. 1E1-1E2 are example screen displays of a shared presentation construct for presenting an opportunity for commercialization by an example Gesture Based Content Presentation System or process.

FIG. 1F is an example screen display of a separate presentation construct for presenting an opportunity for commercialization by an example Gesture Based Content Presentation System or process.

FIG. 1G is a block diagram of an example environment for presenting an opportunity for commercialization using an example Gesture Based Content Presentation System or process.

FIG. 2 is an example block diagram of components of an example Gesture Based Content Presentation System.

FIG. 3.1-3.130 are example flow diagrams of example logic for processes for presenting an opportunity for commercialization based upon gestured input as performed by example embodiments.

FIG. 4 is an example block diagram of a computing system for practicing embodiments of a Gesture Based Content Presentation System.

### DETAILED DESCRIPTION

Embodiments described herein provide enhanced computer- and network-based methods, techniques, and systems for automatically presenting opportunities for commercialization in a gesture based input system. Example embodiments provide a Gesture Based Content Presentation System (GBCPS), which enables a gesture-based user interface to determine (e.g., find, locate, generate, designate, define or cause to be found, located, generated, designated, defined, or the like) content associated with an opportunity for commercialization related to a portion of electronic input that has been indicated by a received gesture and to present (e.g., display, play sound for, draw, and the like) such content. The GBCPS is able to present opportunities for commercialization, and their associated content, in response to a user exploring or otherwise browsing (navigating, examining, etc.) informational content related to some topic. For example, a user who is browsing information on penguins, might be presented with a map to the local zoo by the GBCPS, along with an opportunity to purchase discount tickets. Or, as another example, the user might be presented with a website for buying stuffed animal penguins, or a game to “race a penguin through a maze,” join an environmental group, etc. Accordingly, the GBCPS provides a mechanism for sponsors of opportunities for commercialization to take advantage of additional occasions (e.g., times, events, opportunities) associated with information searching and browsing and not just those available when the user indicates an intent to purchase.

An opportunity for commercialization may include any kind of opportunity, including, for example, different types of advertising, interactive computing games and/or entertainment that may result in a purchase or offer for purchase, bids, bets, competitions, and the like. The content associated with an opportunity for commercialization may include any type of content including, for example, text, images, sound, or the like. Further, the content may be provided by any sponsor of the opportunity for commercialization such as an advertiser, a manufacturer, a publisher, etc. Also, the content may be provided directly or indirectly; for example, sponsor supplied content may be provided by a third party to the sponsor such as from an ad server, a third party with specific user, demographic, or contextual knowledge, and/or another sponsor.

As further examples, suppose the user as posed a query and receives an answer that is a documentary sponsored by the Science Center. The cost of the documentary can be somewhat defrayed by embedding paid for advertisements in the documentary. In this manner the GBCPS has answered the request for information with an advertisement that is mediated through the content that the user has requested. Answers to other types queries for information can be similarly supplemented with content associated with opportunities for commercialization. For example, when a user requests the distance from Seattle to Olympia, a sponsor supplied advertisement (“ad”) may ask whether you wish to buy a map, or embed the ad in the returned directions, or return the directions with ads for related information such as a book on Olympia or the best restaurants. In other example, a person travelling to China and purchasing airline tickets on business may want to see faux pas information that travelers typically make in China but not see ads for weddings or funerals. In all of these instances the user receives back what is perceived as “helpful” information even though it might be supplemented by opportunities where a sponsor, or a third party presenting content through the sponsor, can earn compensation. In addition, the opportunities for commercialization thus presented can be tailored to the context of what information is being sought and potentially other factors, such as context relating to the user, the location, etc.

In overview of operation, the GBCPS presents electronic content that relates to a first topic on a presentation device (such as a display, electronic output, electronic reader, speaker, or the like). Then, the GBCPS allows a portion (e.g., an area, part, or the like) of the electronically presented content to be dynamically indicated by a gesture. The gesture identifies another topic (e.g., a second topic related to the first topic such as when drilling down for information), and/or an object that relates to the first topic and/or an action that relates to the first topic. The gesture may be provided in the form of some type of pointer, for example, a mouse, a touch sensitive display, a wireless device, a human body part, a microphone, a stylus, and/or a pointer that indicates a word, phrase, icon, image, or video, or may be provided in audio form. In some embodiments the indicated portion identifies (e.g., indicates, displays, presents, etc.) an entity (such as a product and/or service) that a user is observing (e.g., viewing, hearing, realizing, etc.) or an action that the user is trying to do (e.g., purchase, view, travel, etc.). The GBCPS then dynamically determines sponsor supplied content that is associated with an opportunity for commercialization that is, typically, related to the identified first topic in some manner (e.g., directly or indirectly). The GBCPS then presents the determined content associated with the opportunity for commercialization on a presentation device (e.g., a display, a speaker, electronic reader, or other output device) in conjunction with one or more of the first topic, second topic, object, and/or action so that it relates to what the user has indicated interest in. For example, if the GBCPS determines that an advertisement is an appropriate opportunity for commercialization corresponding to an indicated (e.g., gestured) portion that identifies a particular (second) topic, then the advertisement may be presented to the user (textually, visually, and/or via audio) instead of or in conjunction with the already presented content.

The determination of the sponsor supplied content associated with an opportunity for commercialization is based upon content contained in the portion of the presented electronic content indicated by the gestured input as it relates to the user's interests. That is, the content upon which the gesture is made relates to some topic—the first topic. The gesture may indicate a related topic, object, and/or action. Thus, the content contained in the gestured portion in some way relates to the first topic, which expresses the user's interests. Content may include, for example, a word, phrase, spoken utterance, image, video, pattern, and/or other audio signal. Also, the portion may be formed from contiguous or composed of separate non-contiguous parts, for example, a title with a disconnected sentence. In addition, the indicated portion may represent the entire body of electronic content presented to the user. For the purposes described herein, the electronic content may comprise any type of content that can be presented for gestured input, including, for example, text, a document, music, a video, an image, a sound, or the like.

The content presented in the electronic content, upon which the gesture is made, may be, for example, one or more pages of a web site, an electronic document, a response to a user query, or information indicating that the user has an interest in seeking knowledge or buying or bidding on something. The sponsor supplied content determined by the GBCPS may responsively provide an answer to the user query, the information sought by the user, or indications of products and/or services that the user is trying to purchase.

The GBCPS may incorporate information from a set of factors (e.g., criteria, state, influencers, things, features, and the like) in addition to the content contained in the indicated portion to determine the sponsor supplied content associated an opportunity for commercialization. The set of factors that may influence the determined sponsor supplied content associated with the opportunity for commercialization may include such things as context surrounding or otherwise relating to the indicated portion (as indicated by the gesture), such as other text, audio, graphics, and/or objects within the presented electronic content; some attribute of the gesture itself, such as size, direction, color, how the gesture is steered (e.g., smudged, nudged, adjusted, and the like); presentation device capabilities, for example, the size of the presentation device, whether text or audio is being presented; prior device communication history, such as what other devices have recently been used by this user or to which other devices the user has been connected; time of day; and/or prior history associated with the user, such as prior search history, navigation history, purchase history, and/or demographic information (e.g., age, gender, location, contact information, or the like). For example, the set of factors may indicate that the user is Japanese and so would prefer sponsor supplied content associated with an opportunity for commercialization targeted to a Japanese product or culture, such as an advertisement for a Japanese beer. As another example, the user's prior navigation history may disambiguate between possible products and/or services indicated by a gesture. For example, a gesture of a particular model of truck may not convey whether opportunities for commercialization are more appropriately targeted to trucks generally, other truck models, or parts for that particular truck. However, in combination with the user's prior navigation history, the GBCPS may be able to determine that the user has been looking for automotive parts by the time the user performs a gesture and thereafter offer occasions for opportunities for commercialization that are related to automotive part for that model truck (e.g., advertisements for truck parts for that model.) In addition, information from a context menu, such as a selection of a menu item by the user, may be used to assist the GBCPS in determining sponsor supplied content associated with an opportunity for commercialization.

The ability to use the context of the gesture, aspects of the gesture itself, and/or other factors to determine content associated with an opportunity for commercialization can result in more targeted types of opportunities, more clearly associated with an intended product and/or service, topic, entity, and/or action indicated by the gestured input. Accordingly, search engines, advertising agencies, third party advertising servers, and/or publishers of content can potentially provide better pricing structures, for example, for such opportunities (such as advertisements), since they will be able to better predict a target audience for each opportunity.

Once sponsor supplied content associated with the opportunity for commercialization is determined, the GBCPS automatically presents the sponsor content associated with the (selected) opportunity for commercialization in conjunction with the corresponding first topic, second topic, object, and/or action. Presenting the content associated with the opportunity for commercialization may also involve “navigating,” such as by changing the user's focus to new content indicated by the opportunity for commercialization. The opportunity for commercialization, and/or the content associated therewith, may be represented by anything, including, for example, a web page, computer code, electronic document, electronic version of a paper document, a purchase or an offer to purchase a product or service, social networking content, and/or the like.

In some embodiments the opportunity for commercialization and/or the content associated with it, may be provided by entities other that those responsible for initially presenting the indicated product and/or service. This may allow, for example, competitors to present competing opportunities for commercialization such as competing advertisements for a gestured and identified product and/or service when the underlying presented content is published by an entity that also sponsors the indicated product and/or service. In some scenarios, the indicated gestured portion is represented by a persistent data structure such as a URL (e.g., a gesturelet) and this gesturelet may be associated with one or more opportunities for commercialization through a purchase process analogous to techniques used to bid on or purchase keywords from search engines. Instead, entities may purchase and/or bid on gesturelets in order to associate the intended sponsor supplied content associated with an opportunity for commercialization (e.g., an advertisement of a product attributable to the entity) with a gestured representation of a product. In addition, in some embodiments, the original presenter of the identified object (e.g., the publisher) may be given an opportunity to “counter-bid” on the gesturelet to insure that no competing opportunities for commercialization are presented. Other bidding and/or purchase arrangements are possible.

The determined opportunity for commercialization and/or sponsor related content therefore is presented to the user in conjunction with the presented topic, object, and/or action, for example, by use of an overlay; in a separate presentation element (e.g., window, pane, frame, or other construct) such as a window juxtaposed to (e.g., next to, contiguous with, nearly up against) the presented electronic content; and/or, as an animation, for example, a pane that slides in to partially or totally obscure the presented electronic content. With animated presentations, artifacts of the movement may be also presented on the screen (e.g., window or object borders that appear to move, flashing text or images, or the like). In some examples, separate presentation constructs (e.g., windows, panes, frames, etc.) are used, each for some purpose, e.g., one presentation construct for the presented electronic content containing the indicated portion, another presentation construct for advertising or other opportunities for commercialization from the publisher of the presented electronic content, and another presentation construct for competing advertisements or other opportunities for commercialization, such as presenting information on better, faster, or cheaper opportunities. In some examples, a user may opt in or out of receiving the advertising (or other opportunities for commercialization) and fewer presentation constructs may be presented. Other methods of presenting the content associated with opportunities for commercialization and layouts are contemplated.

### Gesture Based Content Presentation System Overview

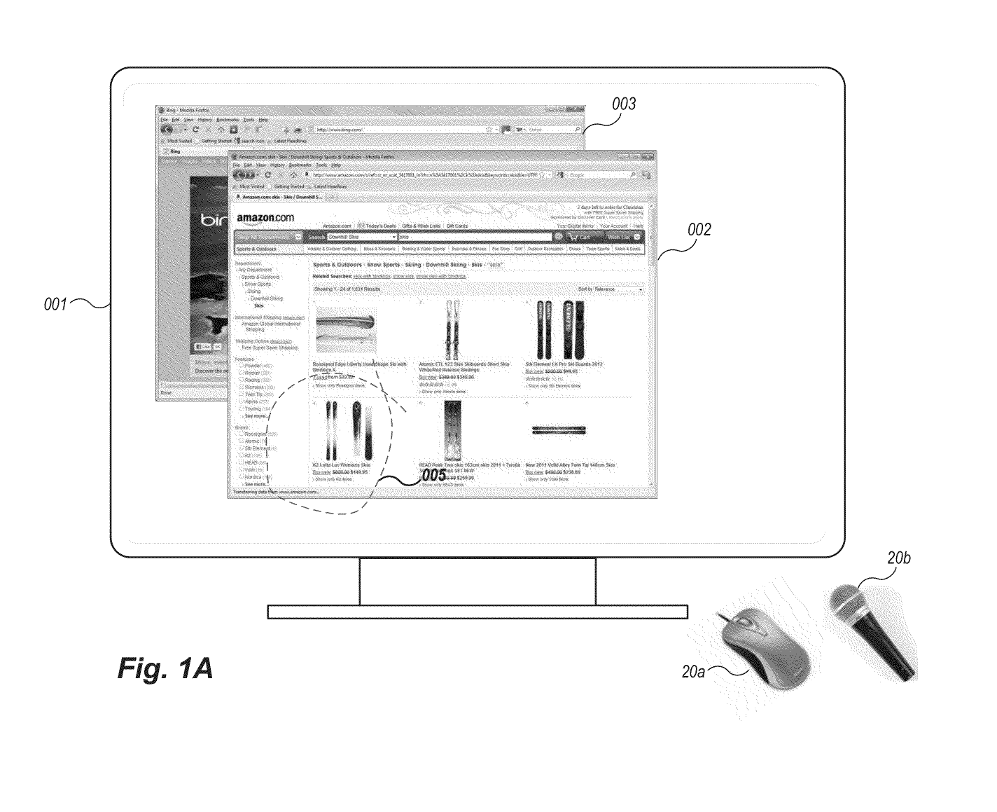

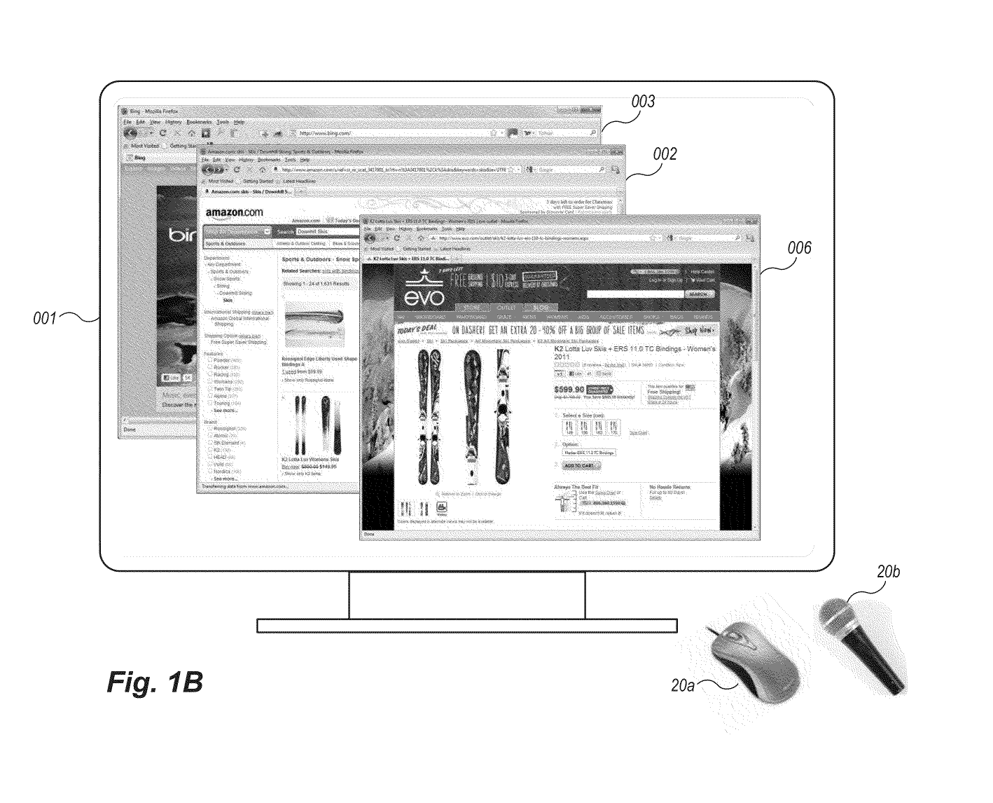

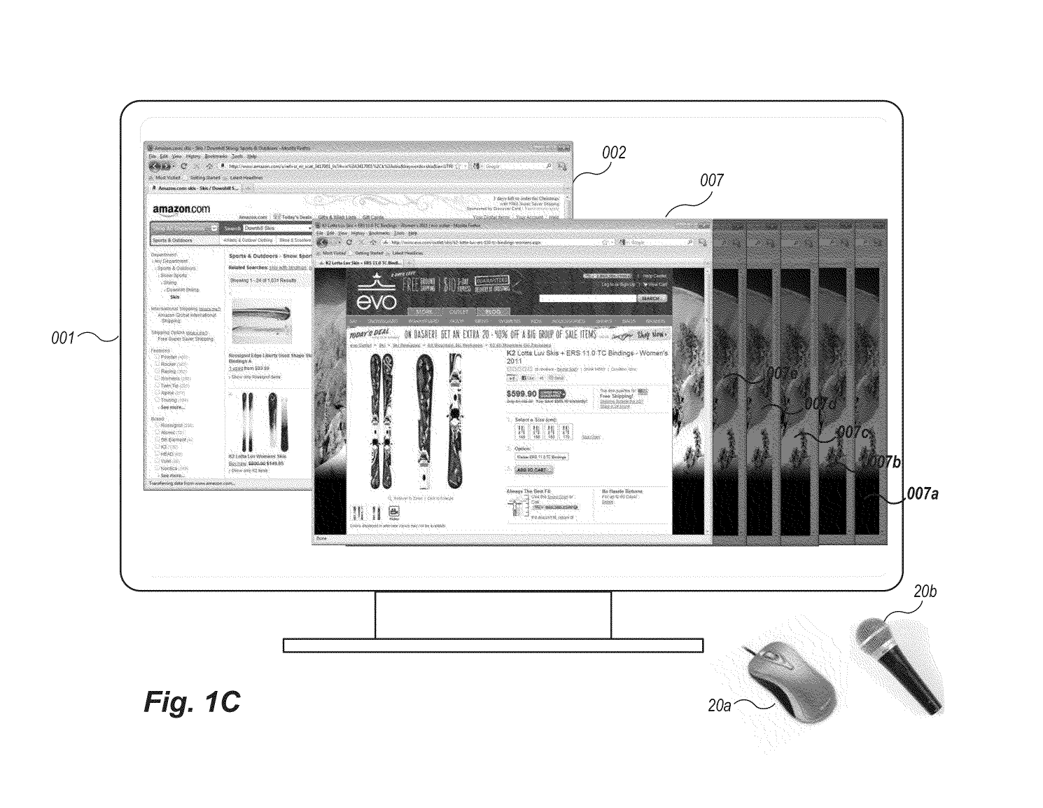

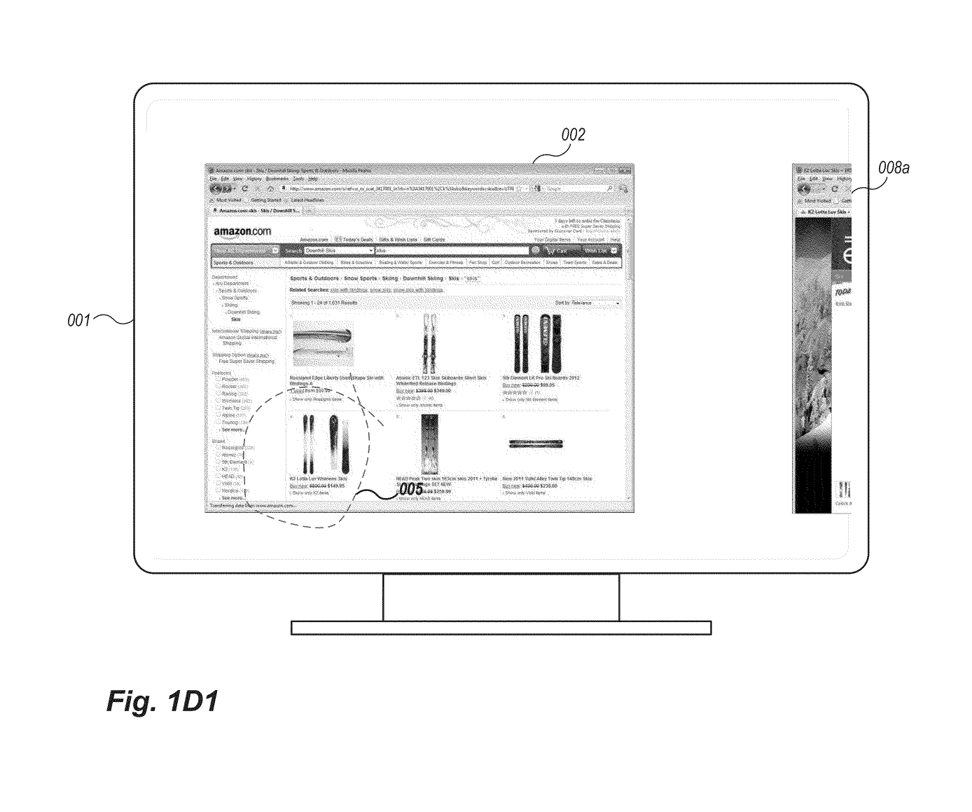

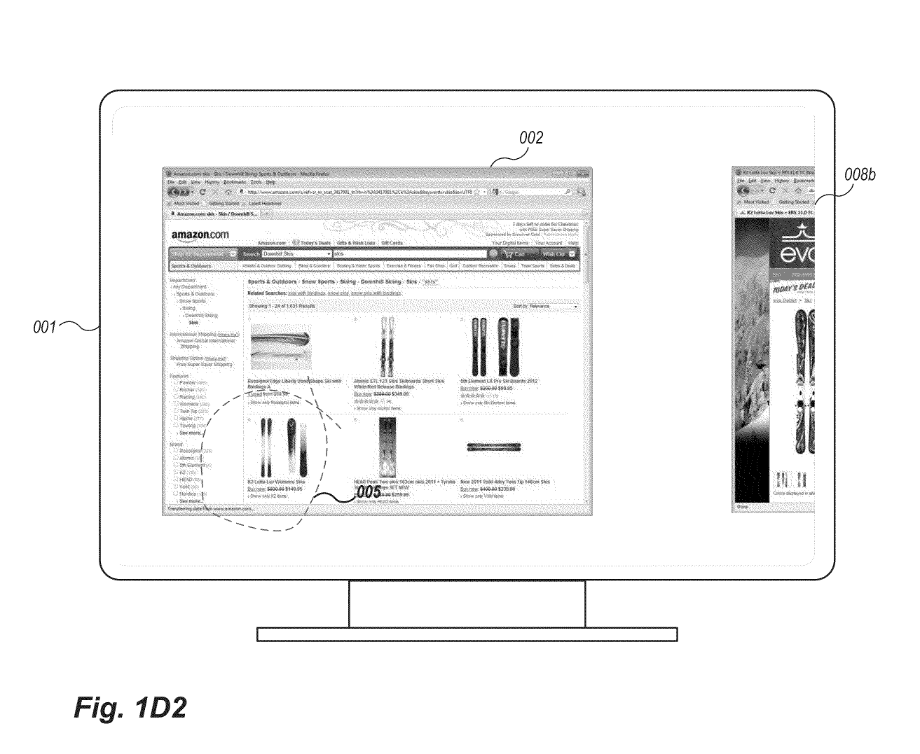

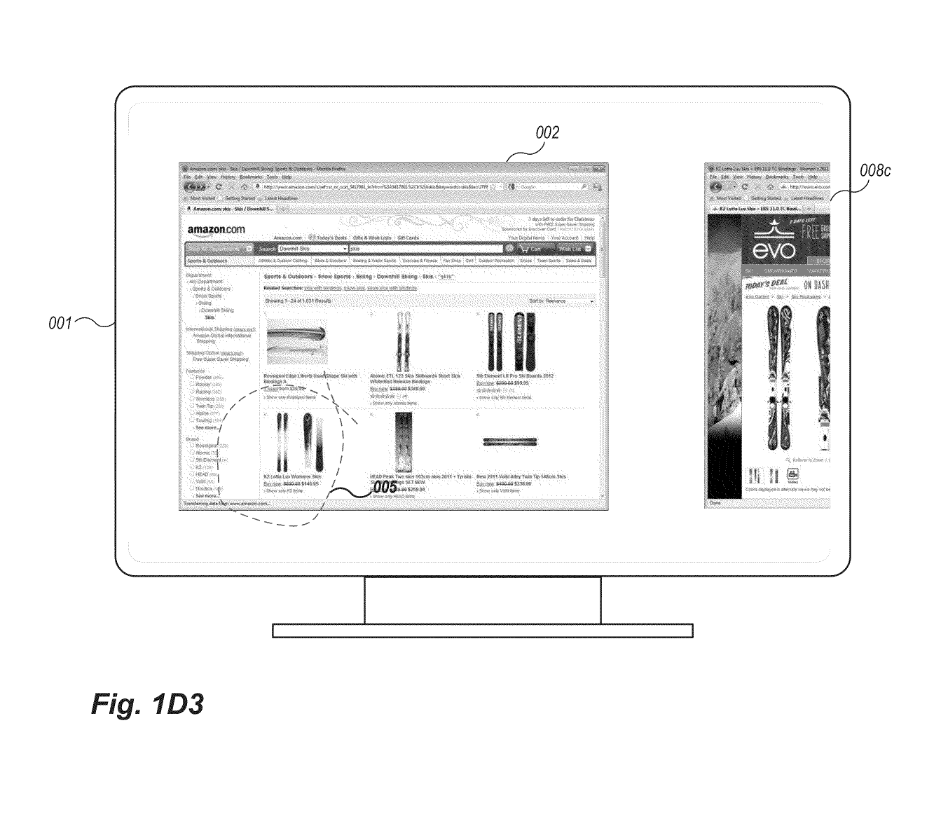

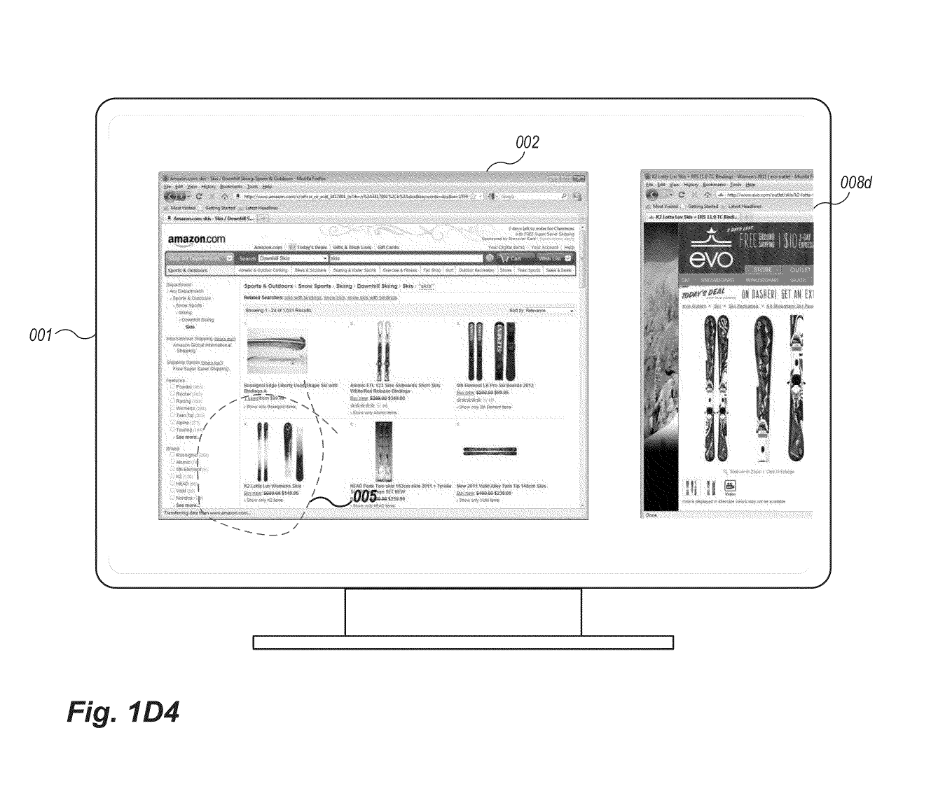

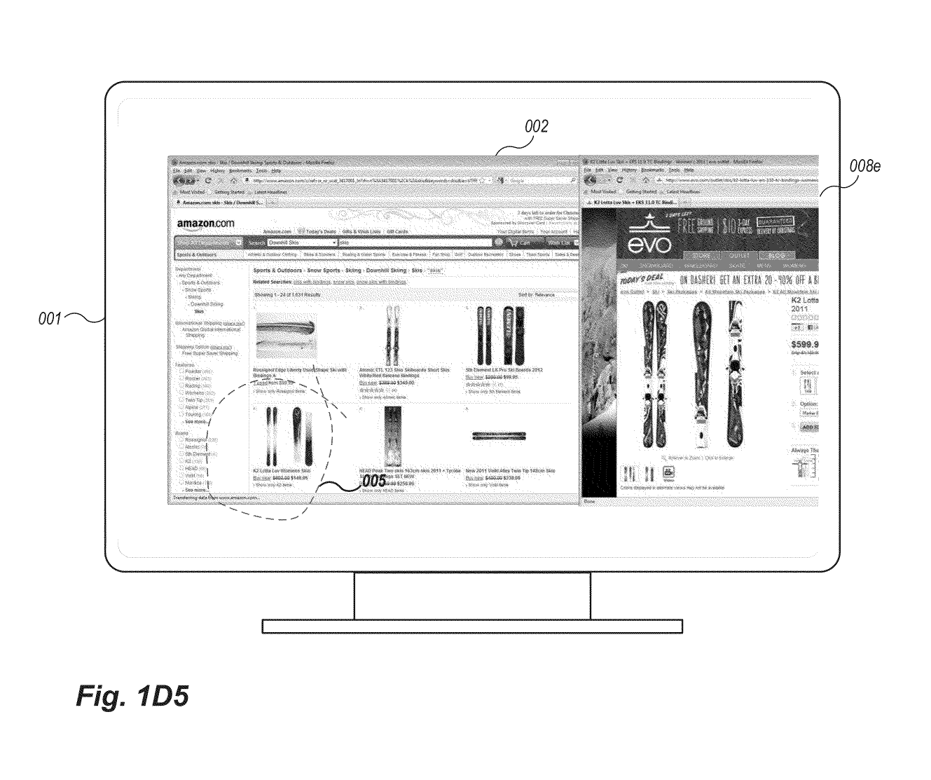

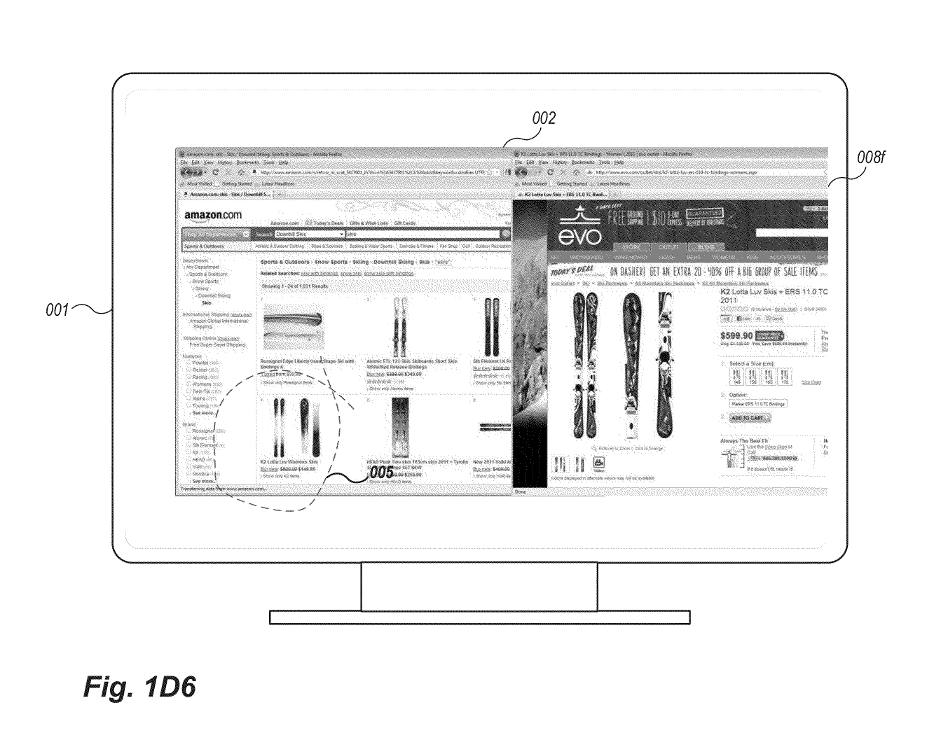

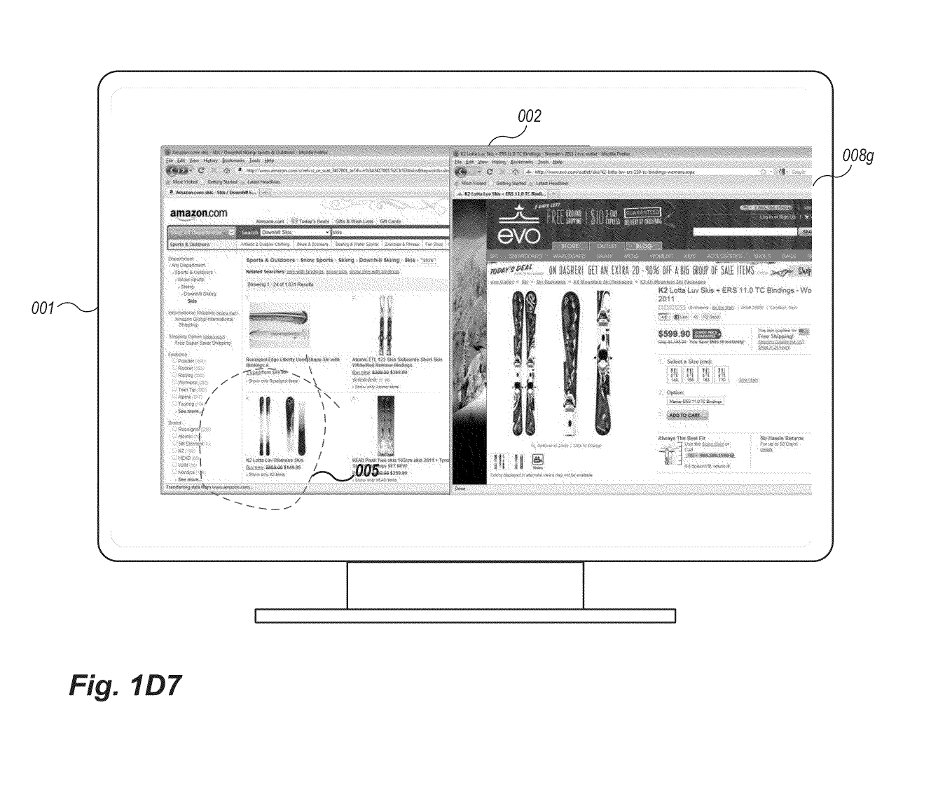

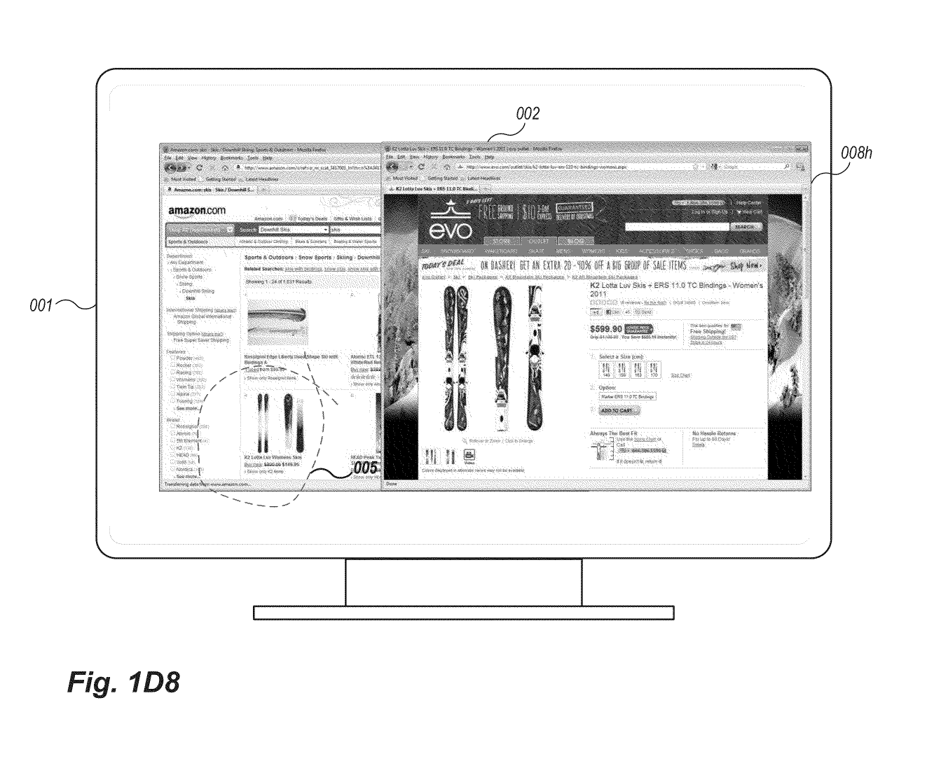

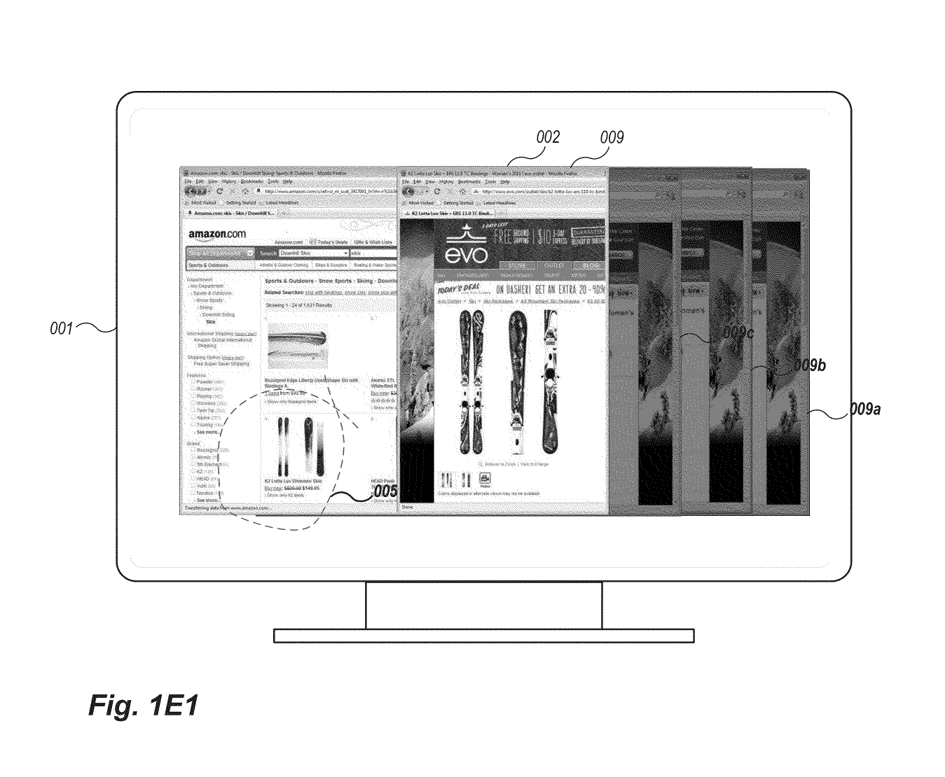

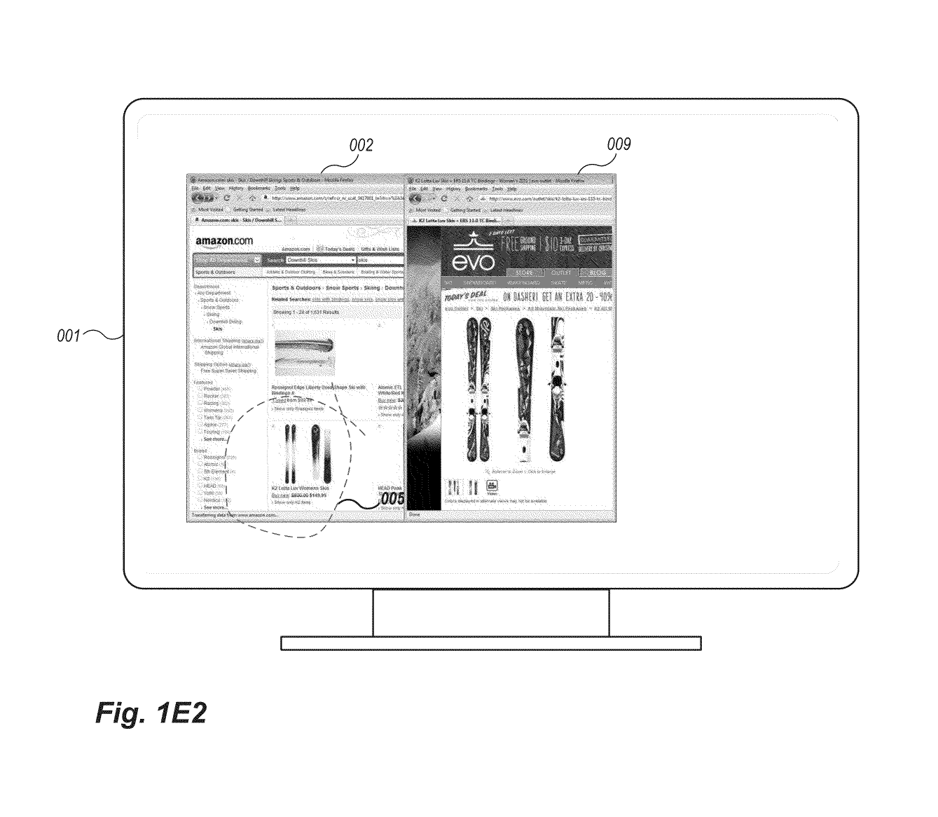

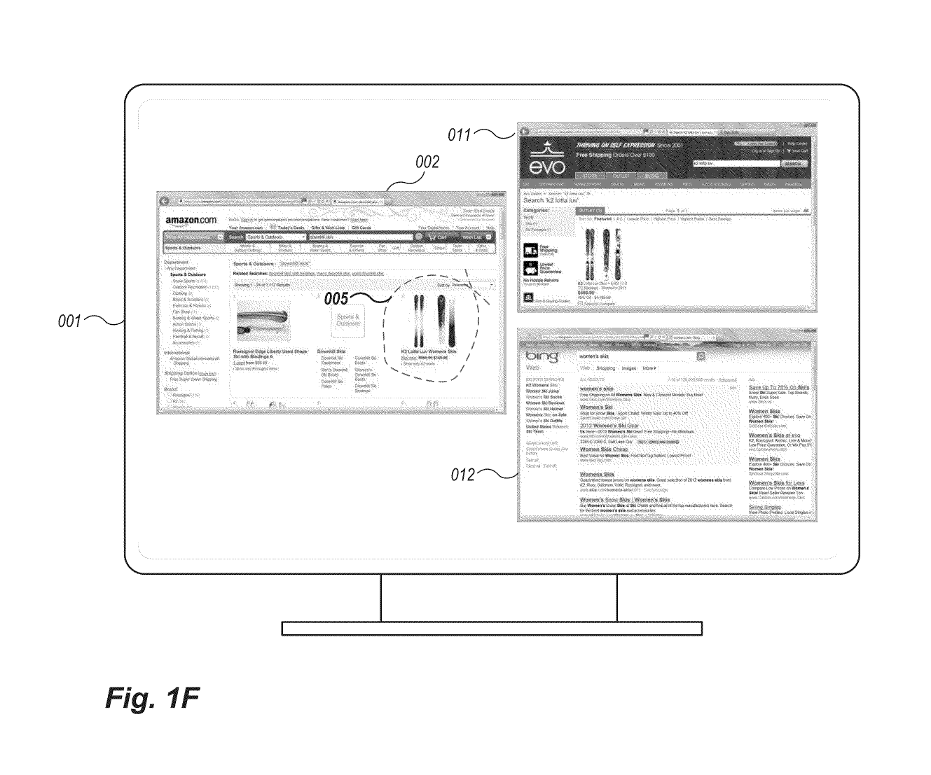

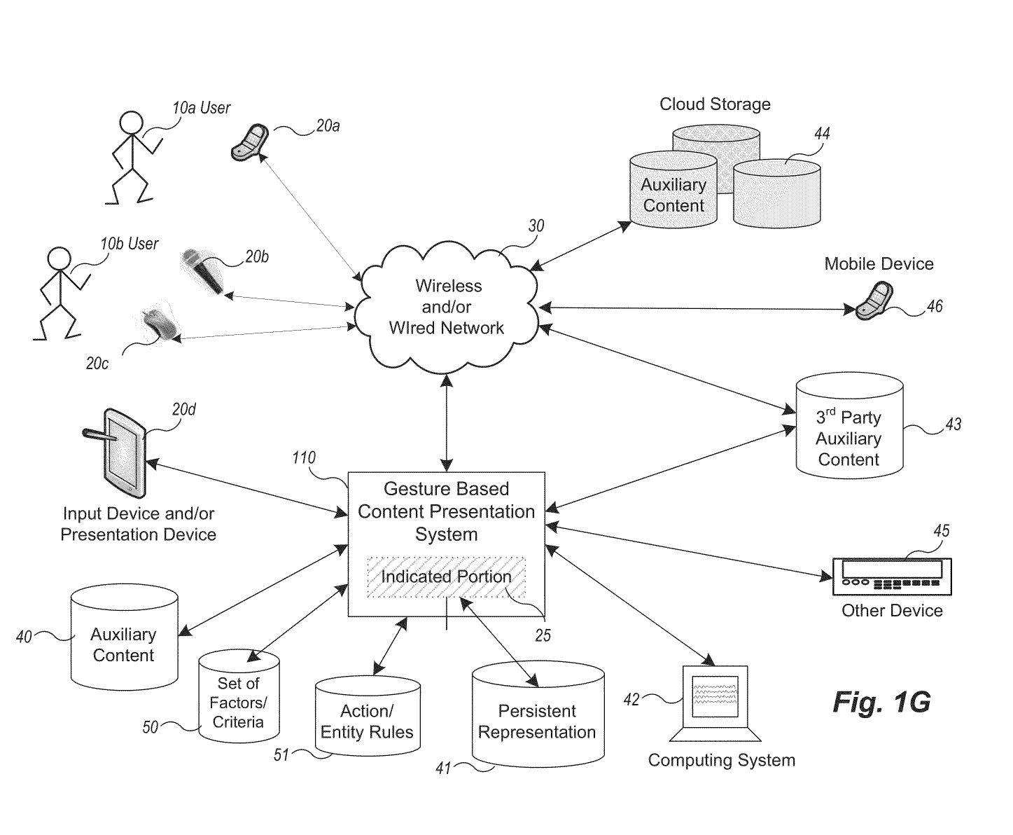

FIG. 1A is a screen display of example gesture based input indicating a topic, an object, and/or an action as performed by an example Gesture Based Content Presentation System (GBCPS) or process. In FIG. 1A, a presentation device, such as computer display screen 001, is shown presenting two windows with electronic content, window 002 and window 003. The user (not shown) utilizes an input device, such as mouse 20a and/or a microphone 20b, electronic display or appliance (not shown), to indicate a gesture (e.g., gesture 005) to the GBCPS. The GBCPS, as will be described in detail elsewhere herein, determines to which portion of the electronic content displayed in window 002 the gesture 005 corresponds, potentially including what type of gesture. In the example illustrated, gesture 005 was created using the mouse device 20a and represents a closed path (shown in red) that is not quite a circle or oval that indicates that the user is interested in the entity representing “K2 Lotta Luv Womens' skis,” a representation of an object published by the website “Amazon.com.” The gesture may be a circle, oval, closed path, polygon, or essentially any other shape recognizable by the GBCPS. The gesture may indicate content that is contiguous or non-contiguous. Audio may also be used to indicate some area of the presented content, such as by using an uttered word, phrase, sound, and/or direction (e.g., command, order, directional command, or the like). Other embodiments provide additional ways to indicate input by means of a gesture. The GBCPS can be fitted to incorporate any technique for providing a gesture that indicates some area or portion (including any or all) of the presented content. In some embodiments, the GBCPS highlights or otherwise demarcates the text and/or image to which gesture 005 is determined to correspond.

In the example illustrated, the GBCPS determines from the indicated portion (the representation of the product and/or offer) and one or more factors, such as the user's prior navigation history, that the user may be interested in more detailed information or purchasing the product represented by the indicated portion. In this case, the GBCPS determines that a third party has bid on presenting advertisements on ski related products and determines content from that third party, in this case “evo.com.” In other examples, different ways to determine what entity is offered an opportunity for commercialization are accommodated, including bidding dynamically, in advance, using an advertising server such as a third party advertising server, through competitions, by the publisher itself (in this case Amazon.com”), and/or the like. In this example, the GBCPS determines that the user typically wants to see an advertisement when an object that is a product is displayed and accordingly displays an appropriate advertisement.

In some example embodiments, using a set of factors associated with the user, the content, the input device, the presentation device, or the like, the GBCPS can determine whether the user would prefer certain types of advertisements to be presented when the example gesture 005 is determined. For example, the user may be more interested in similar skis, better prices for this exact pair of skis, bindings for these skis, information on skis generally, where to ski, etc. The more the GBCPS can determine relevant advertisements or other opportunities for commercialization, the more likely the user can engage in a rewarding experience and the more likely the opportunity for commercialization will be successful.

FIG. 1B is a screen display of a presentation of example gesture based opportunity for commercialization determined by an example Gesture Based Content Presentation System or process. In this example, the opportunity for commercialization is an advertisement from “evo.com” presented on the web page 006 for the same skis originally presented in window 002. This content is shown as an overlay 006 over at least one of the windows 002 on the presentation device 001 that contains the represented product and/or service from the presented electronic content upon which the gesture was indicated.

For the purposes of this description, an “entity” is any person, organization, place, or thing, or a representative of the same, such as by an icon, image, video, utterance, etc. An “action” is something that can be performed, for example, as represented by a verb, an icon, an utterance, or the like.

The content associated with the opportunity for commercialization presented on web page 006 may be presented in ways other than as a single overlay over window 002. For example, FIG. 1C is a screen display of an animated overlay presentation as shown over time of an example gesture based opportunity for commercialization determined by an example Gesture Based Content Presentation System or process. In FIG. 1C, the same web page 007 is shown coming into view over time as an overlay using animation techniques. According to this presentation, the windows 007a-007f are intended to show the window 007 as would be presented in prior moments in time as the window 007 is brought into focus from the right side of presentation screen 001. For example, the window in position 007a moves to the position 007b, then 007c, and the like, until the window reaches its desired position as shown as window 007. In the example shown, a shadow of the window continues to be displayed as an artifact on the screen at each position 007a-007f, however this is not necessary and in other examples no artifacts may remain. The artifacts (e.g., window shadows) may be helpful to the user in perceiving the animation.

FIGS. 1D1-1D8 are example screen displays of a sliding pane overlay sequence shown over time for presenting an opportunity for commercialization by an example Gesture Based Content Presentation System. They illustrate an animation for presenting an opportunity for commercialization over time (here an advertisement) as sliding in from the side of the presentation screen 001 (here from the right hand side) until the window with the opportunity for commercialization reaches its destination (as window 008h) as an overlay on top of the presented electronic content in window 002. As time progresses from earliest to latest, as shown from FIG. 1D1 in sequence to 1D8, the window 008x (where x is a-h) moves closer and closer onto the presented content where the gesture was made. Eventually, the content associated with the opportunity for commercialization in window 008f-008h is shown covering up more and more of the gestured portion. In other examples, when the pane slides in from the side of the screen, the portion of the electronic content in window 002 indicating the gestured portion (as shown by gesture 005) always remains visible. Sometimes this is accomplished by not moving the presentation construct with the opportunity for commercialization as far over the presentation of the gestured portion. In other instances, the window 002 is readjusted (e.g., scrolled, the content repositioned, etc.) to maintain both display of the gestured portion and the opportunity for commercialization. Other animations and non-animations of presenting an opportunity for commercialization using overlays and/or additional presentation constructs are possible.

FIGS. 1E1-1E2 are example screen displays of a shared presentation construct for presenting an opportunity for commercialization by an example Gesture Based Content Presentation System or process. In this example, as the presentation construct 009 with the opportunity for commercialization is moved onto the presentation construct 002 that presents the gestured input over time (sequence of constructs 009a-009c), the construct 009 is readjusted so that it is (e.g., fully or mostly) contained in the presentation construct 002 as illustrated in FIG. 1E2. In the example shown, the presentation construct 002 is effectively “split” (evenly or not) between the originally published content containing the gesture in window 002 and the opportunity for commercialization in window 009. Other examples may split the real estate differently between, for example, an advertisement for a product and the representation of the product. Also, in some examples, artifacts from the presentation constructs (here windows 009a-009c in FIG. 1E1) are shown and in others they are not (for example, in FIG. 1E2).

FIG. 1F is an example screen display of a separate presentation construct for presenting an opportunity for commercialization by an example Gesture Based Content Presentation System or process. In this example, content associated with the opportunity for commercialization is shown in a presentation construct 011 separate from the published content containing the gesture in window 002. An additional presentation construct 012 may be available to present further opportunities for commercialization or additional information. In some examples, one or more of the presentation constructs 002, 011, and 012 are adjacent to one another (not shown). In others, as shown in FIG. 1F they are separated.

In one such example, a presentation construct such as window 011 is reserved for advertisements of products and/or services that are indicated by gestures to enable a user to “opt-in” to advertising. In such systems the GBCPS does not present advertising if the user has not indicated a desire (such as by not opening the “advertising” window 011). Such as system may present what may be termed “voluntary” advertising or opportunities for commercialization. Other arrangements with other numbers and/or types of presentation constructs are contemplated.

FIG. 1G is a block diagram of an example environment for presenting an opportunity for commercialization using an example Gesture Based Content Presentation System (GBCPS) or process. One or more users 10a, 10b, etc. communicate to the GBCPS 110 through one or more networks, for example, wireless and/or wired network 30, by indicating gestures using one or more input devices, for example a mobile device 20a, an audio device such as a microphone 20b, or a pointer device such as mouse 20c or the stylus on table device 20d (or for example, or any other input device, such as a keyboard of a computer device, an electronic control panel, display, or appliance, or a human body part, not shown). For the purposes of this description, the nomenclature “*” indicates a wildcard (substitutable letter(s)). Thus, user 20* may indicate a device 20a or a device 20b. The one or more networks 30 may be any type of communications link, including for example, a local area network or a wide area network such as the Internet.

Content associated with an opportunity for commercialization may be determined and presented as a user indicates, by means of a gesture, different portions of the presented content. Many different mechanisms for causing content associated with an opportunity for commercialization to be presented can be accommodated, for example, a “single-click” of a mouse button following the gesture, a command via an audio input device such as microphone 20b, a secondary gesture, etc. Or in some cases, the determination and presentation is initiated automatically as a direct result of the gesture—without additional input—for example, as soon as the GBCPS determines the gesture is complete and detects an appropriate occasion has presented itself for presenting the sponsor supplied content.

For example, once the user has provided gestured input, the GBCPS 110 will determine to what portion of the presented content the gesture corresponds. In some embodiments, the GBCPS 110 may take into account other factors in addition to the indicated portion of the presented content. The GBCPS 110 determines the indicated portion 25 to which the gesture-based input corresponds, and then, based upon the indicated portion 25, and possibly a set of factors 50, (and, in the case of a context menu, based upon a set of action/entity rules 51) determines sponsor supplied content associated with an opportunity for commercialization. The GBCPS 110 may either consults some sort of library for a stored content associated with the opportunity for commercialization or may offers the possibility to sponsors in near real-time. Once sponsor supplied content is determined (e.g., indicated, linked to, referred to, obtained, or the like) the GBCPS 110 presents the opportunity for commercialization or sponsor content associated therewith.

The set of factors (e.g., criteria) 50 may be dynamically determined, predetermined, local to the GBCPS 110, or stored or supplied externally from the GBCPS 110 as described elsewhere. This set of factors may include a variety of aspects, including, for example: context of the indicated portion of the presented content, such as other words, symbols, and/or graphics nearby the indicated portion, the location of the indicated portion in the presented content, syntactic and semantic considerations, etc.; attributes of the user, for example, prior search, purchase, and/or navigation history, demographic information, and the like; attributes of the gesture, for example, direction, size, shape, color, steering, and the like; previous setup information such as previously stored associations resulting from bids, competitions, etc.; and other criteria, whether currently defined or defined in the future. In this manner, the GBCPS 110 allows presentation of the content associated with an opportunity for commercialization to become “tailored” to the object, action, topic, and/or the user as much as the system is tuned.

As explained with reference to FIGS. 1A-1F, (an indication to) the content associated with an opportunity for commercialization is determined—based upon the topic, object, and/or action encompassed by the gesture and a possibly a set of factors encompassing contextual information. Representations and/or indications of content associated with the opportunities for commercialization (for example, data structures storing information about such opportunities) may be stored local to the GBCPS 110, for example, in auxiliary content data repository 40 associated with a computing system running the GBCPS 110, or may be stored or available externally, for example, from another computing system 42, from third party content 43 (e.g., a 3^{rd} party advertising system, external content, a social network, etc.) from auxiliary content stored using cloud storage 44, from another device 45 (such as from a settop box, NV component, etc.), from a mobile device connected directly or indirectly with the user (e.g., from a device associated with a social network associated with the user, etc.), and/or from other devices or systems not illustrated. Third party content 43 is demonstrated as being communicatively connected to both the GBCPS 110 directly and/or through the one or more networks 30. Although not shown, various of the devices and/or systems 42-46 also may be communicatively connected to the GBCPS 110 directly or indirectly. The auxiliary content containing or representing the content associated with an opportunity for commercialization may be any type of content and, for example, may include another document, an image, an audio snippet, an audio visual presentation, an advertisement, an opportunity for commercialization such as a bid, a product offer, a service offer, or a competition, and the like. Once the GBCPS 110 obtains the sponsor supplied content to present, the GBCPS 110 causes the content to be presented on a presentation device (e.g., presentation device 20d) associated with the user.

The GBCPS 110 illustrated in FIG. 1G may be executing (e.g., running, invoked, instantiated, or the like) on a client or on a server device or computing system. For example, a client application (e.g., a web application, web browser, other application, etc.) may be executing on one of the presentation devices, such as tablet 20d. In some examples, some portion or all of the GBCPS 110 components may be executing as part of the client application (for example, downloaded as a plug-in, active-x component, run as a script or as part of a monolithic application, etc.). In other examples, some portion or all of the GBCPS 110 components may be executing as a server (e.g., server application, server computing system, software as a service, etc.) remotely from the client input and/or presentation devices 20a-d.

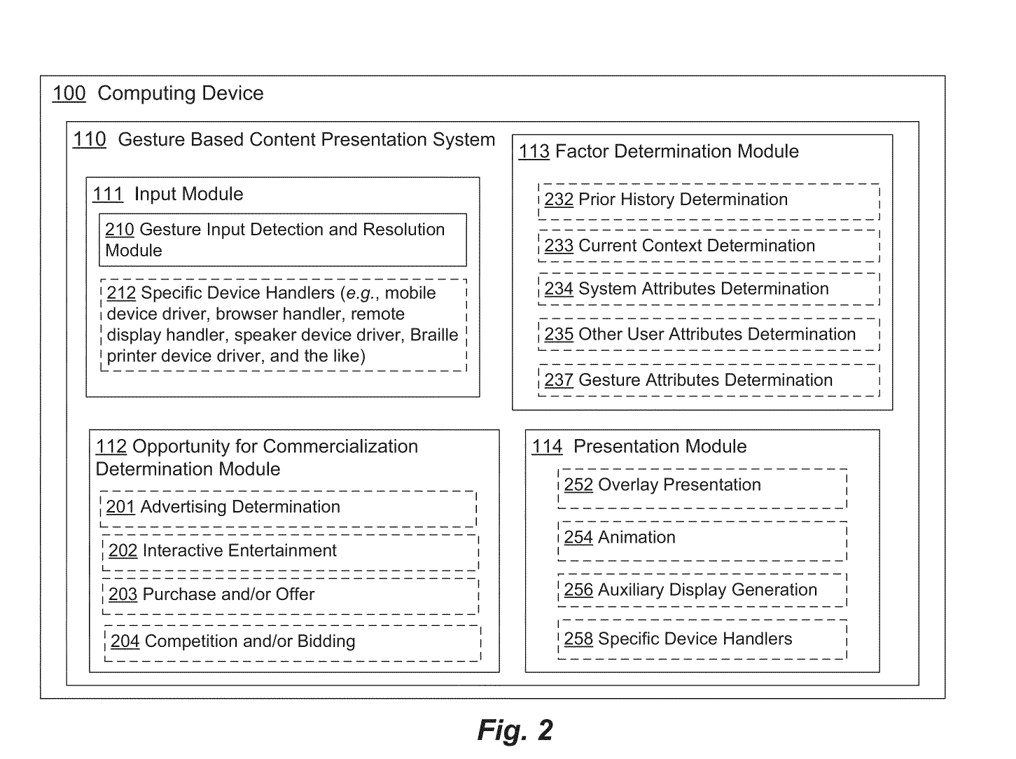

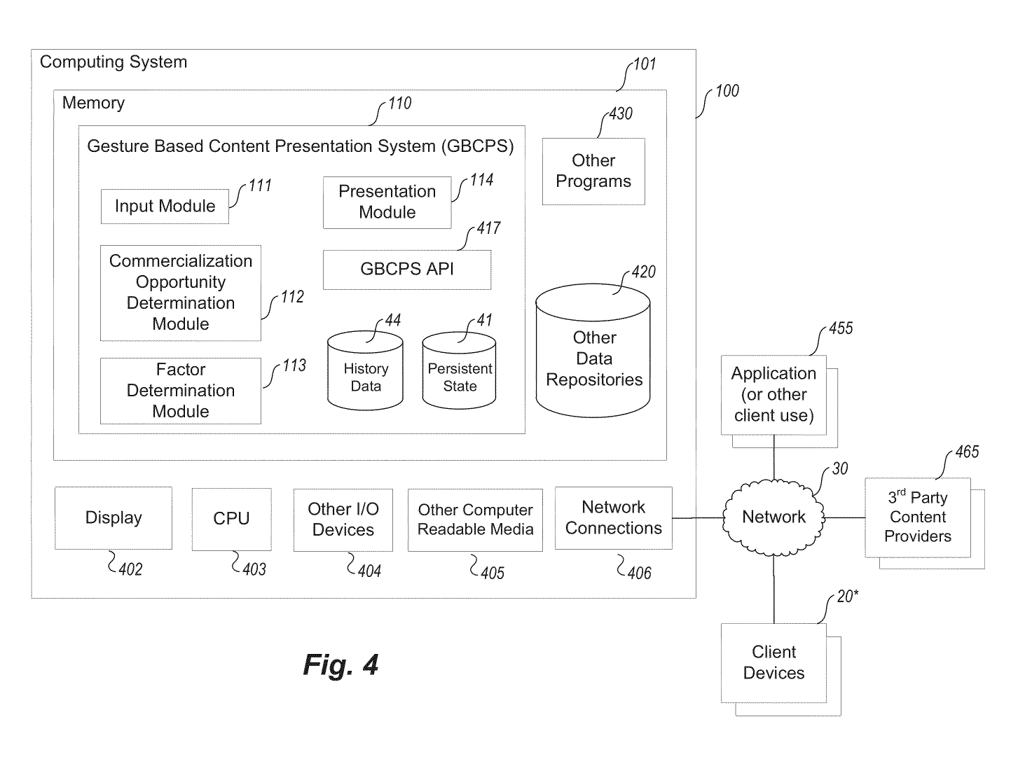

FIG. 2 is an example block diagram of components of an example Gesture Based Content Presentation System. In example GBCPSes such as GBCPS 110 of FIG. 1G, the GBCPS comprises one or more functional components/modules that work together to present sponsor supplied content associated with an opportunity for commercialization based upon gestured input. For example, a Gesture Based Content Presentation System 110 may reside in (e.g., execute thereupon, be stored in, operate with, etc.) a computing device 100 programmed with logic to effectuate the purposes of the GBCPS 110. As mentioned, a GBCPS 110 may be executed client side or server side. For ease of description, the GBCPS 110 is described as though it is operating as a server. It is to be understood that equivalent client side modules can be implemented. Moreover, such client side modules need not operate in a client-server environment, as the GBCPS 110 may be practiced in a standalone environment or even embedded into another apparatus. Moreover, the GBCPS 110 may be implemented in hardware, software, or firmware, or in some combination. In addition, although sponsor supplied content associated with an opportunity for commercialization is typically presented on a client presentation device such as devices 20*, the opportunity for commercialization may be implemented server-side or some combination of both. Details of the computing device/system 100 are described below with reference to FIG. 4.

In an example system, a GBCPS 110 comprises an input module 111, an opportunity for commercialization determination module 112, a factor determination module 113, and a presentation module 114. In some embodiments the GBCPS 110 comprises additional and/or different modules as described further below.

Input module 111 is configured and responsible for determining the gesture and an indication of an area (e.g., a portion) of the presented electronic content indicated by the gesture. In some example systems, the input module 111 comprises a gesture input detection and resolution module 210 to aid in this process. The gesture input detection and resolution module 210 is responsible for determining, using different techniques, for example, pattern matching, parsing, heuristics, syntactic and semantic analysis, etc. to what portion of presented content a gesture corresponds and what word, phrase, image, audio clip, etc. is indicated. In some example systems, the input module 111 is configured to include specific device handlers 212 (e.g., drivers) for detecting and controlling input from the various types of input devices, for example devices 20*. For example, specific device handlers 212 may include a mobile device driver, a browser “device” driver, a remote display “device” driver, a speaker device driver, a Braille printer device driver, and the like. The input module 111 may be configured to work with and or dynamically add other and/or different device handlers.

The gesture input detection and resolution module 210 may be further configured to include a variety of modules and logic (not shown) for handling a variety of input devices and systems. For example, gesture input detection and resolution module 210 may be configured to handle gesture input by way of audio devices and/or a to handle the association of gestures to graphics in content (such as an icon, image, movie, still, sequence of frames, etc.). In addition, in some example systems, the input module 111 may be configured to include natural language processing to detect whether a gesture is meant to indicate a word, a phrase, a sentence, a paragraph, or some other portion of presented electronic content using techniques such as syntactic and/or semantic analysis of the content. In some example systems, the input module 111 may be configured to include gesture identification and attribute processing for handling other aspects of gesture determination such as determining the particular type of gesture (e.g., a circle, oval, polygon, closed path, check mark, box, or the like) or whether a particular gesture is a “steering” gesture that is meant to correct, for example, an initial path indicated by a gesture; a “smudge” which may have its own interpretation such as extend the gesture “here;” the color of the gesture, for example, if the input device supports the equivalent of a colored “pen” (e.g., pens that allow a user can select blue, black, red, or green); the size of a gesture (e.g., whether the gesture draws a thick or thin line, whether the gesture is a small or large circle, and the like); the direction of the gesture (up, down, across, etc.); and/or other attributes of a gesture.

Other modules and logic may be also configured to be used with the input module 111.

Opportunity for commercialization determination module 112 is configured and responsible for determining which sponsor supplied content associated with an opportunity for commercialization to present and for determining different occasions (e.g., events, opportunities, locations, options, etc.) for an opportunity for commercialization to be presented. For example, the module 112 may determine content from entities that sell sports equipment based upon the appearance of certain objects (when gestured) and user context (for example, a user's gender). As explained earlier, determining which sponsor supplied content associated with an opportunity for commercialization to present may be based upon the context—the portion indicated by the gesture and potentially a set of factors (e.g., criteria, properties, aspects, or the like) that help to define context. Thus, the opportunity for commercialization determination module 112 may invoke the factor determination module 113 to determine the one or more factors to use to assist in specifying pricing of presenting the sponsor supplied content associated with the opportunity for commercialization. The factor determination module 113 may comprise a variety of implementations corresponding to different types of factors, for example, modules for determining prior history associated with the user, current context, gesture attributes, system attributes, bid history, or the like.

In some cases, for example, when the portion of content indicated by the gesture is ambiguous or not clear by the indicated portion itself, the opportunity for commercialization determination module 112 may utilize logic (not shown) to help disambiguate the indicated portion of content. In addition, based upon the indicated portion of content and the set of factors, more than one sponsor supplied content associated with an opportunity for commercialization may be identified. If this is the case, then the opportunity for commercialization determination module 112 may use the disambiguation logic to select which sponsor supplied content to present. The disambiguation logic may utilize syntactic and/or semantic aids, user selection, default values, and the like to assist in the determination of an opportunity for commercialization.

In some example systems, the opportunity for commercialization determination module 112 is configured to determine (e.g., find, establish, select, realize, resolve, establish, etc.) the sponsor supplied content and/or an opportunity for commercialization that best matches the object, action, or topic indicated by the gestured input and/or a set of factors. Best match may include content and/or an opportunity for commercialization that is, for example, most related syntactically or semantically, closest in “proximity” however proximity is defined (e.g., an advertisement that has been shown to a relative of the user or the user's social network), most often presented given the object, action, or topic indicated by the gesture, and the like. Other definitions for determining what content and/or opportunity for commercialization best relates to objection, action, or topic indicated by the gestured input and/or one or more of the set of factors is contemplated and can be incorporated by the GBCPS.

The opportunity for commercialization determination module 112 may be further configured to include a variety of different modules and/or logic to aid in this determination process. For example, the opportunity for commercialization determination module 112 may be configured to include one or more of an advertising determination module 201, an interactive entertainment determination module 202, a purchase and/or offer determination module 203, and/or a competition and/or bidding determination module 204. These modules may be used to determine different types of commercial opportunities, for example, bidding opportunities, computer-assisted competitions, advertisements, games, purchase and/or offers for products or services, interactive entertainment, or the like, that can be associated with the topic, object, and/or action indicated by the gestured input. For example, as shown in FIG. 1G, these advertisements may be provided by a variety of sources including from local storage, over a network (e.g., wide area network such as the Internet, a local area network, a proprietary network, an Intranet, or the like), from a known source provider, from third party content (available, for example from cloud storage or from the provider's repositories), or the like. In some systems, a third party advertisement provider system is used that is configured to accept queries for advertisements (“ads”) such as using keywords, to output appropriate advertising content.

Other modules and logic may be also configured to be used with the opportunity for commercialization determination module 112.

As mentioned, the opportunity for commercialization determination module 112 may invoke the factor determination module 113 to determine the one or more factors to use to assist in determining which sponsor supplied content and/or opportunity for commercialization is associated with a detected gestured input or to assist in determining how to define and price presentation of same in context. The factor determination module 113 may be configured to include a prior history determination module 232, a current context determination module 233, a system attributes determination module 234, other user attributes determination module 235, and/or a gesture attributes determination module 237. Other modules may be similarly incorporated.

In some example systems, the prior history determination module 232 is configured to determine (e.g., find, establish, select, realize, resolve, establish, etc.) prior histories associated with the user and/or the product and/or service represented by the gestured input and is configured to include modules/logic to implement such. For example, the prior history determination module 232 may be configured to determine demographics (such as age, gender, residence location, citizenship, languages spoken, or the like) associated with the user. The prior history determination module 232 also may be configured determine a user's prior purchases. The purchase history may be available electronically, over the network, may be integrated from manual records, or some combination. In some systems, these purchases may be product and/or service purchases. The prior history determination module 232 may be configured to determine a user's prior searches for product and/or service. Such records may be stored locally with the GBCPS 110 or may be available over the network 30 or using a third party service, etc. The prior history determination module 232 also may be configured to determine how a user navigates through his or her computing system so that the GBCPS 110 can determine aspects such as navigation preferences, commonly visited content (for example, commonly visited websites or bookmarked items), what prior content has been viewed, etc.

In some example systems, the current context determination module 233 is configured to provide determinations of attributes regarding what the user is viewing, the underlying content, context relative to other containing content (if known), whether the gesture has selected a word or phrase that is located with certain areas of presented content (such as the title, abstract, a review, and so forth).

In some example systems, the system attributes determination module 234 is configured to determine aspects of the “system” that may provide influence or guidance (e.g., may inform) the determination of the portion of content indicated by the gestured input. These may include, for example, aspects of the GBCPS 110, aspects of the system that is executing the GBCPS 110 (e.g., the computing system 100), aspects of a system associated with the GBCPS 110 (e.g., a third party system), network statistics, and/or the like.

In some example systems, the other user attributes determination module 235 is configured to determine other attributes associated with the user not covered by the prior history determination module 232. For example, a user's social connectivity data may be determined by module 235. For example, a list of products and/or services purchased and/or offered or information relevant to members of the user's social network may provide insights for what this user may like.

In some example systems, the gesture attributes determination module 237 is configured to provide determinations of attributes of the gesture input, similar or different from those described relative to input module 111 for determining to what content a gesture corresponds. Thus, for example, the gesture attributes determination module 237 may provide information and statistics regarding size, length, shape, color, and/or direction of a gesture.

Other modules and logic may be also configured to be used with the factor determination module 113.

In some embodiments, the GBCPS uses context menus, for example, to allow a user to modify a gesture or to assist the GBCPS is inferring what sponsor supplied content and/or opportunity for commercialization is appropriate. In such a case, a context menu handling module (not shown) may be configured to process and handle menu presentation and input. It may be configured to include an items determination logic for determining what menu items to present on a particular menu, input handling logic for providing an event loop to detect and handle user selection of a menu item, viewing logic to determine what kind of “view” (as in a model/view/controller—MVC—model) to present (e.g., a pop-up, pull-down, dialog, interest wheel, and the like) and a presentation logic for determining when and what to present to the user and to determine an opportunity for commercialization to present that is associated with a selection. In some embodiments, rules for actions and/or entities may be provided to determine what to present on a particular menu.

Once sponsor supplied content associated with an opportunity for commercialization is determined, the GBCPS 110 uses the presentation module 114 to present the determined opportunity for commercialization and/or content associated therewith. The GBCPS 110 forwards (e.g., communicates, sends, pushes, etc.) the opportunity for commercialization to the presentation module 114 to cause the presentation module 114 to present the content associated with the opportunity for commercialization or cause another device to present it. The sponsor supplied content associated with an opportunity for commercialization may be presented in a variety of manners, including via visual display, audio display, via a Braille printer, electronic reader, etc., and using different techniques, for example, overlays, slide-ins, panes, animation, etc.

The presentation module 115 may be configured to include a variety of other modules and/or logic. For example, the presentation module 115 may be configured to include an overlay presentation module 252 for determining how to present the determined opportunity for commercialization in an overlay manner on a presentation device such as tablet 20d. Overlay presentation module 252 may utilize knowledge of the presentation devices to decide how to integrate the opportunity for commercialization as an “overlay” (e.g., covering up a portion or all of the underlying presented content). For example, when the GBCPS 110 is run as a server application that serves web pages to a client side web browser, certain configurations using “html” commands or other tags may be used.

Presentation module 115 also may be configured to include an animation module 254. In some example systems, for example as described in FIGS. 1C, 1D1-1D8, and 1E1, the sponsor supplied content associated with an opportunity for commercialization may be “moved in” from one side or portion of a presentation device in an animated manner. For example, the sponsor supplied content associated with an opportunity for commercialization may be placed in a pane (e.g., a window, frame, pane, etc., as appropriate to the underlying operating system or application running on the presentation device) that is moved in from one side of the display onto the content previously shown. Other animations can be similarly incorporated.

Presentation module 115 also may be configured to include an auxiliary display generation module 256 for generating a new graphic or audio construct to be presented in conjunction with the content already displayed on the presentation device. In some systems, the new content is presented in a new window, frame, pane, or other auxiliary display construct.

Presentation module 115 also may be configured to include specific device handlers 258, for example, device drivers configured to communicate with mobile devices, remote displays, speakers, electronic readers, Braille printers, and/or the like as described elsewhere. Other or different presentation device handlers may be similarly incorporated.

Also, other modules and logic may be also configured to be used with the presentation module 115.

Although the techniques of a Gesture Based Content Presentation System (GBCPS) are generally applicable to any type of gesture-based system, the phrase “gesture” is used generally to imply any type of physical pointing type of gesture or audio equivalent. In addition, although the examples described herein often refer to online electronic content such as available over a network such as the Internet, the techniques described herein can also be used by a local area network system or in a system without a network. In addition, the concepts and techniques described are applicable to other input and presentation devices. Essentially, the concepts and techniques described are applicable to any environment that supports some type of gesture-based input.

Also, although certain terms are used primarily herein, other terms could be used interchangeably to yield equivalent embodiments and examples. In addition, terms may have alternate spellings which may or may not be explicitly mentioned, and all such variations of terms are intended to be included.

Example embodiments described herein provide applications, tools, data structures and other support to implement a Gesture Based Content Presentation System (GBCPS) to be used for providing presentation of sponsor supplied content associated with an opportunity for commercialization based upon gestured input. Other embodiments of the described techniques may be used for other purposes. In the following description, numerous specific details are set forth, such as data formats and code sequences, etc., in order to provide a thorough understanding of the described techniques. The embodiments described also can be practiced without some of the specific details described herein, or with other specific details, such as changes with respect to the ordering of the logic or code flow, different logic, or the like. Thus, the scope of the techniques and/or components/modules described are not limited by the particular order, selection, or decomposition of logic described with reference to any particular routine.

### Example Processes

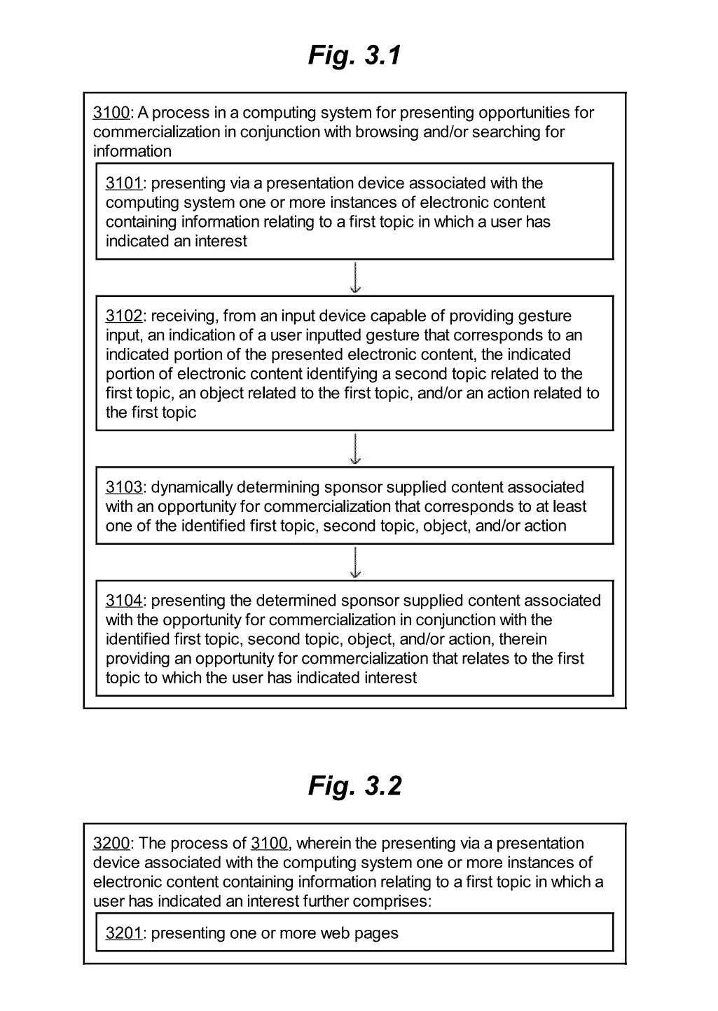

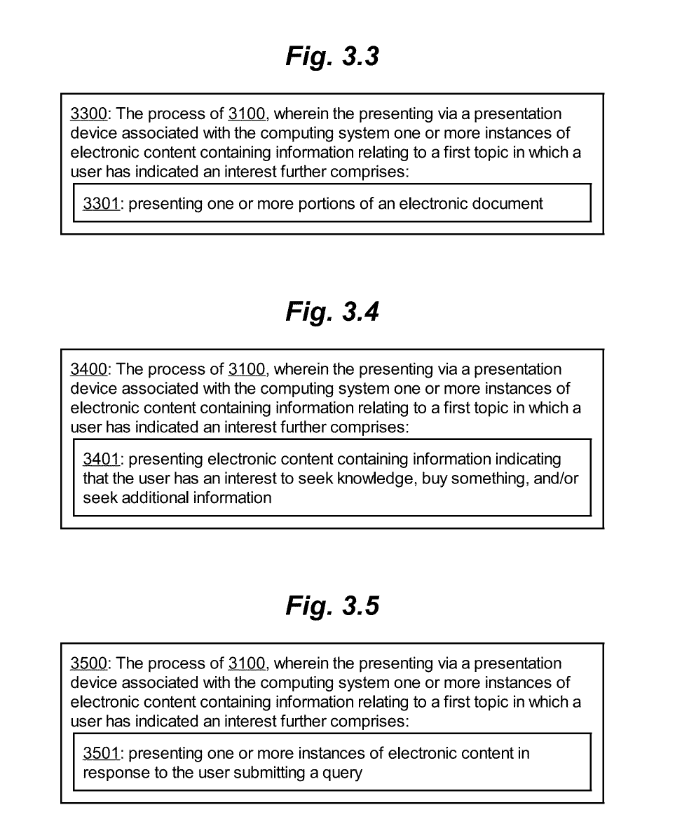

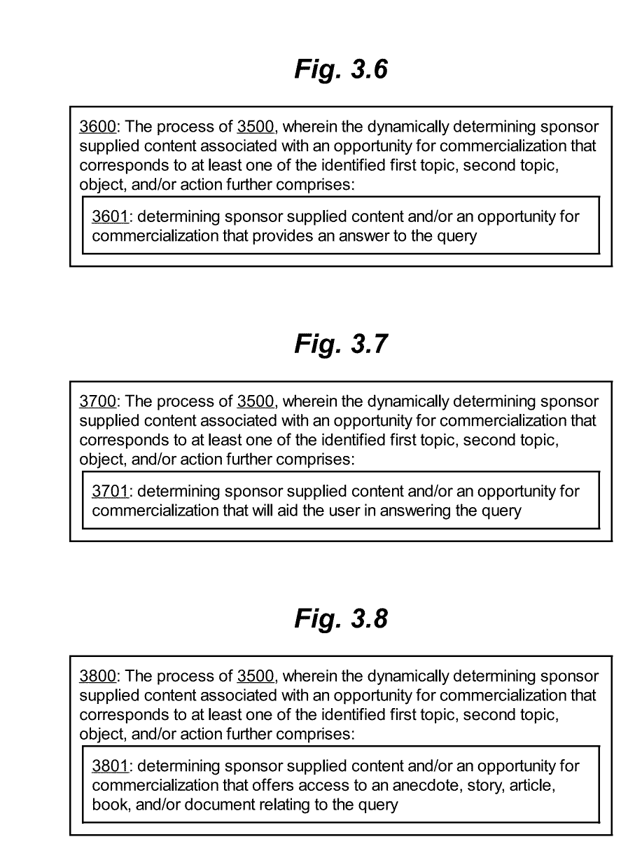

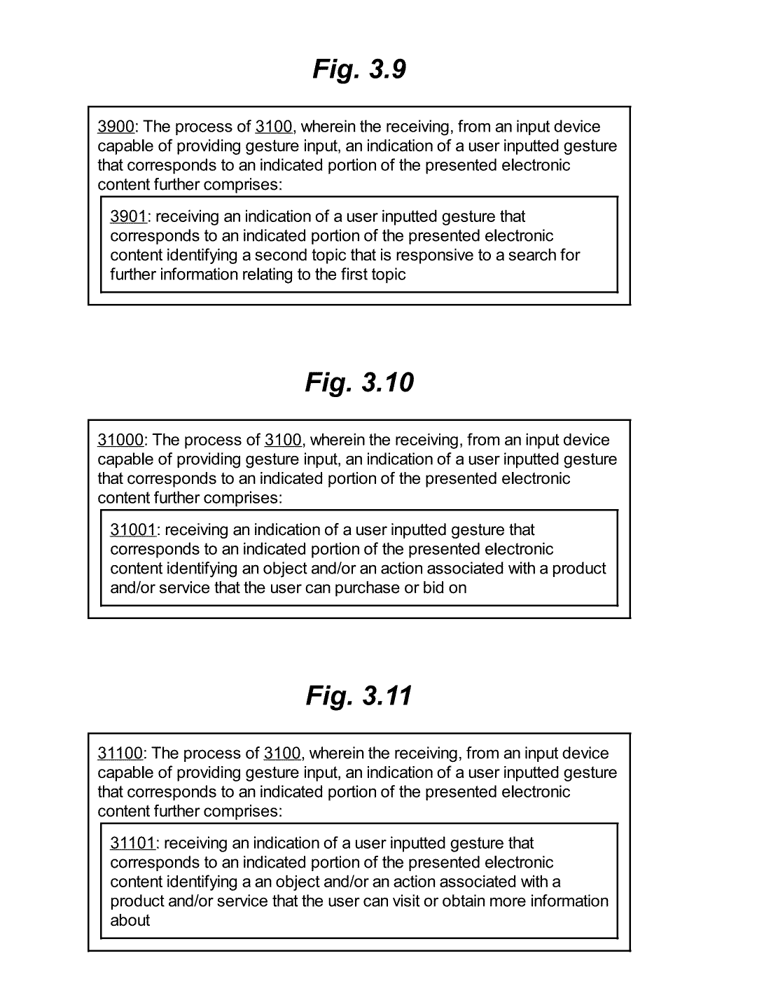

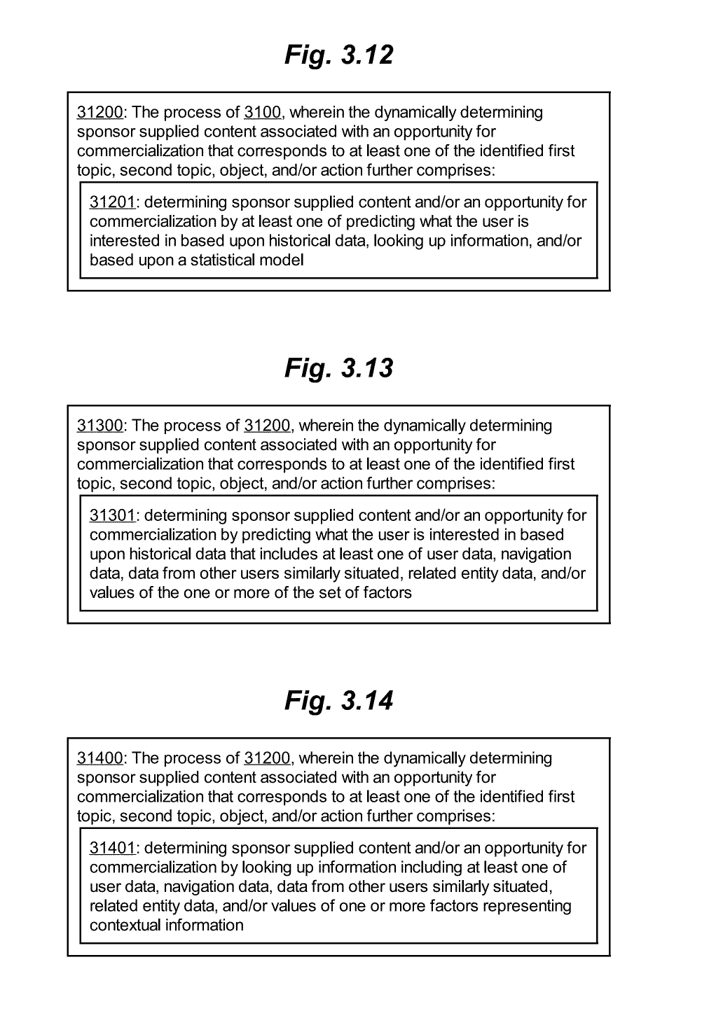

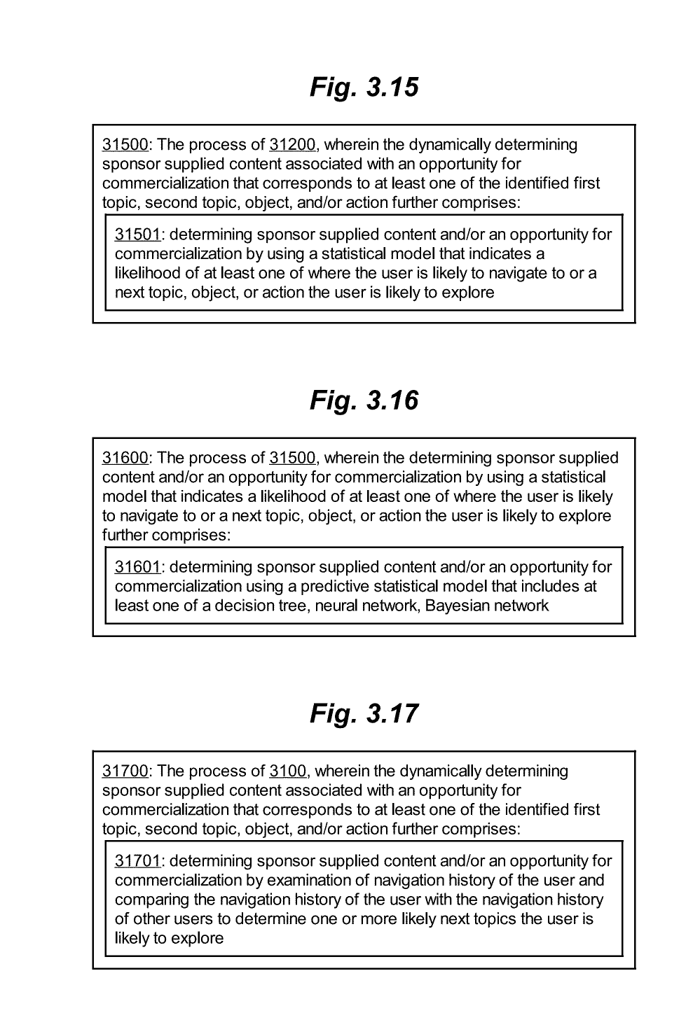

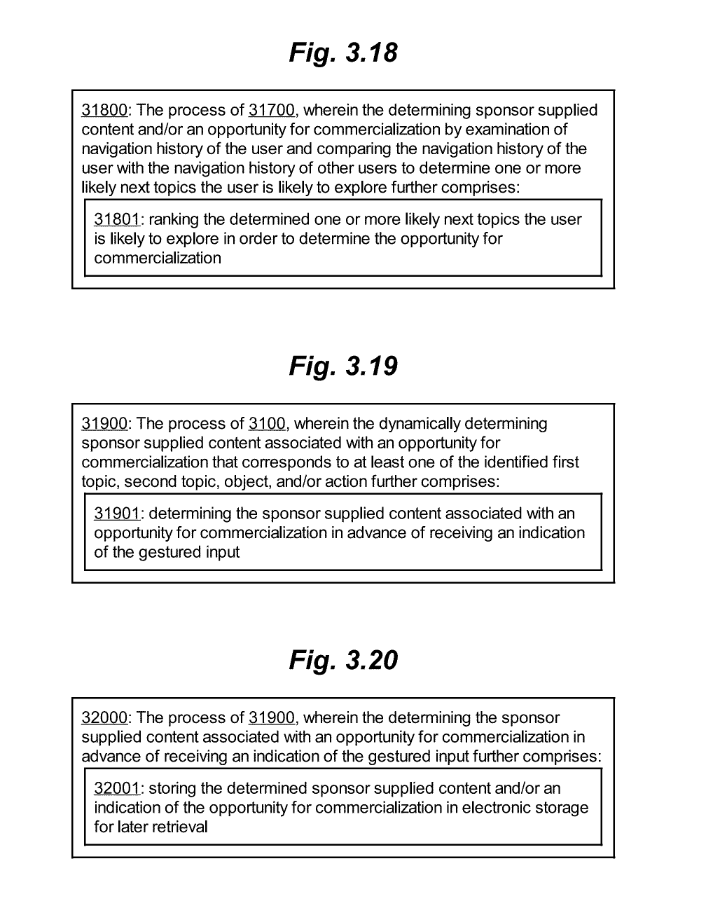

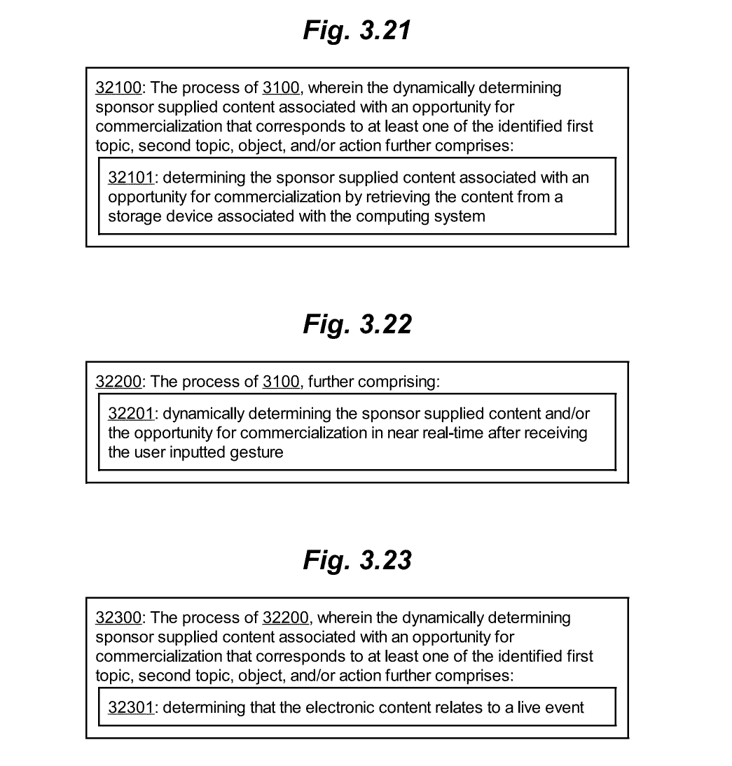

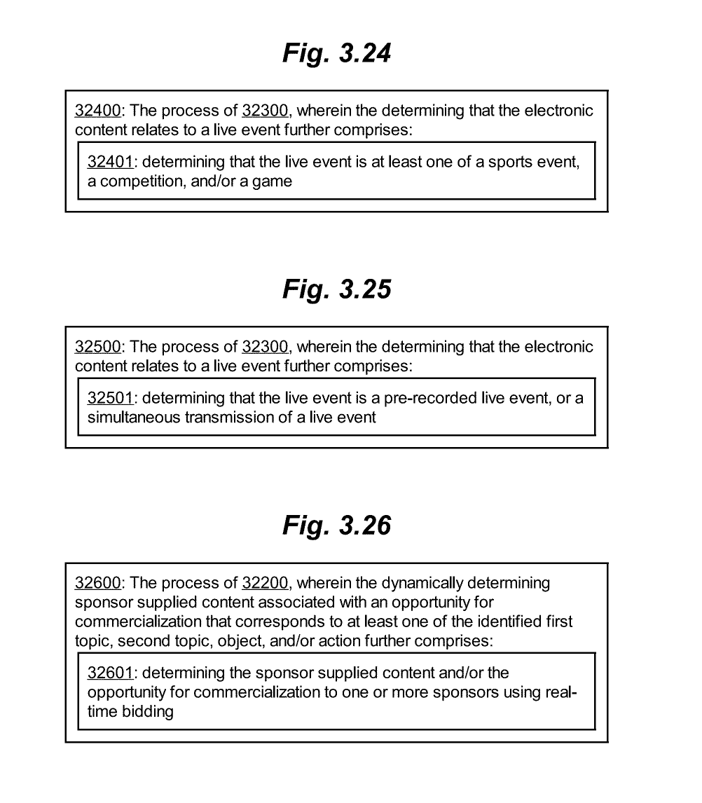

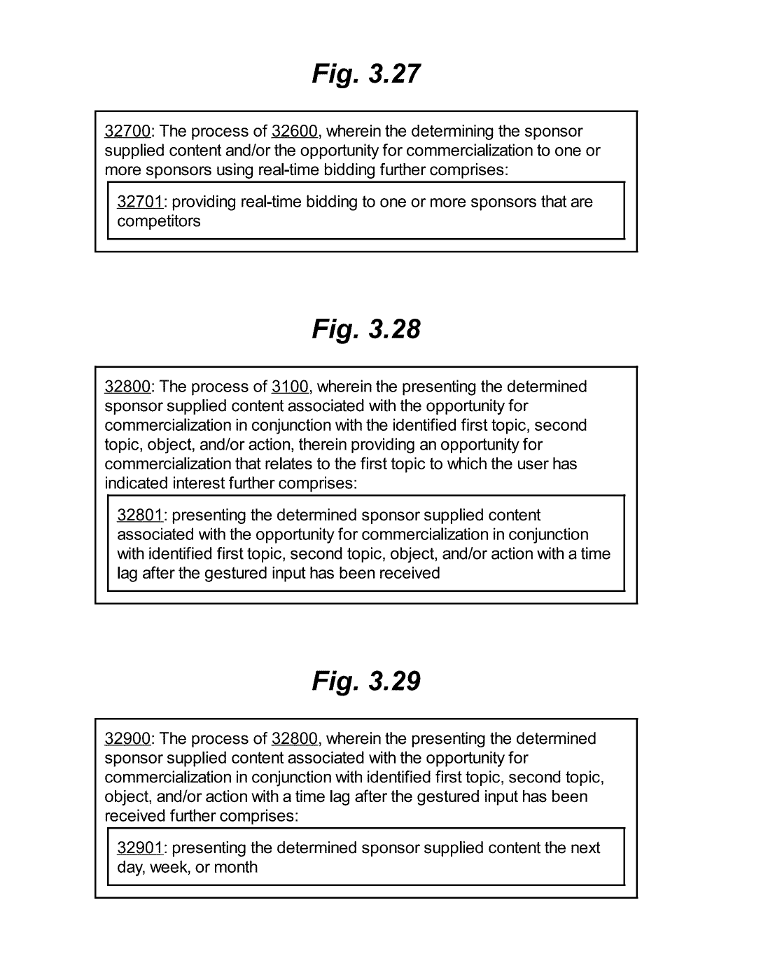

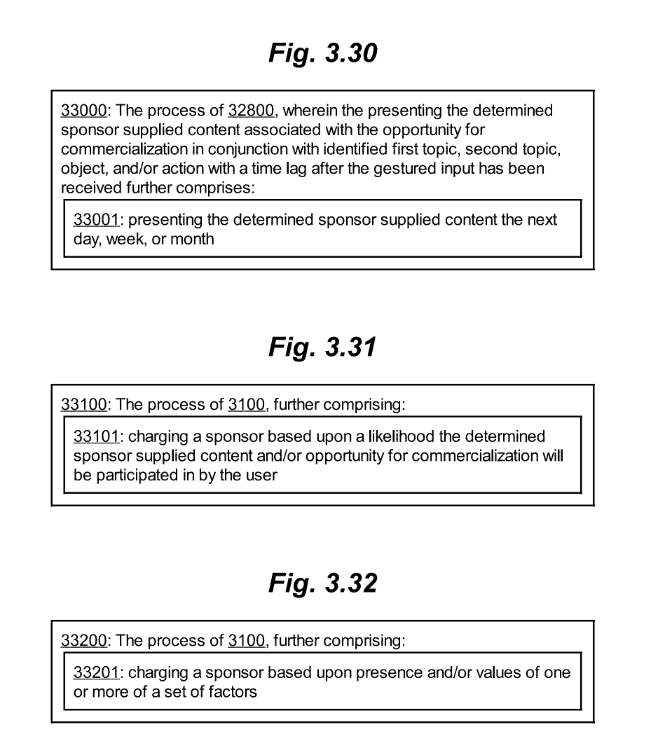

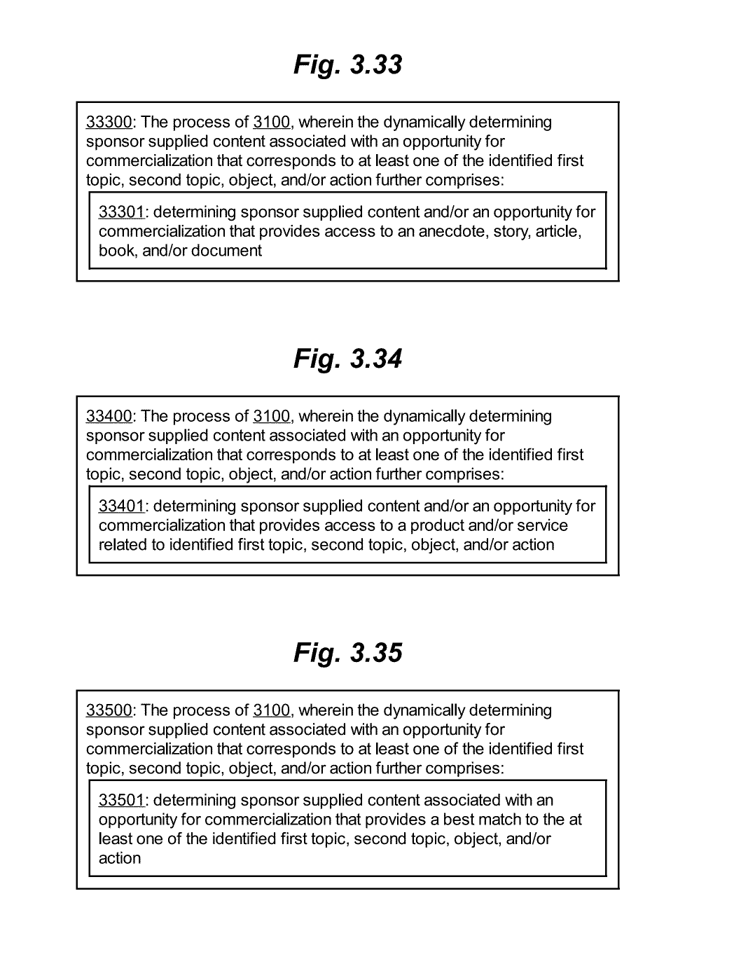

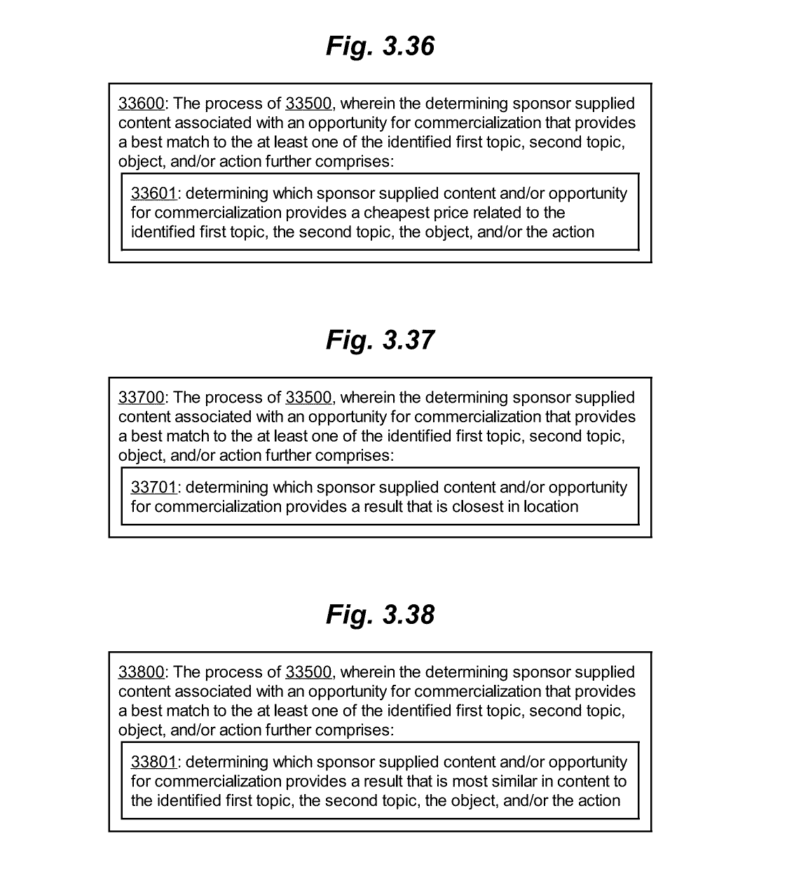

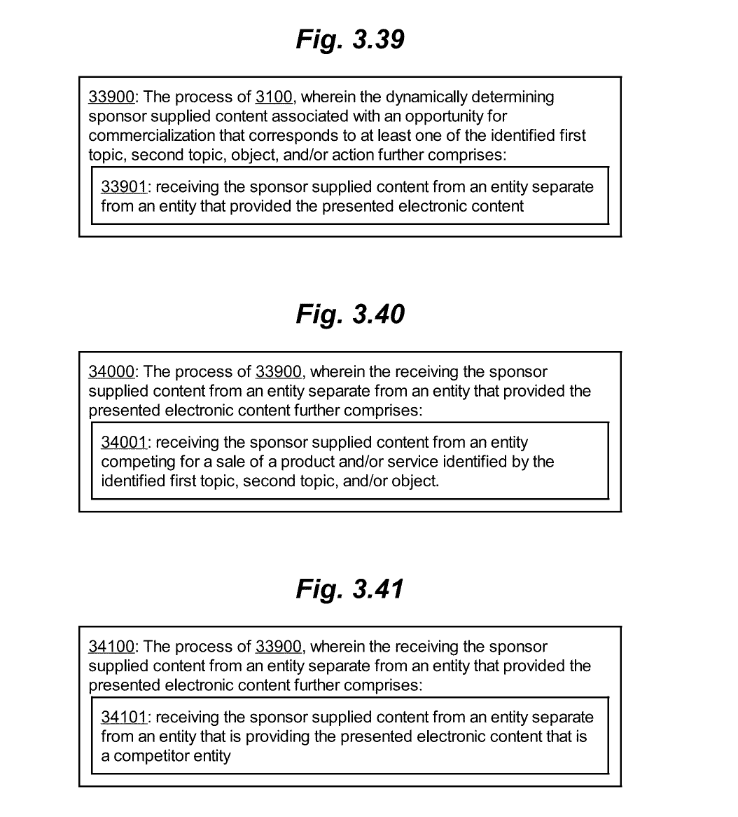

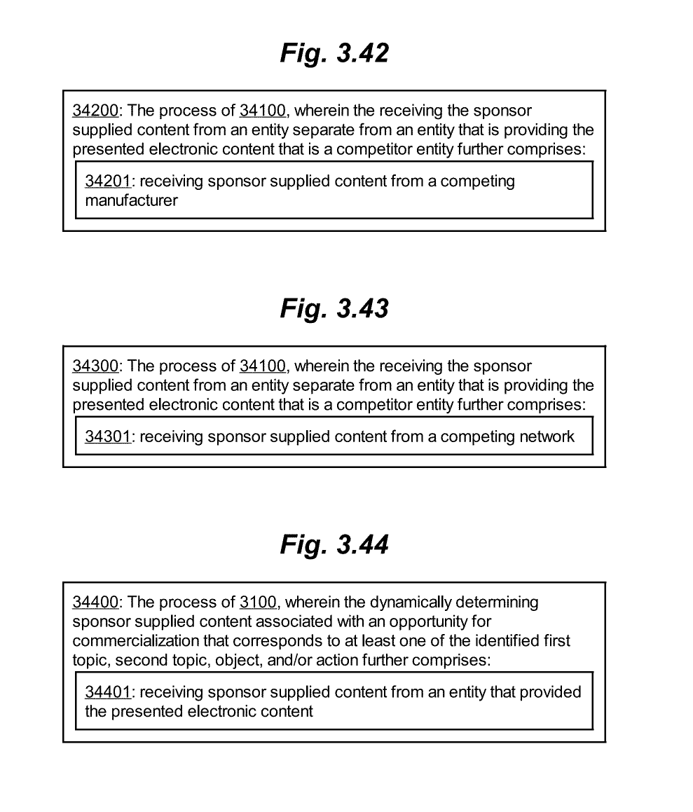

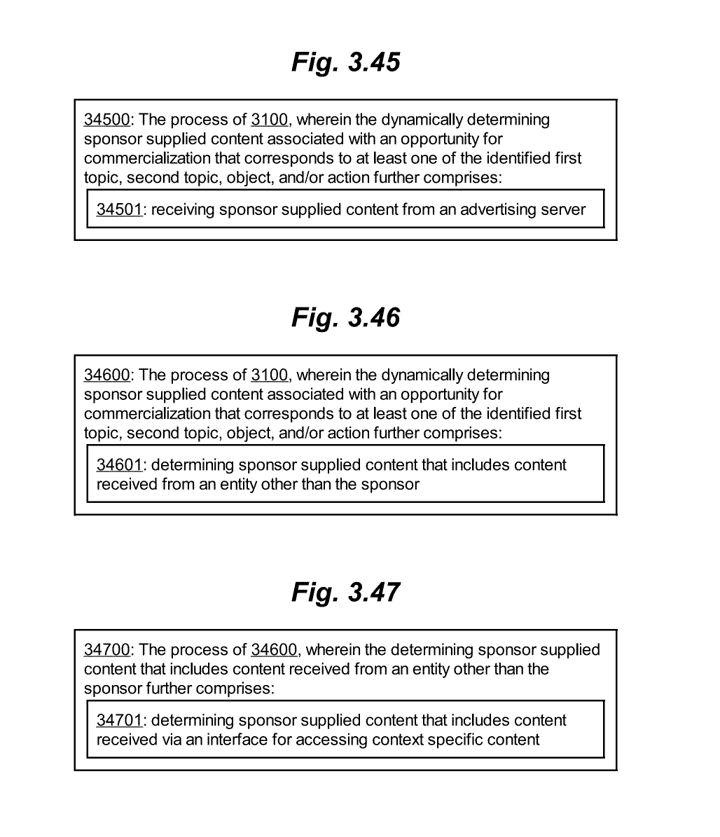

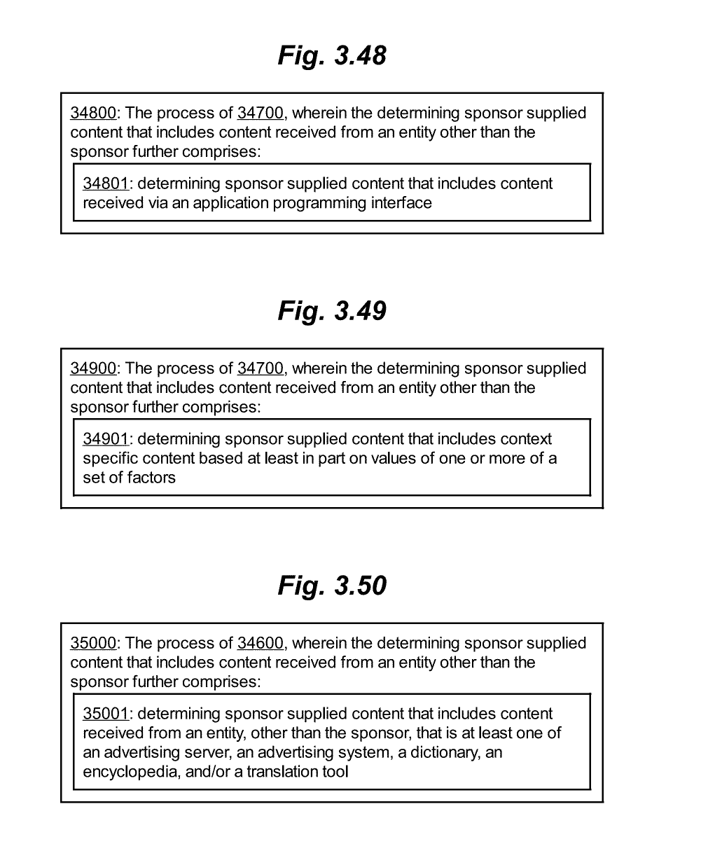

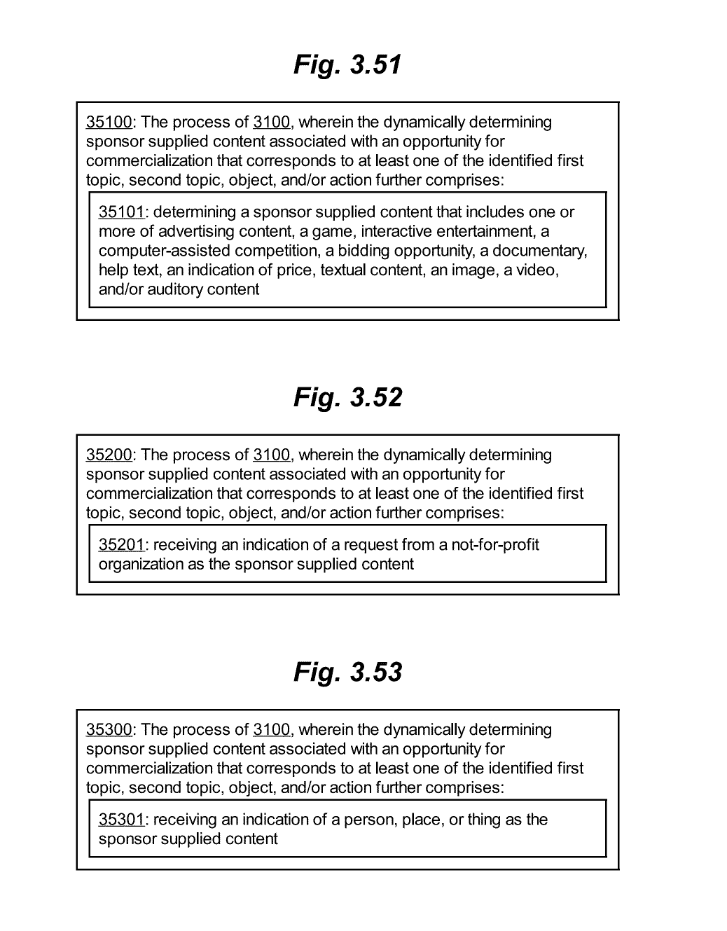

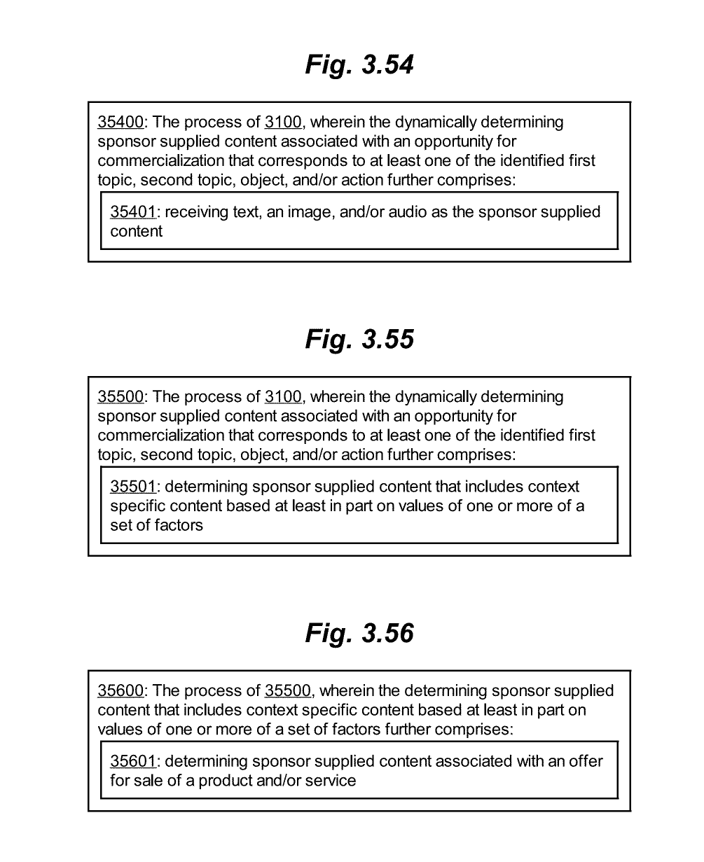

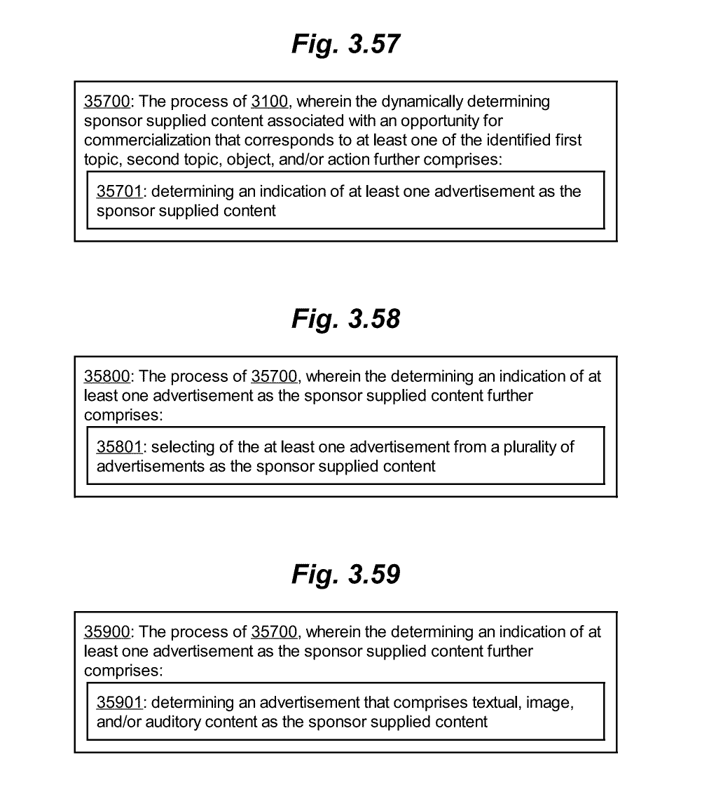

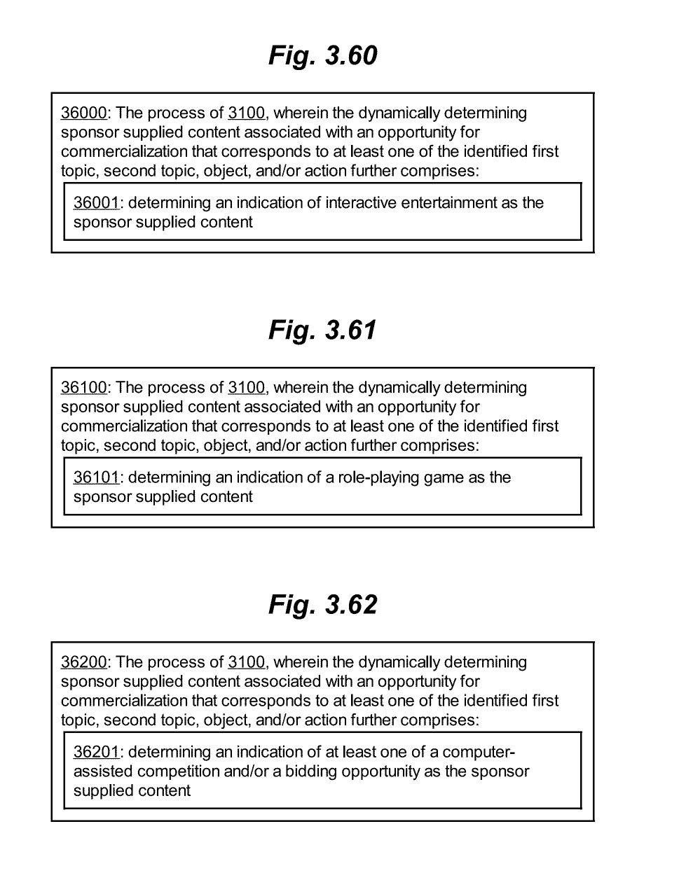

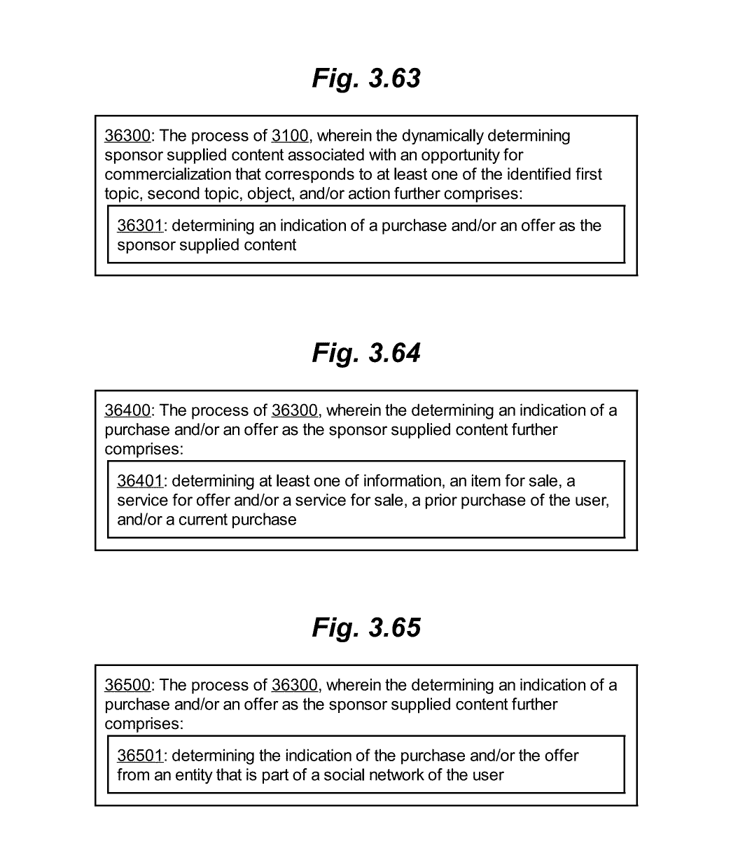

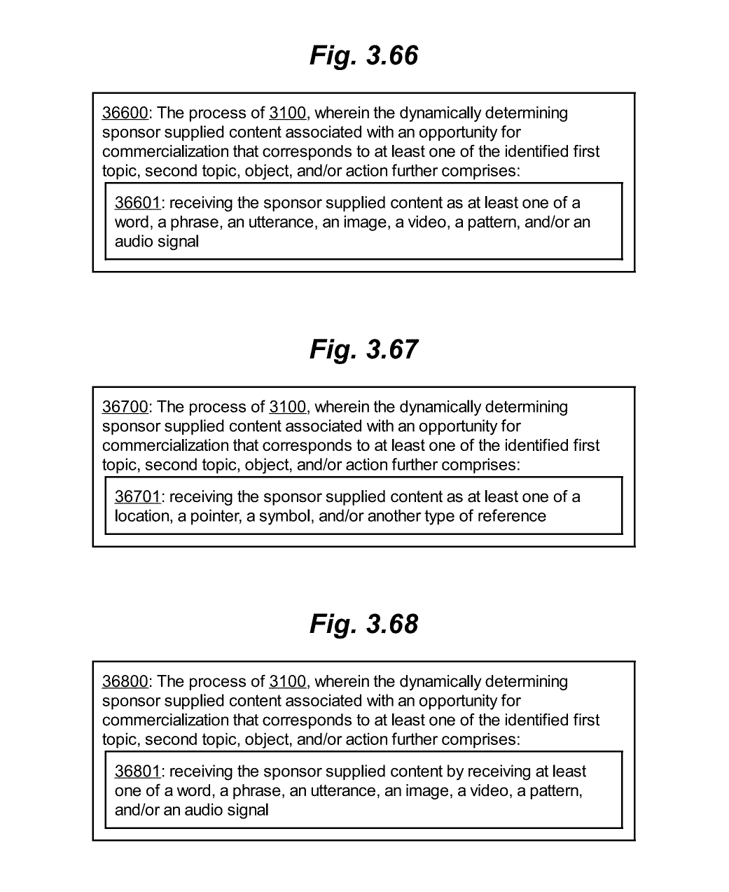

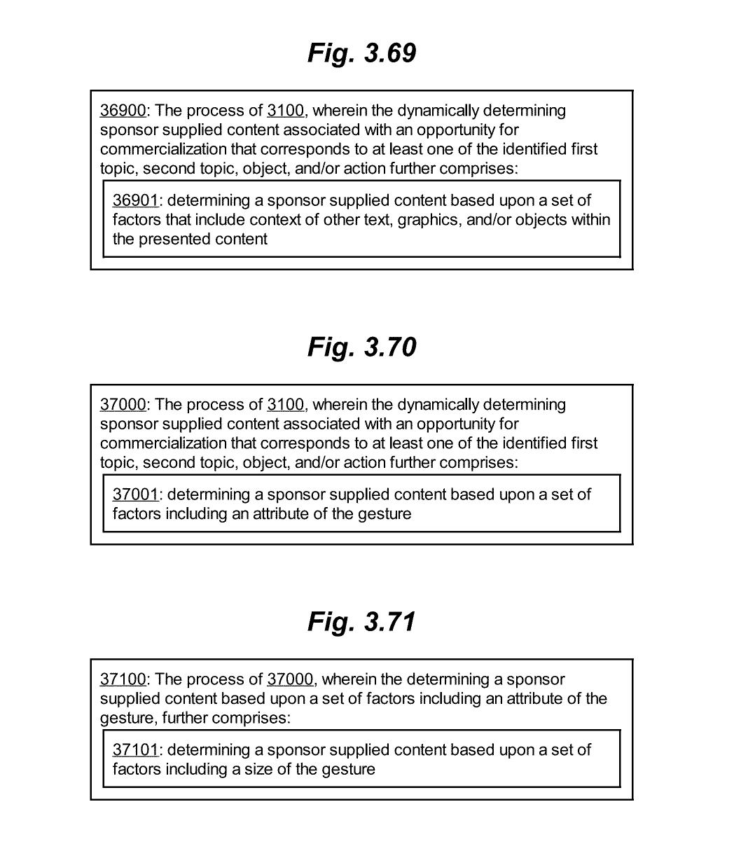

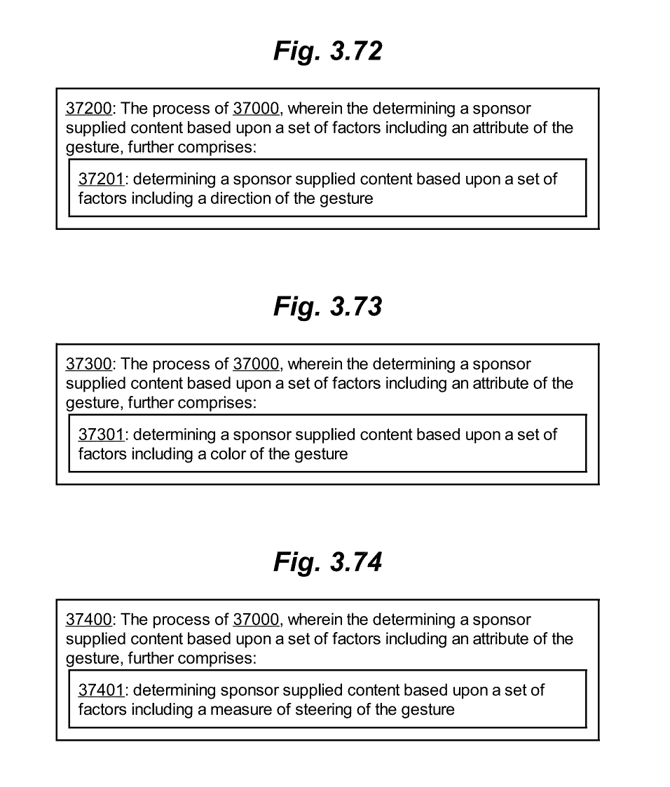

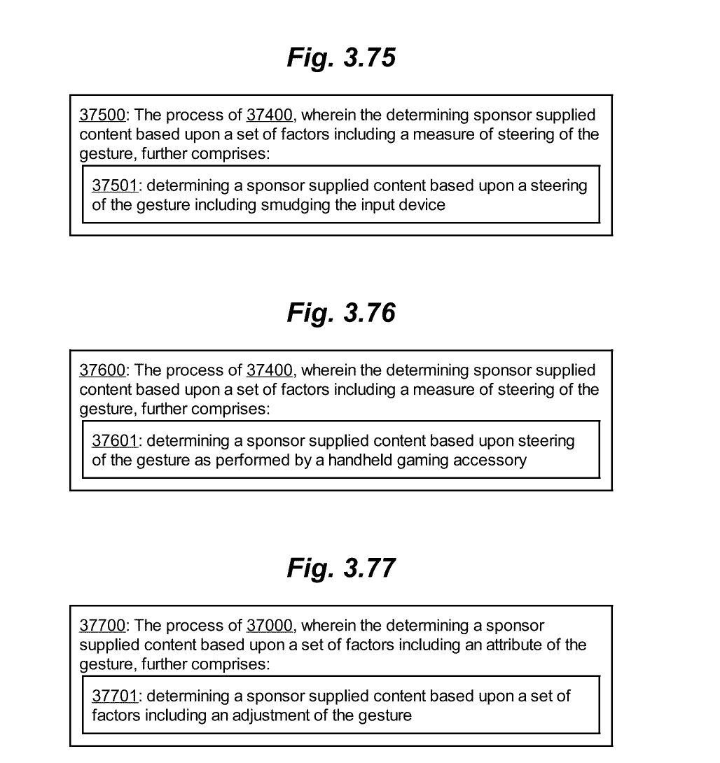

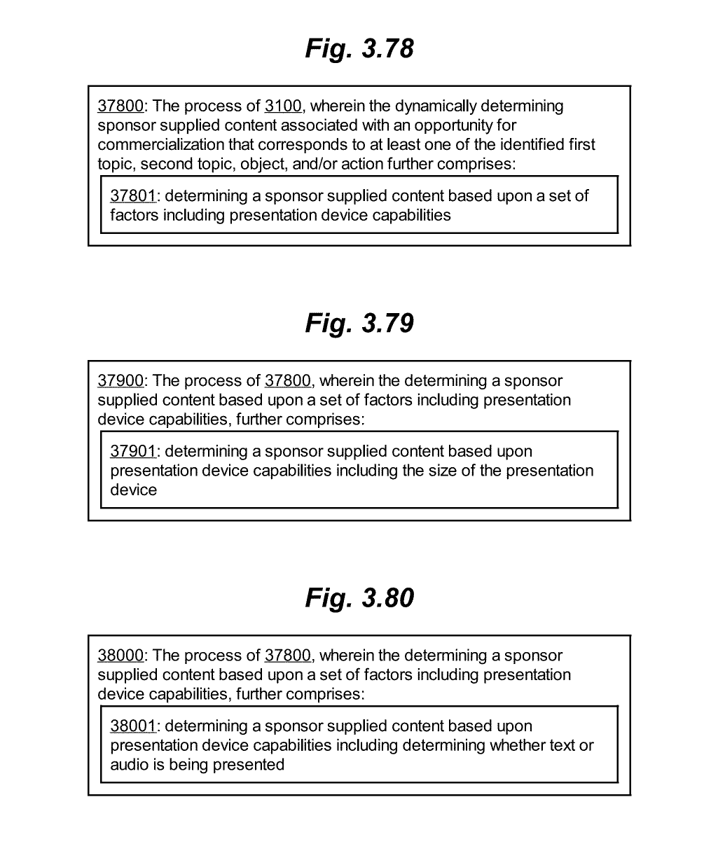

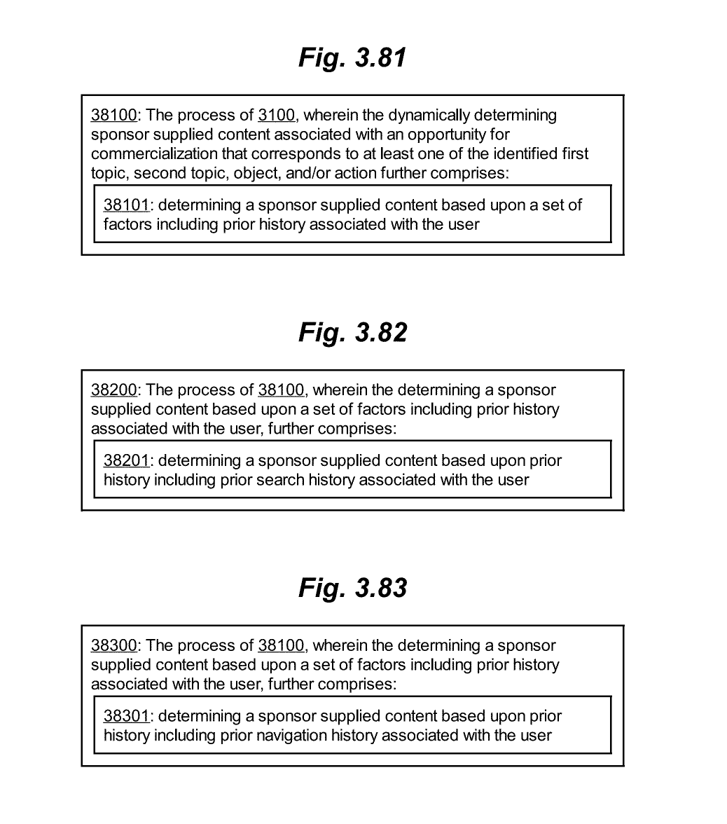

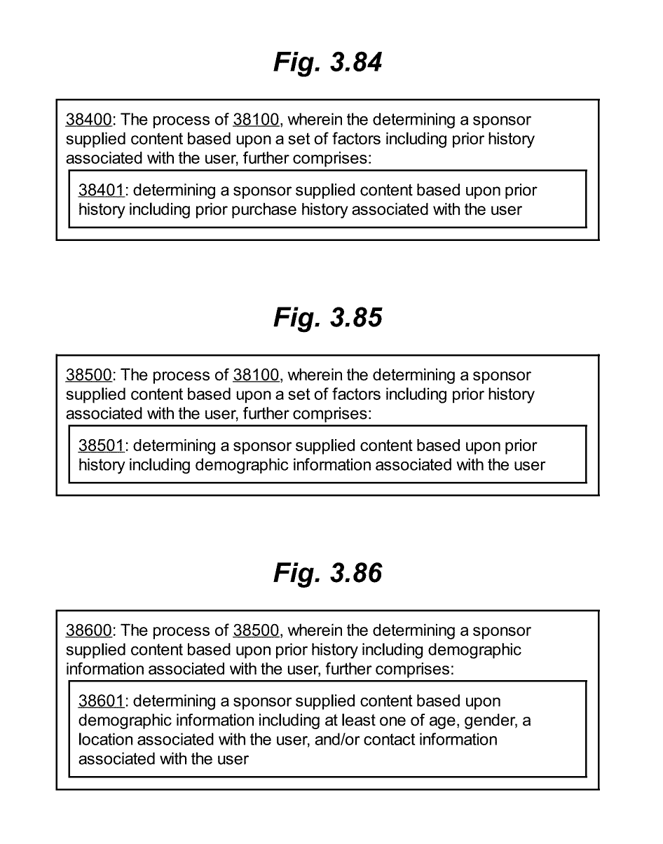

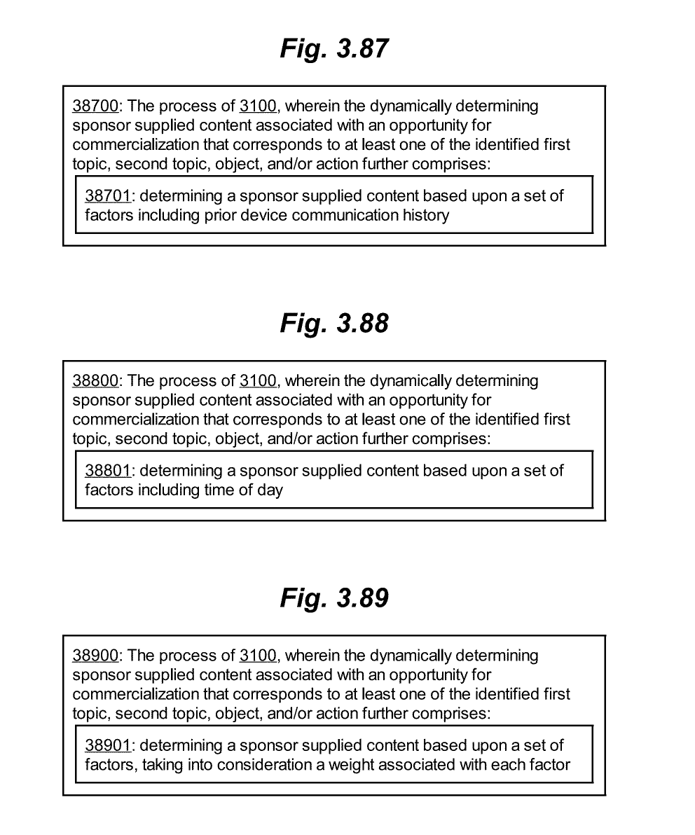

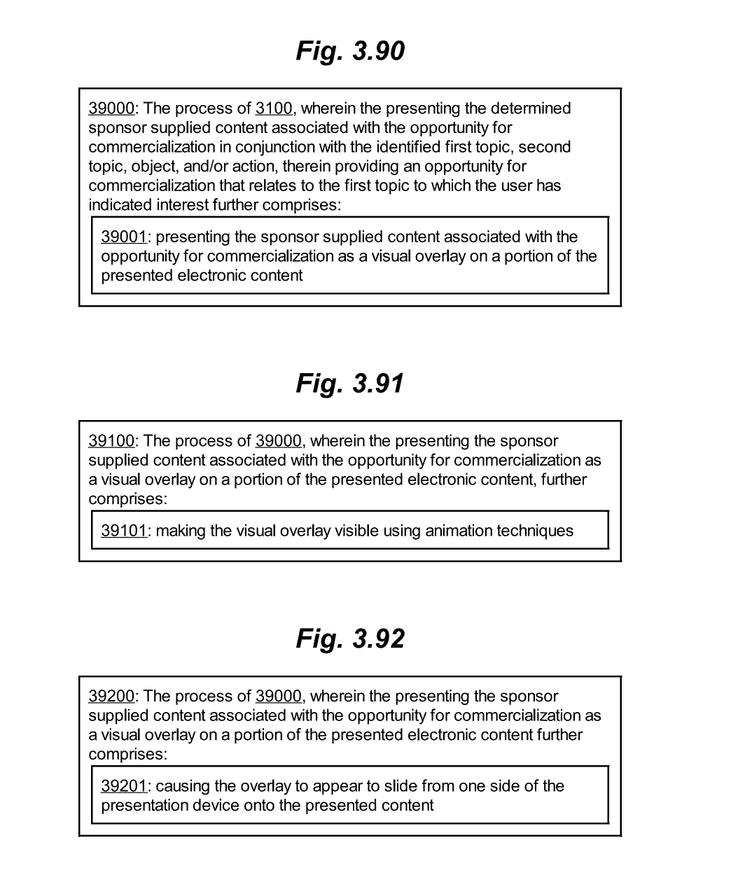

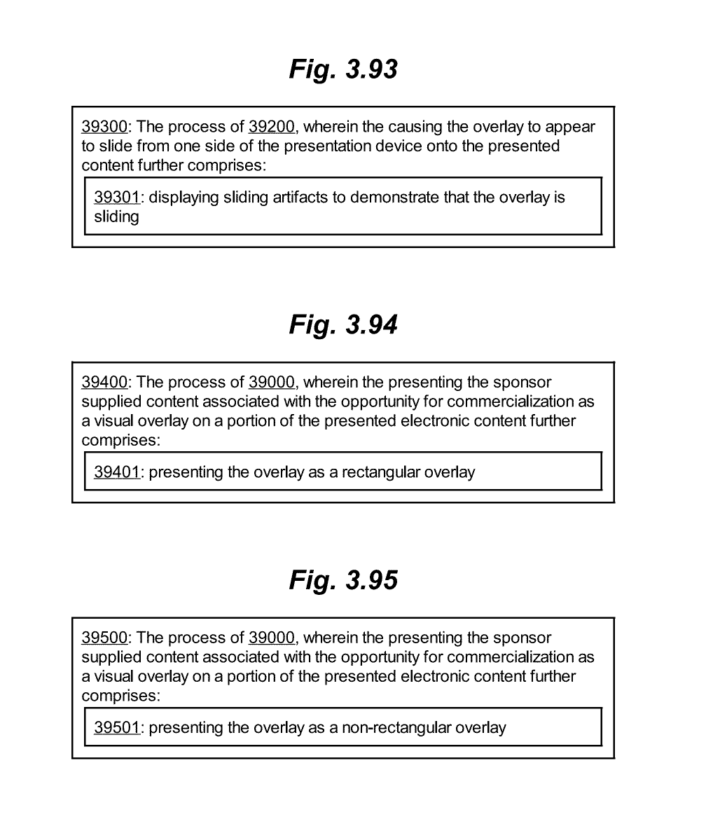

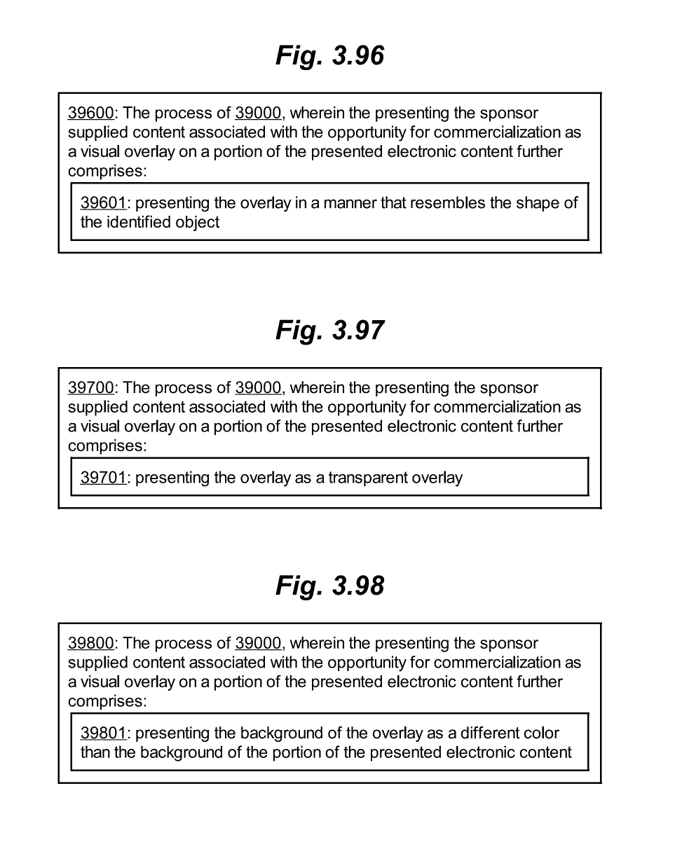

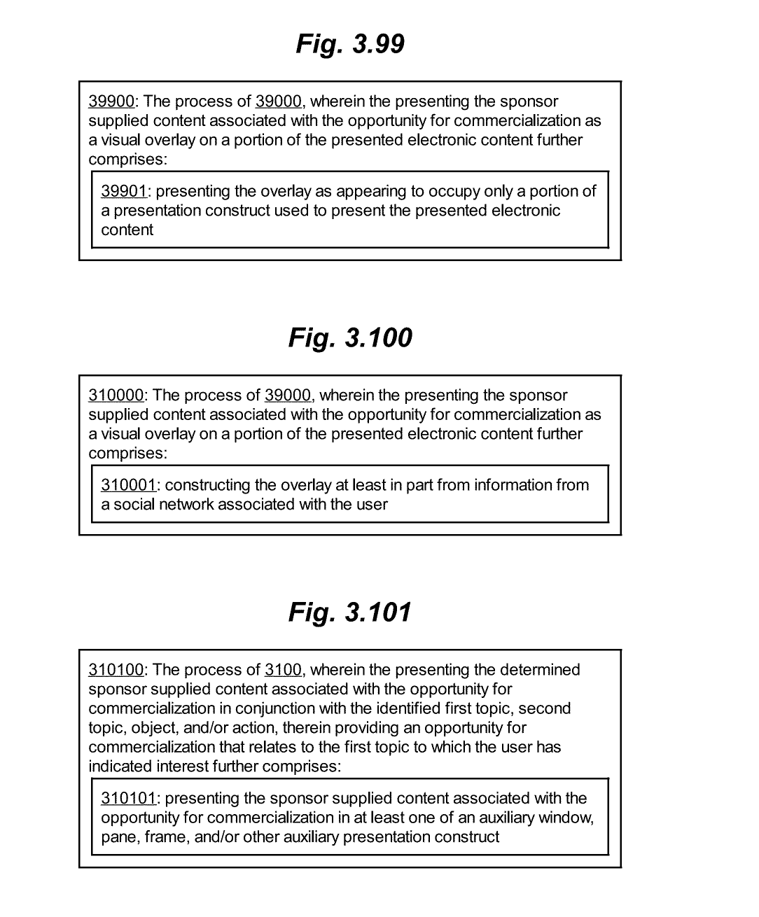

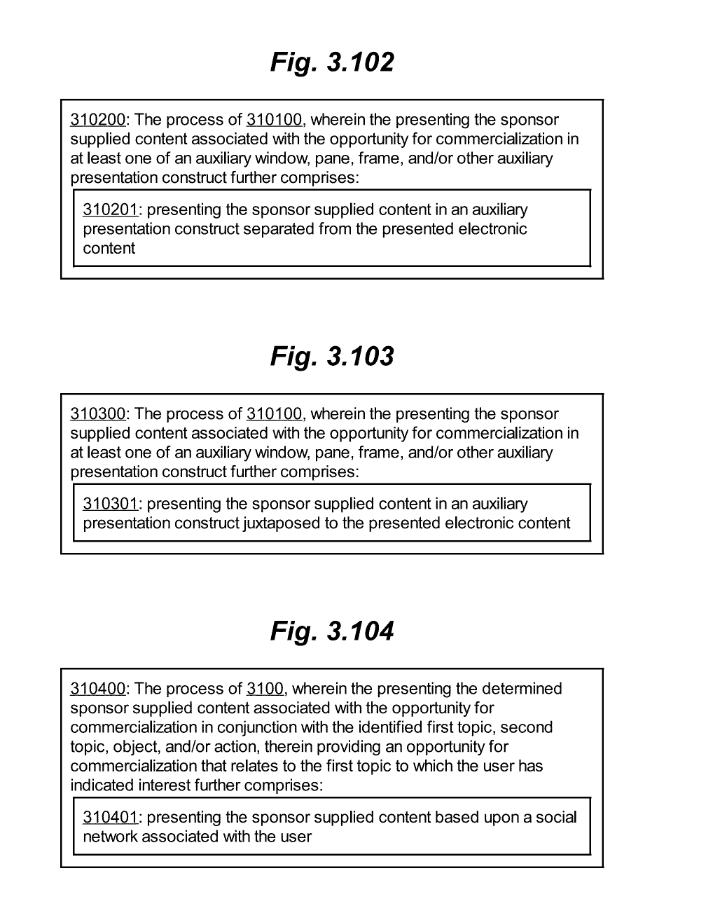

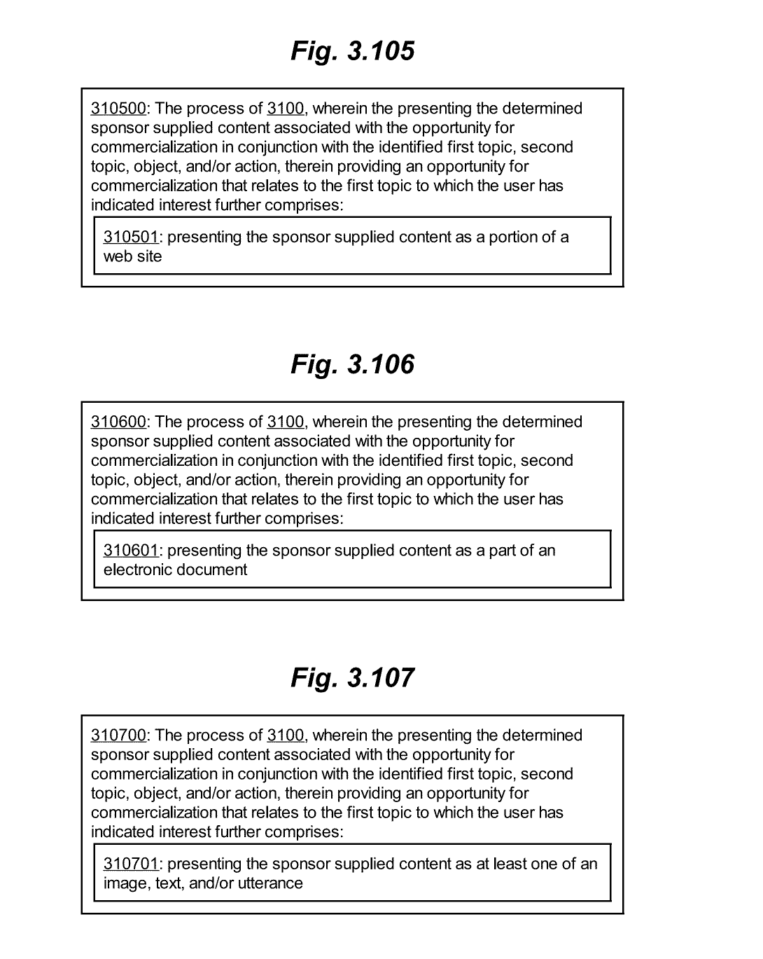

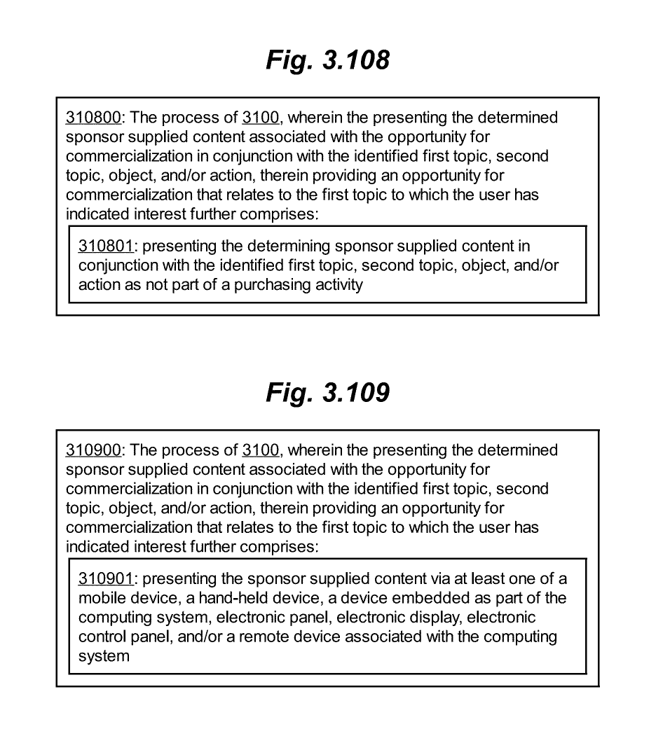

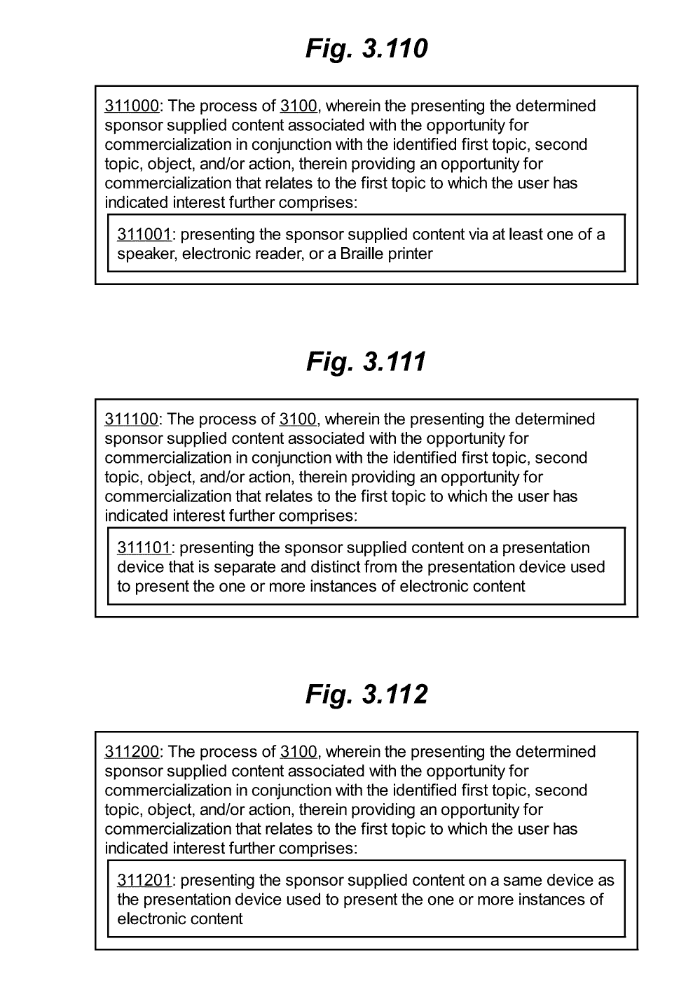

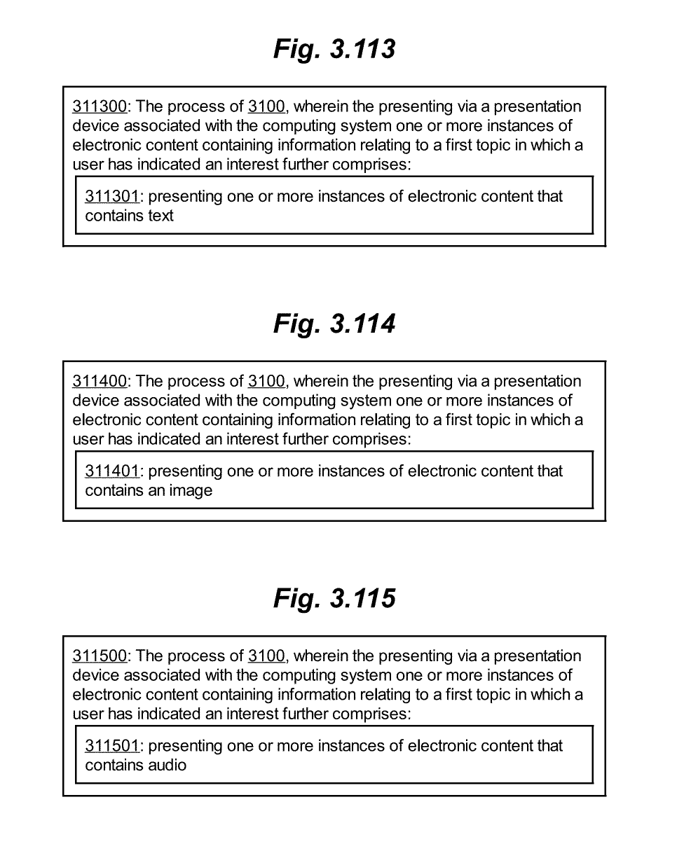

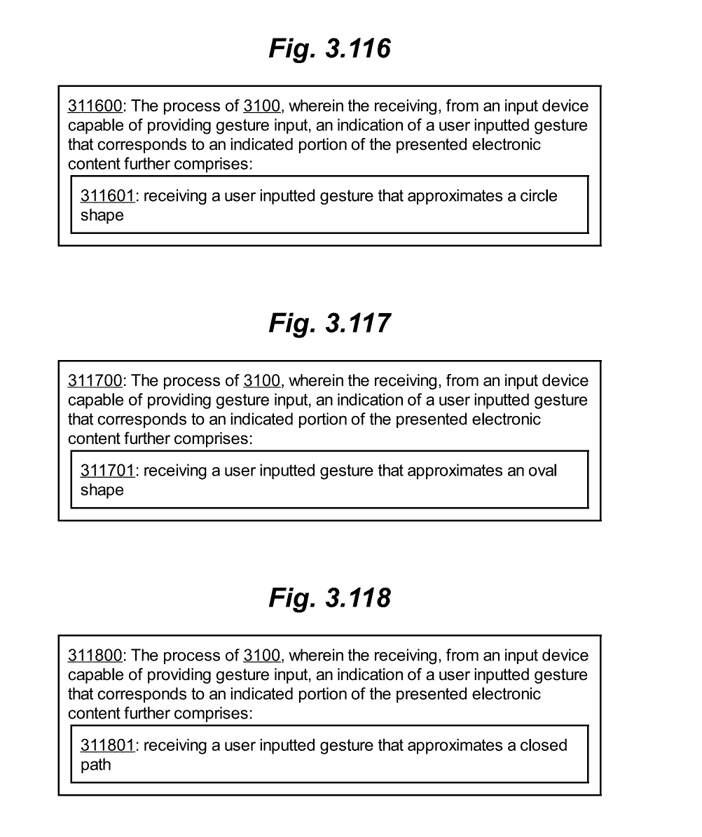

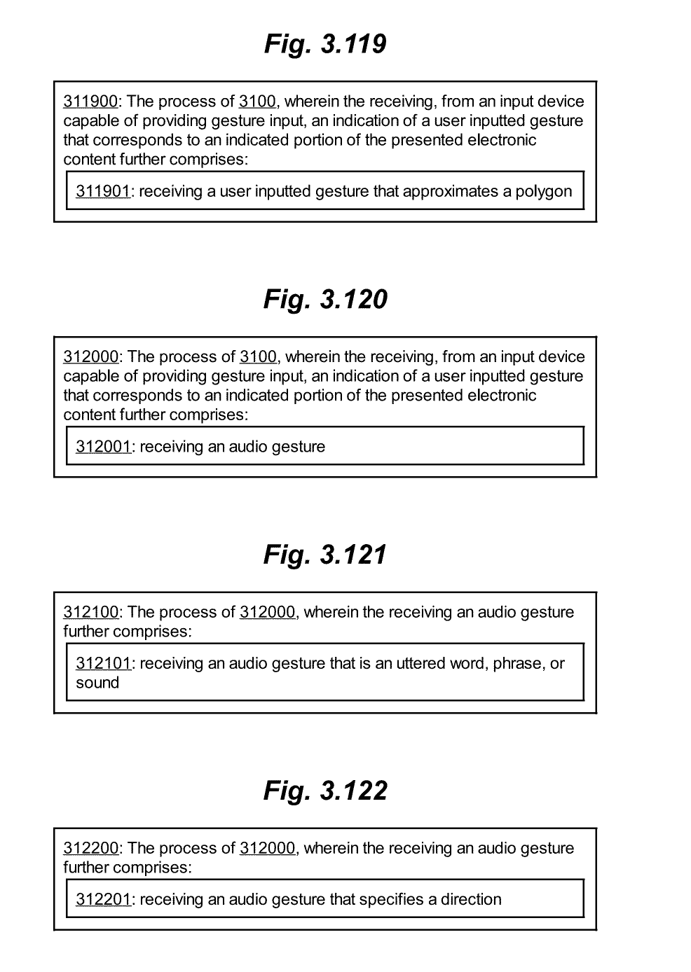

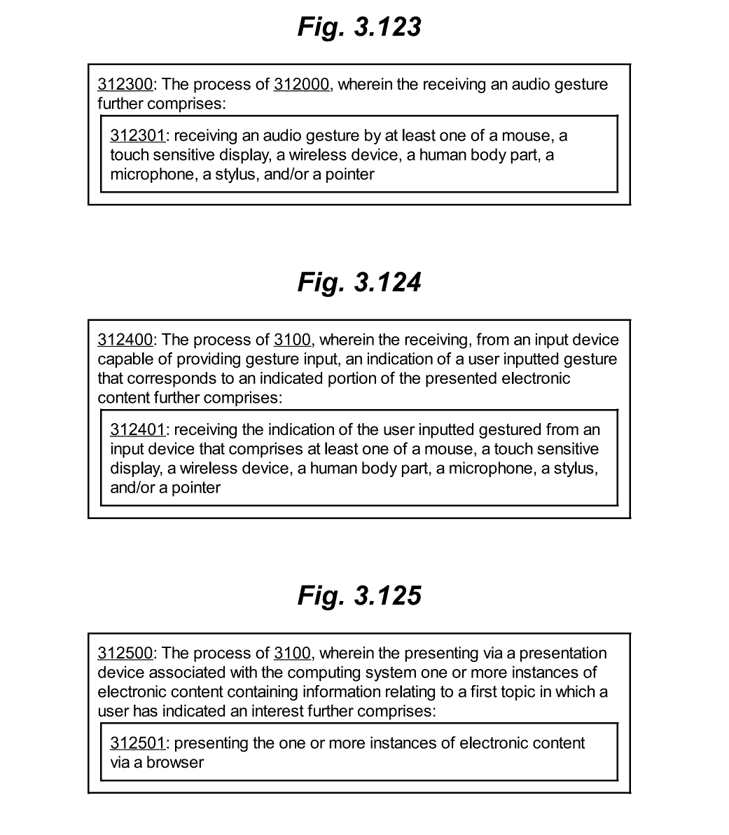

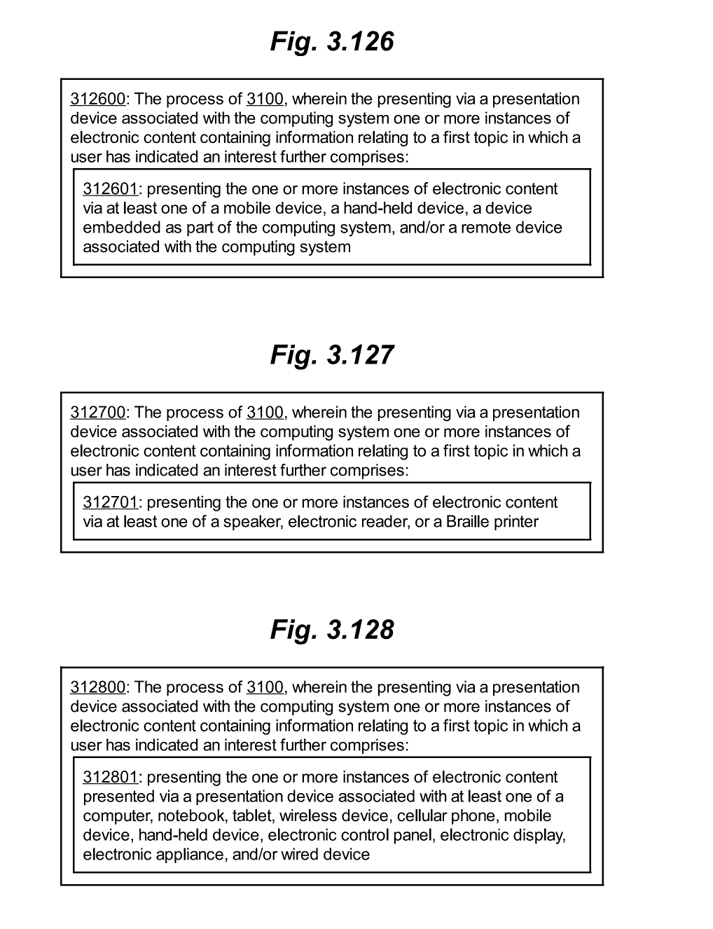

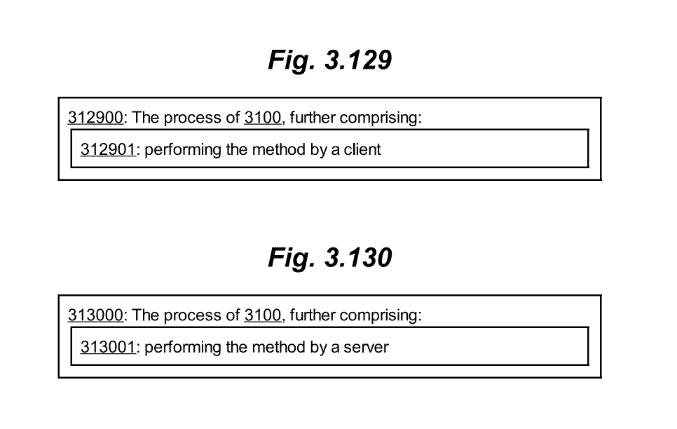

FIGS. 3.1-3.130 are example flow diagrams of various example logic that may be used to implement embodiments of a Gesture Based Content Presentation System (GBCPS). The example logic will be described with respect to the example components of example embodiments of a GBCPS as described above with respect to FIGS. 1A-2. However, it is to be understood that the flows and logic may be executed in a number of other environments, systems, and contexts, and/or in modified versions of those described. In addition, various logic blocks (e.g., operations, events, activities, or the like) may be illustrated in a “box-within-a-box” manner. Such illustrations may indicate that the logic in an internal box may comprise an optional example embodiment of the logic illustrated in one or more (containing) external boxes. However, it is to be understood that internal box logic may be viewed as independent logic separate from any associated external boxes and may be performed in other sequences or concurrently.

FIG. 3.1 is an example flow diagram of example logic in a computing system for presenting opportunities for commercialization in conjunction with browsing and/or searching for information. More particularly, FIG. 3.1 illustrates a process 3100 that includes operations performed by or at the following block(s).

At block 3101, the process performs presenting via a presentation device associated with the computing system one or more instances of electronic content containing information relating to a first topic in which a user has indicated an interest. This logic may be performed, for example, by the presentation module 114 of the GBCPS 110 described with reference to FIG. 2. Electronic content is presented via a presentation device (e.g., 20*) associated with the computing system 100. The electronic content may contain information relating to a first topic (e.g., image, category, word, entity, object subject, etc.) in which the user has expressed an interest. For example, the electronic content may be a user submitted query or an answer to same, a web page navigated to by the user, etc.

At block 3102, the process performs receiving, from an input device capable of providing gesture input, an indication of a user inputted gesture that corresponds to an indicated portion of the presented electronic content, the indicated portion of electronic content identifying a second topic related to the first topic, an object related to the first topic, and/or an action related to the first topic. This logic may be performed, for example, by the input module 111 of the GBCPS 110 described with reference to FIG. 2 by receiving (e.g., obtaining, getting, extracting, and so forth), from an input device capable of providing gesture input (e.g., devices 20*, electronic display or control panel, etc.), an indication of a user inputted gesture that corresponds to an indicated portion (e.g., indicated portion 25) of the presented electronic content. Different logic of the gesture input detection and resolution module 210, such as the audio handling logic, graphics handling logic, natural language processing, and/or gesture identification and attribute processing logic may be used to assist in this receiving block. In addition, specific device handlers 212 of the input module 111 of the GBCPS 110 described with reference to FIG. 2 may be used to determine the gestured portion. The indicated portion may be formed from contiguous or composed of separate non-contiguous parts, for example, a title with a disconnected sentence, with or without a picture, or the like. In addition, the indicated portion may represent the entire body of electronic content presented to the user or a part. Also as described elsewhere, the gestural input may be of different forms, including, for example, a circle, an oval, a closed path, a polygon, and the like. The gesture may be from a pointing device, for example, a mouse, laser pointer, a body part, control panel, and the like, or from a source of auditory input. The identified second topic, object, and/or action is related to the first topic and may be of any type of representation, including textual, auditory, images, and the like.

At block 3103, the process performs dynamically determining sponsor supplied content associated with an opportunity for commercialization that corresponds to at least one of the identified first topic, second topic, object, and/or action. This logic may be performed, for example, by the opportunity for commercialization determination module 112 of the of the GBCPS 110 described with reference to FIG. 2. The GBCPS 110 may determine sponsor supplied content either before a particular topic, object, and/or action is gestured (and, for example, stored in a library of possible opportunities for commercialization) or in response to gesturing of a particular topic, object, and/or action. In the former case, the GBCPS 110 may determine a variety of occasions (e.g., events, opportunities, locations, options, etc.) for presenting opportunities for commercialization associated with a topic, object, and/or action and offer such occasions to entities for sponsoring them. The GBCPS 110 then receives indications of the sponsor supplied content and associated opportunity for commercialization, and stores them until further needed. The indication of the sponsor supplied content and/or opportunity for commercialization may take a variety of forms including text, pointers, images, urls, or any other type of reference to content. In the latter case (for example, responsive to gesturing of a particular product and/or service, the GBCPS 110 may determine sponsor supplied content and/or opportunities for commercialization in near real-time, for example by notifying any listeners (sponsors awaiting such opportunities) that an offer period is now open and bids are being accepted. Further, the opportunity for commercialization determination module 112 of the of the GBCPS 110 described with reference to FIG. 2 may employ the factor determination module 113 to associate, link, or depend various context such as are represented by one or more of a set of factors (e.g., the context of the gesture, the user, or of the represented product and/or service, prior history associated with the user or the system, attributes of the gestures, associations of opportunities for commercialization stored by the GBCPS 110 and the like). As described further elsewhere, the opportunities for commercialization may include any kind of opportunity such as advertisements, games, and/or entertainment that may result in a purchase or an offer for purchase, bids, bets, competitions, or the like.

At block 3104, the process performs presenting the determined sponsor supplied content associated with the opportunity for commercialization in conjunction with the identified first topic, second topic, object, and/or action, therein providing an opportunity for commercialization that relates to the first topic to which the user has indicated interest. This logic may be performed, for example, by the presentation module 114 of the GBCPS 110 described with reference to FIG. 2. In some embodiments the GBCPS 110 presents the sponsor supplied content associated with the opportunity for commercialization in a variety of manners. As described in detail elsewhere, the indicated opportunity for commercialization may include any type of content that can be shown to or navigated to by the user. For example, the opportunity for commercialization may include advertising, web pages, code, images, audio clips, video clips, speech, or other opportunities for commercialization such as a product or service offer or sale, competitions, or the like. The opportunity for commercialization may be presented (e.g., shown, displayed, played back, outputted, rendered, illustrated, or the like) as overlaid content or juxtaposed to the already presented electronic content, using additional presentation constructs (e.g., windows, frames, panes, dialog boxes, or the like) or within already presented constructs. In some cases, the user is navigated to the opportunity for commercialization being presented by, for example, changing the user's focus point on the presentation device. In some embodiments at least a portion (e.g., some or all) of the originally presented content (from which the gesture was made) is also presented in order to provide visual and/or auditory context. For example, some indication of gestured text may be shown at the same time as the opportunity for commercialization in order to show the user a correspondence between the gestured content and the opportunity for commercialization. FIGS. 1B-1F show different examples of the many ways of presenting the opportunity for commercialization in conjunction with the corresponding electronic content to maintain context.

FIG. 3.2 is an example flow diagram of example logic illustrating an example embodiment of process 3100 of FIG. 3.1. More particularly, FIG. 3.2 illustrates a process 3200 that includes the process 3100, wherein the presenting via a presentation device associated with the computing system one or more instances of electronic content containing information relating to a first topic in which a user has indicated an interest further comprises operations performed by or at one or more of the following block(s).

At block 3201, the process performs presenting one or more web pages. This logic may be performed, for example, by the presentation module 114 of the GBCPS 110 described with reference to FIG. 2. In some embodiments, the GBCPS 110 presents one or more web pages as the electronic content. Typically, these pages are accessed via a url or uri, but could be by any reference thereto.

FIG. 3.3 is an example flow diagram of example logic illustrating an example embodiment of process 3100 of FIG. 3.1. More particularly, FIG. 3.3 illustrates a process 3300 that includes the process 3100, wherein the presenting via a presentation device associated with the computing system one or more instances of electronic content containing information relating to a first topic in which a user has indicated an interest further comprises operations performed by or at one or more of the following block(s).

At block 3301, the process performs presenting one or more portions of an electronic document. This logic may be performed, for example, by the presentation module 114 of the GBCPS 110 described with reference to FIG. 2. In some embodiments, the GBCPS 110 presents portions of an electronic document (such as a page of a book, an article, a part of a newspaper, etc.) as the electronic content.

FIG. 3.4 is an example flow diagram of example logic illustrating an example embodiment of process 3100 of FIG. 3.1. More particularly, FIG. 3.4 illustrates a process 3400 that includes the process 3100, wherein the presenting via a presentation device associated with the computing system one or more instances of electronic content containing information relating to a first topic in which a user has indicated an interest further comprises operations performed by or at one or more of the following block(s).

At block 3401, the process performs presenting electronic content containing information indicating that the user has an interest to seek knowledge, buy something, and/or seek additional information. This logic may be performed, for example, by the presentation module 114 of the GBCPS 110 described with reference to FIG. 2. In some embodiments, the GBCPS 110 presents electronic content that shows a users interest in seeking knowledge (such as a web page from a “wiki,” dictionary, or encyclopedia), or in purchasing an object (such as a buying portal like “Amazon.com.”

FIG. 3.5 is an example flow diagram of example logic illustrating an example embodiment of process 3100 of FIG. 3.1. More particularly, FIG. 3.5 illustrates a process 3500 that includes the process 3100, wherein the presenting via a presentation device associated with the computing system one or more instances of electronic content containing information relating to a first topic in which a user has indicated an interest further comprises operations performed by or at one or more of the following block(s).

At block 3501, the process performs presenting one or more instances of electronic content in response to the user submitting a query. This logic may be performed, for example, by the presentation module 114 of the GBCPS 110 described with reference to FIG. 2. In some embodiments, the GBCPS 110 presents an answer to a user query as the electronic content.

FIG. 3.6 is an example flow diagram of example logic illustrating an example embodiment of process 3500 of FIG. 3.5. More particularly, FIG. 3.6 illustrates a process 3600 that includes the process 3500, wherein the dynamically determining sponsor supplied content associated with an opportunity for commercialization that corresponds to at least one of the identified first topic, second topic, object, and/or action further comprises operations performed by or at one or more of the following block(s).

At block 3601, the process performs determining sponsor supplied content and/or an opportunity for commercialization that provides an answer to the query. This logic may be performed, for example, by the opportunity for commercialization determination module 112 of the of the GBCPS 110 described with reference to FIG. 2. In some embodiments, the GBCPS 110 determines sponsor supplied content or a opportunity for commercialization that will answer to a user query. For example, providing an game to learn how to do a task may answer a query about how to do the task.

FIG. 3.7 is an example flow diagram of example logic illustrating an example embodiment of process 3500 of FIG. 3.5. More particularly, FIG. 3.7 illustrates a process 3700 that includes the process 3500, wherein the dynamically determining sponsor supplied content associated with an opportunity for commercialization that corresponds to at least one of the identified first topic, second topic, object, and/or action further comprises operations performed by or at one or more of the following block(s).

At block 3701, the process performs determining sponsor supplied content and/or an opportunity for commercialization that will aid the user in answering the query. This logic may be performed, for example, by the opportunity for commercialization determination module 112 of the of the GBCPS 110 described with reference to FIG. 2. In some embodiments, the GBCPS 110 determines sponsor supplied content or a opportunity for commercialization that will help a user to answer a query. For example, providing a map or directions along with an advertisement can provide an answer to a query at the same time as providing a opportunity for commercialization.

FIG. 3.8 is an example flow diagram of example logic illustrating an example embodiment of process 3500 of FIG. 3.5. More particularly, FIG. 3.8 illustrates a process 3800 that includes the process 3500, wherein the dynamically determining sponsor supplied content associated with an opportunity for commercialization that corresponds to at least one of the identified first topic, second topic, object, and/or action further comprises operations performed by or at one or more of the following block(s).

At block 3801, the process performs determining sponsor supplied content and/or an opportunity for commercialization that offers access to an anecdote, story, article, book, and/or document relating to the query. This logic may be performed, for example, by the opportunity for commercialization determination module 112 of the of the GBCPS 110 described with reference to FIG. 2. In some embodiments, the GBCPS 110 determines sponsor supplied content or a opportunity for commercialization that offers access to an anecdote, story, article, book and/or document that relates (to the answer to) a query. For example, providing an ad for a book along can provide an answer to a query at the same time as providing a opportunity for commercialization.

FIG. 3.9 is an example flow diagram of example logic illustrating an example embodiment of process 3100 of FIG. 3.1. More particularly, FIG. 3.9 illustrates a process 3900 that includes the process 3100, wherein the receiving, from an input device capable of providing gesture input, an indication of a user inputted gesture that corresponds to an indicated portion of the presented electronic content further comprises operations performed by or at one or more of the following block(s).

At block 3901, the process performs receiving an indication of a user inputted gesture that corresponds to an indicated portion of the presented electronic content identifying a second topic that is responsive to a search for further information relating to the first topic. This logic may be performed, for example, by the input module 111 of the GBCPS 110 described with reference to FIG. 2. In some embodiments, the GBCPS 110 determines that the gesture has identified another topic, for example a subtopic or a topic that the user is further interested in, in response to a user search for further information regarding the first topic. This could occur by the user navigating via a link or by some other means of following an object from the presented content.

FIG. 3.10 is an example flow diagram of example logic illustrating an example embodiment of process 3100 of FIG. 3.1. More particularly, FIG. 3.10 illustrates a process 31000 that includes the process 3100, wherein the receiving, from an input device capable of providing gesture input, an indication of a user inputted gesture that corresponds to an indicated portion of the presented electronic content further comprises operations performed by or at one or more of the following block(s).

At block 31001, the process performs receiving an indication of a user inputted gesture that corresponds to an indicated portion of the presented electronic content identifying an object and/or an action associated with a product and/or service that the user can purchase or bid on. This logic may be performed, for example, by the input module 111 of the GBCPS 110 described with reference to FIG. 2. In some embodiments, the GBCPS 110 determines that the gesture has identified an object and/or an action associated with a product and/or a service. For example, the user may have identified a pair of shoes that the athlete is wearing on a web page regarding the Olympic games. By the GBCPS 110 presenting a opportunity for commercialization, the user may be able to bid on that athletes shoes or a pair like them.

FIG. 3.11 is an example flow diagram of example logic illustrating an example embodiment of process 3100 of FIG. 3.1. More particularly, FIG. 3.11 illustrates a process 31100 that includes the process 3100, wherein the receiving, from an input device capable of providing gesture input, an indication of a user inputted gesture that corresponds to an indicated portion of the presented electronic content further comprises operations performed by or at one or more of the following block(s).

At block 31101, the process performs receiving an indication of a user inputted gesture that corresponds to an indicated portion of the presented electronic content identifying a an object and/or an action associated with a product and/or service that the user can visit or obtain more information about. This logic may be performed, for example, by the input module 111 of the GBCPS 110 described with reference to FIG. 2. In some embodiments, the GBCPS 110 determines that the gesture has identified an object and/or an action associated with a product and/or a service that the user can obtain more information about. For example, the user may have identified a pair of shoes that the athlete is wearing on a web page regarding the Olympic games. By the GBCPS 110 presenting a opportunity for commercialization, the user may be able to find out exactly what kind of shoes that the athlete is wearing and possibly purchase a pair like them.

FIG. 3.12 is an example flow diagram of example logic illustrating an example embodiment of process 3100 of FIG. 3.1. More particularly, FIG. 3.12 illustrates a process 31200 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 31201, the process performs determining sponsor supplied content and/or an opportunity for commercialization by at least one of predicting what the user is interested in based upon historical data, looking up information, and/or based upon a statistical model. This logic may be performed, for example, by the opportunity for commercialization determination module 112 of the of the GBCPS 110 described with reference to FIG. 2. The GBCPS 110 may determine sponsor supplied content and/or an opportunity for commercialization by looking at historical data of, for example, the user, other users, the system, and the like; by looking up information, for example, stored in a persistent repository such as a data base, file, cloud storage, and the like; and/or by using any kind of statistical modeling including those that provide classifiers for interpreting new data based upon known data.

FIG. 3.13 is an example flow diagram of example logic illustrating an example embodiment of process 31200 of FIG. 3.12. More particularly, FIG. 3.13 illustrates a process 31300 that includes the process 31200, wherein the dynamically determining sponsor supplied content associated with an opportunity for commercialization that corresponds to at least one of the identified first topic, second topic, object, and/or action further comprises operations performed by or at one or more of the following block(s).

At block 31301, the process performs determining sponsor supplied content and/or an opportunity for commercialization by predicting what the user is interested in based upon historical data that includes at least one of user data, navigation data, data from other users similarly situated, related entity data, and/or values of the one or more of the set of factors. The GBCPS 110 may determine a sponsor supplied content and/or an opportunity for commercialization by making predictions based upon historical data of users, navigation of the user and other users, usage, navigation, and purchase (and other) data of other users that are similar to this user, for example, those that are in the social network of the user, share the same gender, location, age, etc. In addition, the GBCPS 110 may predict a sponsor supplied content and/or an opportunity for commercialization based upon any of the set of factors, described further elsewhere, that provide contextual information including, for example, prior history of the user, presentation device characteristics, characteristics of the gesture, etc.

FIG. 3.14 is an example flow diagram of example logic illustrating an example embodiment of process 31200 of FIG. 3.12. More particularly, FIG. 3.14 illustrates a process 31400 that includes the process 31200, wherein the dynamically determining sponsor supplied content associated with an opportunity for commercialization that corresponds to at least one of the identified first topic, second topic, object, and/or action further comprises operations performed by or at one or more of the following block(s).

At block 31401, the process performs determining sponsor supplied content and/or an opportunity for commercialization by looking up information including at least one of user data, navigation data, data from other users similarly situated, related entity data, and/or values of one or more factors representing contextual information. The GBCPS 110 may determine a sponsor supplied content and/or an opportunity for commercialization by looking up historical data of users, navigation of the user and other users, usage, navigation, and purchase (and other) data of other users that are similar to this user, for example, those that are in the social network of the user, share the same gender, location, age, etc. In addition, the GBCPS 110 may predict a sponsor supplied content and/or opportunity for commercialization by looking up values any of the set of factors, described further elsewhere, that provide contextual information including, for example, prior history of the user, presentation device characteristics, characteristics of the gesture, etc.

FIG. 3.15 is an example flow diagram of example logic illustrating an example embodiment of process 31200 of FIG. 3.12. More particularly, FIG. 3.15 illustrates a process 31500 that includes the process 31200, wherein the dynamically determining sponsor supplied content associated with an opportunity for commercialization that corresponds to at least one of the identified first topic, second topic, object, and/or action further comprises operations performed by or at one or more of the following block(s).

At block 31501, the process performs determining sponsor supplied content and/or an opportunity for commercialization by using a statistical model that indicates a likelihood of at least one of where the user is likely to navigate to or a next topic, object, or action the user is likely to explore. The GBCPS 110 may determine a sponsor supplied content and/or an opportunity for commercialization by using a statistical model of historical data of users, navigation of the user and other users, usage, navigation, and purchase (and other) data of other users that are similar to this user, for example, those that are in the social network of the user, share the same gender, location, age, etc. In addition, the GBCPS 110 may statistically determine a sponsor supplied content and/or an opportunity for commercialization based upon any of the set of factors, described further elsewhere, that provide contextual information including, for example, prior history of the user, presentation device characteristics, characteristics of the gesture, etc.

FIG. 3.16 is an example flow diagram of example logic illustrating an example embodiment of process 31500 of FIG. 3.15. More particularly, FIG. 3.16 illustrates a process 31600 that includes the process 31500, wherein the determining sponsor supplied content and/or an opportunity for commercialization by using a statistical model that indicates a likelihood of at least one of where the user is likely to navigate to or a next topic, object, or action the user is likely to explore further comprises operations performed by or at one or more of the following block(s).

At block 31601, the process performs determining sponsor supplied content and/or an opportunity for commercialization using a predictive statistical model that includes at least one of a decision tree, neural network, Bayesian network. In some embodiments, the GBCPS 110 uses decision trees, neural networks, or Bayesian networks as a statistical model to predict the next content the user will navigate to.

FIG. 3.17 is an example flow diagram of example logic illustrating an example embodiment of process 3100 of FIG. 3.1. More particularly, FIG. 3.17 illustrates a process 31700 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 31701, the process performs determining sponsor supplied content and/or an opportunity for commercialization by examination of navigation history of the user and comparing the navigation history of the user with the navigation history of other users to determine one or more likely next topics the user is likely to explore. In some embodiments, the GBCPS 110 determines the next topics that the user is likely to explore by looking at similarly situated users, based upon comparing the navigation history of this user with the navigation history of other users. For example, if some amount of other users (say a majority or over some threshold would navigate to a particular content from the current content, then the GBCPS 110 may determine that the particular content has a “x” chance of being the correct next topic for this user.

FIG. 3.18 is an example flow diagram of example logic illustrating an example embodiment of process 31700 of FIG. 3.17. More particularly, FIG. 3.18 illustrates a process 31800 that includes the process 31700, wherein the determining sponsor supplied content and/or an opportunity for commercialization by examination of navigation history of the user and comparing the navigation history of the user with the navigation history of other users to determine one or more likely next topics the user is likely to explore further comprises operations performed by or at one or more of the following block(s).

At block 31801, the process performs ranking the determined one or more likely next topics the user is likely to explore in order to determine the opportunity for commercialization. In some embodiments it is the case that more than one likely next topic is determined by the GBCPS 110. In this case, it can be helpful for the GBCPS 110 to rank these by likelihood to communicate that information to possible sponsors.

FIG. 3.19 is an example flow diagram of example logic illustrating an example embodiment of process 3100 of FIG. 3.1. More particularly, FIG. 3.19 illustrates a process 31900 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 31901, the process performs determining the sponsor supplied content associated with an opportunity for commercialization in advance of receiving an indication of the gestured input. This logic may be performed, for example, by the opportunity for commercialization determination module 112 of the of the GBCPS 110 described with reference to FIG. 2. As described elsewhere, the sponsor supplied content may be determined through an offer and acceptance levered by the GBCPS 110. In addition, the GBCPS 110 may have already stored one or more sponsor supplied content associated with one or more opportunities for commercialization in some kind of library (e.g. file, semi or permanent storage associated with the GBCPS 110) before any offers for occasions for opportunities for commercialization are offered by the GBCPS 110.

FIG. 3.20 is an example flow diagram of example logic illustrating an example embodiment of process 31900 of FIG. 3.19. More particularly, FIG. 3.20 illustrates a process 32000 that includes the process 31900, wherein the determining the sponsor supplied content associated with an opportunity for commercialization in advance of receiving an indication of the gestured input further comprises operations performed by or at one or more of the following block(s).

At block 32001, the process performs storing the determined sponsor supplied content and/or an indication of the opportunity for commercialization in electronic storage for later retrieval. As described elsewhere, the sponsor supplied content may be determined through an offer and acceptance levered by the GBCPS 110 and stored in some kind of library (e.g. file, semi or permanent storage associated with the GBCPS 110) before any detection of a corresponding occasion for an opportunity for commercialization has been processed. That way, when the gestured input and context is detected, the GBCPS 110 can draw from the stored content for presentation of the opportunity for commercialization.

FIG. 3.21 is an example flow diagram of example logic illustrating an example embodiment of process 3100 of FIG. 3.1. More particularly, FIG. 3.21 illustrates a process 32100 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 32101, the process performs determining the sponsor supplied content associated with an opportunity for commercialization by retrieving the content from a storage device associated with the computing system. This logic may be performed, for example, by the opportunity for commercialization determination module 112 of the of the GBCPS 110 described with reference to FIG. 2. In some embodiments the GBCPS 110 may retrieve the sponsor supplied content from a library of content (such as auxiliary content storage 40, 3rd party auxiliary content storage 43, cloud storage 44, a memory, database, repository, content management system, etc.) made available at some other time by the sponsor to the computing system 110. As described elsewhere, any data structure for storage of such content may be used including a database, file, cloud storage, and the like.

FIG. 3.22 is an example flow diagram of example logic illustrating an example embodiment of process 3100 of FIG. 3.1. More particularly, FIG. 3.22 illustrates a process 32200 that includes the process 3100, and which further includes operations performed by or at the following block(s).

At block 32201, the process performs dynamically determining the sponsor supplied content and/or the opportunity for commercialization in near real-time after receiving the user inputted gesture. This logic may be performed, for example, by the opportunity for commercialization determination module 112 of the of the GBCPS 110 described with reference to FIG. 2. In some embodiments the GBCPS 110 determines (e.g., calculates, examines, etc.) from gestured input what kind of opportunities for commercialization exist. This can provide a kind of “look-a-head” to predict where the user is navigating to so that more relevant content can be provided in an opportunity for commercialization. For example, if a user has first circled a Ford 150 truck, it would be useful for the publisher of the content to be able to provide advertisements relevant to what the user is looking for: a new truck, truck parts, etc. The GBCPS 110 may be able to determine from the gesture (e.g., the first and/or second topic, object, and/or action) whether the user is looking for truck parts or for a new truck and then offer a corresponding occasion for entities to buy or bid on the occasion associated with the (an other) product and/or service. As described further elsewhere, the opportunities for commercialization may include any kind of opportunity such as advertisements, games, and/or entertainment that may result in a purchase or an offer for purchase, bids, bets, competitions, or the like.

FIG. 3.23 is an example flow diagram of example logic illustrating an example embodiment of process 32200 of FIG. 3.22. More particularly, FIG. 3.23 illustrates a process 32300 that includes the process 32200, wherein the dynamically determining sponsor supplied content associated with an opportunity for commercialization that corresponds to at least one of the identified first topic, second topic, object, and/or action further comprises operations performed by or at one or more of the following block(s).

At block 32301, the process performs determining that the electronic content relates to a live event. This logic may be performed, for example, by the input module 111 of the GBCPS 110 described with reference to FIG. 2 in conjunction with the opportunity for commercialization determination module 112 of the of the GBCPS 110 described with reference to FIG. 2. In some embodiments the electronic content is published content pertaining to a live event, for example, a sporting event, a competition (real world based or computer based), a game, a television show, or the like.

FIG. 3.24 is an example flow diagram of example logic illustrating an example embodiment of process 32300 of FIG. 3.23. More particularly, FIG. 3.24 illustrates a process 32400 that includes the process 32300, wherein the determining that the electronic content relates to a live event further comprises operations performed by or at one or more of the following block(s).

At block 32401, the process performs determining that the live event is at least one of a sports event, a competition, and/or a game. This logic may be performed, for example, by the opportunity for commercialization determination module 112 of the of the GBCPS 110 described with reference to FIG. 2. In some embodiments the live event is at least one of a sporting event, a competition, and/or a game, real world based or computer based.

FIG. 3.25 is an example flow diagram of example logic illustrating an example embodiment of process 32300 of FIG. 3.23. More particularly, FIG. 3.25 illustrates a process 32500 that includes the process 32300, wherein the determining that the electronic content relates to a live event further comprises operations performed by or at one or more of the following block(s).

At block 32501, the process performs determining that the live event is a pre-recorded live event, or a simultaneous transmission of a live event. This logic may be performed, for example, by the opportunity for commercialization determination module 112 of the of the GBCPS 110 described with reference to FIG. 2. In some embodiments the live event is a simultaneous transmission (e.g., real time streamed content) of a live event such as a television show or media content streamed in real-time from a head-end or other electronic media source. In some embodiments the live event is pre-recorded, for example, by a digital recording device, a head-end, a communications network, etc. and then streamed as presented content to the user.

FIG. 3.26 is an example flow diagram of example logic illustrating an example embodiment of process 32200 of FIG. 3.22. More particularly, FIG. 3.26 illustrates a process 32600 that includes the process 32200, wherein the dynamically determining sponsor supplied content associated with an opportunity for commercialization that corresponds to at least one of the identified first topic, second topic, object, and/or action further comprises operations performed by or at one or more of the following block(s).

At block 32601, the process performs determining the sponsor supplied content and/or the opportunity for commercialization to one or more sponsors using real-time bidding. This logic may be performed, for example, by the opportunity for commercialization determination module 112 of the of the GBCPS 110 described with reference to FIG. 2. As described elsewhere, the GBCPS 110 may offer up the possibility to be associated with the gestured topic, object, and/or action (e.g., the new truck or the truck parts) to one or more entities that can sponsor the content (e.g., a manufacturer, distributor, publisher, or the like). This offer can be communicated (e.g., posted, forwarded to, sent, etc.) using any type of real time bidding system.

FIG. 3.27 is an example flow diagram of example logic illustrating an example embodiment of process 32600 of FIG. 3.26. More particularly, FIG. 3.27 illustrates a process 32700 that includes the process 32600, wherein the determining the sponsor supplied content and/or the opportunity for commercialization to one or more sponsors using real-time bidding further comprises operations performed by or at one or more of the following block(s).

At block 32701, the process performs providing real-time bidding to one or more sponsors that are competitors. This logic may be performed, for example, by the opportunity for commercialization determination module 112 of the of the GBCPS 110 described with reference to FIG. 2. In some embodiments the one or more sponsors are competitors to the publisher of the electronic content that was gestured to by the user.

FIG. 3.28 is an example flow diagram of example logic illustrating an example embodiment of process 3100 of FIG. 3.1. More particularly, FIG. 3.28 illustrates a process 32800 that includes the process 3100, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises operations performed by or at one or more of the following block(s).

At block 32801, the process performs presenting the determined sponsor supplied content associated with the opportunity for commercialization in conjunction with identified first topic, second topic, object, and/or action with a time lag after the gestured input has been received. This logic may be performed, for example, by the presentation module 114 of the GBCPS 110 described with reference to FIG. 2. In some embodiments the GBCPS 110 determines sponsor supplied content associated with the opportunity for commercialization but doesn't present it until sometime later. Such a situation may occur when the user isn't yet ready to participate in the opportunity for commercialization. This may be determined, for example, as part of the determining process such as when examining behavior of other users similarly situated.

FIG. 3.29 is an example flow diagram of example logic illustrating an example embodiment of process 32800 of FIG. 3.28. More particularly, FIG. 3.29 illustrates a process 32900 that includes the process 32800, wherein the presenting the determined sponsor supplied content associated with the opportunity for commercialization in conjunction with identified first topic, second topic, object, and/or action with a time lag after the gestured input has been received further comprises operations performed by or at one or more of the following block(s).

At block 32901, the process performs presenting the determined sponsor supplied content the next day, week, or month. The GBCPS 110 may present the determined sponsor supplied content with a time lag that is at least the next day after the gestured input has been received. This situation may occur when a user “sleeps” on the idea of doing the opportunity for commercialization and then decides to participate.

FIG. 3.30 is an example flow diagram of example logic illustrating an example embodiment of process 32800 of FIG. 3.28. More particularly, FIG. 3.30 illustrates a process 33000 that includes the process 32800, wherein the presenting the determined sponsor supplied content associated with the opportunity for commercialization in conjunction with identified first topic, second topic, object, and/or action with a time lag after the gestured input has been received further comprises operations performed by or at one or more of the following block(s).

At block 33001, the process performs presenting the determined sponsor supplied content the next day, week, or month. The GBCPS 110 may present the determined sponsor supplied content with a time lag that is at least two or more minutes after the gestured input has been received. This situation may occur when a user waits a few minutes on the idea of doing the opportunity for commercialization and then decides to participate.

FIG. 3.31 is an example flow diagram of example logic illustrating an example embodiment of process 3100 of FIG. 3.1. More particularly, FIG. 3.31 illustrates a process 33100 that includes the process 3100, and which further includes operations performed by or at the following block(s).

At block 33101, the process performs charging a sponsor based upon a likelihood the determined sponsor supplied content and/or opportunity for commercialization will be participated in by the user. This logic may be performed, for example, by the opportunity for commercialization determination module 112 of the of the GBCPS 110 described with reference to FIG. 2. The GBCPS 110 may determine any number of schemes for charging sponsors for the association of opportunities for commercialization with an identified topic, object, and/or action. For example, In some embodiments, the GBCPS 110 may charge the sponsors when the opportunity for commercialization is actually presented to the user. In other cases, the GBCPS 110 may charge at different times or for differing amounts. What constitutes “participated in” (e.g., engaged in, acted upon, interacted with, etc.) may depend upon the opportunity for commercialization or the type of opportunity for commercialization

FIG. 3.32 is an example flow diagram of example logic illustrating an example embodiment of process 3100 of FIG. 3.1. More particularly, FIG. 3.32 illustrates a process 33200 that includes the process 3100, and which further includes operations performed by or at the following block(s).

At block 33201, the process performs charging a sponsor based upon presence and/or values of one or more of a set of factors. This logic may be performed, for example, by the opportunity for commercialization determination module 112 of the of the GBCPS 110 described with reference to FIG. 2. The GBCPS 110 may determine any number of schemes for charging sponsors for the association of opportunities for commercialization with an identified topic, object, and/or action. For example, In some embodiments, the GBCPS 110 may charge the sponsors a range of prices based upon an association with the presence (or absence) of various ones of a set of factors or their values (e.g., context required for the opportunity for commercialization to be presented. In other cases, the GBCPS 110 may charge at different times or for differing amounts.

FIG. 3.33 is an example flow diagram of example logic illustrating an example embodiment of process 3100 of FIG. 3.1. More particularly, FIG. 3.33 illustrates a process 33300 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 33301, the process performs determining sponsor supplied content and/or an opportunity for commercialization that provides access to an anecdote, story, article, book, and/or document. This logic may be performed, for example, by the opportunity for commercialization determination module 112 of the of the GBCPS 110 described with reference to FIG. 2. In some embodiments the GBCPS 110 determines what opportunity of content provides access (e.g., identifies, sells, shows for bid, etc.) to an anecdote, story, article, book, and/or document that is somehow related to the topic, object, and/or action identified by the gestured portion of the presented content.

FIG. 3.34 is an example flow diagram of example logic illustrating an example embodiment of process 3100 of FIG. 3.1. More particularly, FIG. 3.34 illustrates a process 33400 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 33401, the process performs determining sponsor supplied content and/or an opportunity for commercialization that provides access to a product and/or service related to identified first topic, second topic, object, and/or action. This logic may be performed, for example, by the opportunity for commercialization determination module 112 of the of the GBCPS 110 described with reference to FIG. 2. In some embodiments the GBCPS 110 determines what opportunity of content provides access (e.g., identifies, sells, shows for bid, etc.) to a product, good, service, etc. that is somehow related to the topic, object, and/or action identified by the gestured portion of the presented content.

FIG. 3.35 is an example flow diagram of example logic illustrating an example embodiment of process 3100 of FIG. 3.1. More particularly, FIG. 3.35 illustrates a process 33500 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 33501, the process performs determining sponsor supplied content associated with an opportunity for commercialization that provides a best match to the at least one of the identified first topic, second topic, object, and/or action. In some embodiments the best match may be determining what other opportunity for commercialization shows an opportunity or a content that in some manner (e.g., price, location, similarity, etc.) provides a best match to the identified first topic, second topic, object, and/or action.

FIG. 3.36 is an example flow diagram of example logic illustrating an example embodiment of process 33500 of FIG. 3.35. More particularly, FIG. 3.36 illustrates a process 33600 that includes the process 33500, wherein the determining sponsor supplied content associated with an opportunity for commercialization that provides a best match to the at least one of the identified first topic, second topic, object, and/or action further comprises operations performed by or at one or more of the following block(s).

At block 33601, the process performs determining which sponsor supplied content and/or opportunity for commercialization provides a cheapest price related to the identified first topic, the second topic, the object, and/or the action. In some embodiments the best match may be determining what other opportunity for commercialization shows a topic or object (or action) having the cheapest (i.e., least expensive) price.

FIG. 3.37 is an example flow diagram of example logic illustrating an example embodiment of process 33500 of FIG. 3.35. More particularly, FIG. 3.37 illustrates a process 33700 that includes the process 33500, wherein the determining sponsor supplied content associated with an opportunity for commercialization that provides a best match to the at least one of the identified first topic, second topic, object, and/or action further comprises operations performed by or at one or more of the following block(s).

At block 33701, the process performs determining which sponsor supplied content and/or opportunity for commercialization provides a result that is closest in location. In some embodiments the best match may be determining what other opportunity for commercialization shows an opportunity or content that may be found geographically (or other measure of location) closest to the user, the identified first topic, second topic, object and/or action.

FIG. 3.38 is an example flow diagram of example logic illustrating an example embodiment of process 33500 of FIG. 3.35. More particularly, FIG. 3.38 illustrates a process 33800 that includes the process 33500, wherein the determining sponsor supplied content associated with an opportunity for commercialization that provides a best match to the at least one of the identified first topic, second topic, object, and/or action further comprises operations performed by or at one or more of the following block(s).

At block 33801, the process performs determining which sponsor supplied content and/or opportunity for commercialization provides a result that is most similar in content to the identified first topic, the second topic, the object, and/or the action. In some embodiments the best match may be determining what other opportunity for commercialization shows an opportunity or content that is most similar to the content of the user, the identified first topic, second topic, or object.

FIG. 3.39 is an example flow diagram of example logic illustrating an example embodiment of process 3100 of FIG. 3.1. More particularly, FIG. 3.39 illustrates a process 33900 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 33901, the process performs receiving the sponsor supplied content from an entity separate from an entity that provided the presented electronic content. This logic may be performed, for example, by the opportunity for commercialization determination module 112 of the of the GBCPS 110 described with reference to FIG. 2. The opportunity for commercialization may involve any sort of content that gives the user or the system an opportunity for something to be purchased or offered for purchase or for any other sort of reason (e.g., survey, statistics, etc.) involving commerce. In some embodiments, the entity associated with the presented electronic content may be, for example, GBCPS 110 and the opportunity for commercialization may be, for example, an advertisement from the auxiliary content 40. The entity separate from the entity that provided (or published) the presented electronic content may be, for example, a third party or a competitor entity whose content is accessible through third party auxiliary content 43. In some embodiments the GBCPS 110 sponsors a kind of “bidding” system whereby third party entities may purchase opportunities for presentation of an opportunity for commercialization.

FIG. 3.40 is an example flow diagram of example logic illustrating an example embodiment of process 33900 of FIG. 3.39. More particularly, FIG. 3.40 illustrates a process 34000 that includes the process 33900, wherein the receiving the sponsor supplied content from an entity separate from an entity that provided the presented electronic content further comprises operations performed by or at one or more of the following block(s).

At block 34001, the process performs receiving the sponsor supplied content from an entity competing for a sale of a product and/or service identified by the identified first topic, second topic, and/or object. This logic may be performed, for example, by the opportunity for commercialization determination module 112 of the of the GBCPS 110 described with reference to FIG. 2. In some embodiments the sponsor is an entity (e.g., a manufacturer, advertiser, publisher, etc.) interested in presenting the opportunity for commercialization who competes with the entity that is responsible for the initial content upon which the gesture is made. For example, if a website shopping portal is the initial source of the published information upon which a gesture of a product is made, then the sponsor may be a manufacturer with a competing brand of the same product. For example, in FIG. 1B, the “evo.com” website is given an opportunity to present a competing advertisement for the pair of skis shown by the gestured input of FIG. 1A.

FIG. 3.41 is an example flow diagram of example logic illustrating an example embodiment of process 33900 of FIG. 3.39. More particularly, FIG. 3.41 illustrates a process 34100 that includes the process 33900, wherein the receiving the sponsor supplied content from an entity separate from an entity that provided the presented electronic content further comprises operations performed by or at one or more of the following block(s).

At block 34101, the process performs receiving the sponsor supplied content from an entity separate from an entity that is providing the presented electronic content that is a competitor entity. A competitor entity may be any type of entity that is determined to be competitive with the entity that has published the content underlying the gestured input, whether or not the competition is real or imagined, or known in the marketplace as competitive or not.

FIG. 3.42 is an example flow diagram of example logic illustrating an example embodiment of process 34100 of FIG. 3.41. More particularly, FIG. 3.42 illustrates a process 34200 that includes the process 34100, wherein the receiving the sponsor supplied content from an entity separate from an entity that is providing the presented electronic content that is a competitor entity further comprises operations performed by or at one or more of the following block(s).

At block 34201, the process performs receiving sponsor supplied content from a competing manufacturer. This logic may be performed, for example, by the opportunity for commercialization determination module 112 of the of the GBCPS 110 described with reference to FIG. 2. In some embodiments the sponsor is an entity (e.g., a manufacturer, advertiser, publisher, etc.) interested in presenting the opportunity for commercialization that is a manufacturer that competes with the entity that is responsible for the initial content upon which the gesture is made.

FIG. 3.43 is an example flow diagram of example logic illustrating an example embodiment of process 34100 of FIG. 3.41. More particularly, FIG. 3.43 illustrates a process 34300 that includes the process 34100, wherein the receiving the sponsor supplied content from an entity separate from an entity that is providing the presented electronic content that is a competitor entity further comprises operations performed by or at one or more of the following block(s).

At block 34301, the process performs receiving sponsor supplied content from a competing network. This logic may be performed, for example, by the opportunity for commercialization determination module 112 of the of the GBCPS 110 described with reference to FIG. 2. In some embodiments the sponsor is an entity (e.g., a manufacturer, advertiser, publisher, etc.) interested in presenting the opportunity for commercialization that is a network (e.g., a publisher, portal, website, social network, and the like) that competes with the entity that is responsible for the initial content upon which the gesture is made.

FIG. 3.44 is an example flow diagram of example logic illustrating an example embodiment of process 3100 of FIG. 3.1. More particularly, FIG. 3.44 illustrates a process 34400 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 34401, the process performs receiving sponsor supplied content from an entity that provided the presented electronic content. This logic may be performed, for example, by the opportunity for commercialization determination module 112 of the of the GBCPS 110 described with reference to FIG. 2. The opportunity for commercialization may involve any sort of content that gives the user or the system an opportunity for something to be purchased or offered for purchase or for any other sort of reason (e.g., survey, statistics, etc.) involving commerce. In some embodiments, the entity associated with the presented electronic content may be a publisher of a webpage being presented in a client application, web browser, or similar application. In some embodiments, the entity associated with the presented electronic content may be, for example, GBCPS 110 and the opportunity for commercialization may be provided by that entity.

FIG. 3.45 is an example flow diagram of example logic illustrating an example embodiment of process 3100 of FIG. 3.1. More particularly, FIG. 3.45 illustrates a process 34500 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 34501, the process performs receiving sponsor supplied content from an advertising server. This logic may be performed, for example, by the opportunity for commercialization determination module 112 of the of the GBCPS 110 described with reference to FIG. 2. In some embodiments an advertisement may be provided by a remote tool or application connected via the network 30 to the GBCPS 110 such as a third party advertising system (e.g. system 43) or server. The advertisement may be any type of electronic advertisement including for example, text, images, sound, etc. Advertisements may be supplied directly or indirectly as indicators to advertisements that can be served by server computing systems.

FIG. 3.46 is an example flow diagram of example logic illustrating an example embodiment of process 3100 of FIG. 3.1. More particularly, FIG. 3.46 illustrates a process 34600 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 34601, the process performs determining sponsor supplied content that includes content received from an entity other than the sponsor. This logic may be performed, for example, by the opportunity for commercialization determination module 112 of the of the GBCPS 110 described with reference to FIG. 2. In some embodiments the sponsor is an entity (e.g., a manufacturer, advertiser, publisher, etc.) interested in presenting the opportunity for commercialization but may not have complete access to all of the needed or desired content, or may desire content specific and/or available from a third party such an advertising server. In some embodiments, this allows the sponsor to receive content that is targeted for a particular audience, location, demographic, etc. as the third party may have access to context specific information. For example, the sponsor, upon determining that the published website that is presenting the gestured product and/or service is in Japanese, may invoke a third party server to translate the advertisement text of the opportunity for commercialization into the Japanese language.

FIG. 3.47 is an example flow diagram of example logic illustrating an example embodiment of process 34600 of FIG. 3.46. More particularly, FIG. 3.47 illustrates a process 34700 that includes the process 34600, wherein the determining sponsor supplied content that includes content received from an entity other than the sponsor further comprises operations performed by or at one or more of the following block(s).

At block 34701, the process performs determining sponsor supplied content that includes content received via an interface for accessing context specific content. This logic may be performed, for example, by the opportunity for commercialization determination module 112 of the of the GBCPS 110 described with reference to FIG. 2. In some embodiments the sponsor is an entity (e.g., a manufacturer, advertiser, publisher, etc.) interested in presenting the opportunity for commercialization but may not have complete access to all of the needed or desired content, or may desire content specific and/or available from a third party such an advertising server. In this case, the sponsor may access the content through some sort of electronic interface such as an application programming interface, an interprocess function call, etc.

FIG. 3.48 is an example flow diagram of example logic illustrating an example embodiment of process 34700 of FIG. 3.47. More particularly, FIG. 3.48 illustrates a process 34800 that includes the process 34700, wherein the determining sponsor supplied content that includes content received from an entity other than the sponsor further comprises operations performed by or at one or more of the following block(s).

At block 34801, the process performs determining sponsor supplied content that includes content received via an application programming interface. This logic may be performed, for example, by the opportunity for commercialization determination module 112 of the of the GBCPS 110 described with reference to FIG. 2. In some embodiments the sponsor is an entity (e.g., a manufacturer, advertiser, publisher, etc.) interested in presenting the opportunity for commercialization but may not have complete access to all of the needed or desired content, or may desire content specific and/or available from a third party such an advertising server. In this case, the sponsor may access the content through some an application programming interface.

FIG. 3.49 is an example flow diagram of example logic illustrating an example embodiment of process 34700 of FIG. 3.47. More particularly, FIG. 3.49 illustrates a process 34900 that includes the process 34700, wherein the determining sponsor supplied content that includes content received from an entity other than the sponsor further comprises operations performed by or at one or more of the following block(s).

At block 34901, the process performs determining sponsor supplied content that includes context specific content based at least in part on values of one or more of a set of factors. This logic may be performed, for example, by the opportunity for commercialization determination module 112 of the of the GBCPS 110 described with reference to FIG. 2. In some embodiments the sponsor presents content (e.g., text, images, sound, or the like that is based upon context, such as context of the user, the presentation device, the input device, the gesture, the underlying presented content, nearby sentences, phrases, words, images, sounds, or the like. In some embodiments, this context is represented by values (numeric or discrete) of one or more factors of the set of factors.

FIG. 3.50 is an example flow diagram of example logic illustrating an example embodiment of process 34600 of FIG. 3.46. More particularly, FIG. 3.50 illustrates a process 35000 that includes the process 34600, wherein the determining sponsor supplied content that includes content received from an entity other than the sponsor further comprises operations performed by or at one or more of the following block(s).

At block 35001, the process performs determining sponsor supplied content that includes content received from an entity, other than the sponsor, that is at least one of an advertising server, an advertising system, a dictionary, an encyclopedia, and/or a translation tool. This logic may be performed, for example, by the presentation module 114 of the GBCPS 110 described with reference to FIG. 2. In some embodiments the sponsor is an entity (e.g., a manufacturer, advertiser, publisher, etc.) interested in presenting the opportunity for commercialization but may not have complete access to all of the needed or desired content, or may desire content specific and/or available from a third party. In some embodiments the third party may be an advertising server or advertising system (e.g., a system targeted to deliver ads electronically, perhaps based upon different parameters), a dictionary, an encyclopedia or a translation tool.

FIG. 3.51 is an example flow diagram of example logic illustrating an example embodiment of process 3100 of FIG. 3.1. More particularly, FIG. 3.51 illustrates a process 35100 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 35101, the process performs determining a sponsor supplied content that includes one or more of advertising content, a game, interactive entertainment, a computer-assisted competition, a bidding opportunity, a documentary, help text, an indication of price, textual content, an image, a video, and/or auditory content. This logic may be performed, for example, by the presentation module 114 of the GBCPS 110 described with reference to FIG. 2. In some embodiments the sponsor supplied content (e.g., text, images, sounds, etc.) includes one or more ads, games, some sort of interactive entertainment (e.g., puzzles, games, tasks, etc.), competitions (e.g., sponsored or unsponsored games between two or more users), a documentary (e.g., a film, an e-book, etc.), help text, an indication of price (e.g., a price tag, a value, a comparative value, a ranking, etc.) textual content, image, video, or audio in any form.

FIG. 3.52 is an example flow diagram of example logic illustrating an example embodiment of process 3100 of FIG. 3.1. More particularly, FIG. 3.52 illustrates a process 35200 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 35201, the process performs receiving an indication of a request from a not-for-profit organization as the sponsor supplied content. This logic may be performed, for example, by the input module 111 of the GBCPS 110 described with reference to FIG. 2. In some embodiments, the sponsor supplied content may be a request from a not-for-profit organization such as a church, charity, club, etc. For example, the request may be a request for a donation, invitation to membership, or the like.

FIG. 3.53 is an example flow diagram of example logic illustrating an example embodiment of process 3100 of FIG. 3.1. More particularly, FIG. 3.53 illustrates a process 35300 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 35301, the process performs receiving an indication of a person, place, or thing as the sponsor supplied content. For example, the indicated portion may identify any type of person (e.g., alive or dead), any type of place (e.g., location), or any type of thing (e.g., a named or unnamed object).

FIG. 3.54 is an example flow diagram of example logic illustrating an example embodiment of process 3100 of FIG. 3.1. More particularly, FIG. 3.54 illustrates a process 35400 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 35401, the process performs receiving text, an image, and/or audio as the sponsor supplied content. For example, the indicated portion may identify any type of person (e.g., alive or dead), any type of place (e.g., location), or any type of thing (e.g., a named or unnamed object). For example, the indicated portion may include an audio clip related to the product for example, an explanation of the product and/or service such as how to use it, testimonials, or the like For example, the indicated portion may include a picture that shows attributes of the product and/or service such as color, size, location, brand, availability, rating, and the like For example, the indicated portion may include a picture of a product or service along with a description of the good and/or service, including for example, a price, location, quantity, descriptors (e.g., color, size, etc.), or the like.

FIG. 3.55 is an example flow diagram of example logic illustrating an example embodiment of process 3100 of FIG. 3.1. More particularly, FIG. 3.55 illustrates a process 35500 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 35501, the process performs determining sponsor supplied content that includes context specific content based at least in part on values of one or more of a set of factors. This logic may be performed, for example, by the opportunity for commercialization determination module 112 of the of the GBCPS 110 described with reference to FIG. 2. In some embodiments the content received from a sponsor (e.g., text, images, sound, or the like) is based upon context, such as context of the user, the presentation device, the input device, the gesture, the underlying presented content, nearby sentences, phrases, words, images, sounds, or the like. In some embodiments, this context is represented by values (numeric or discrete) of one or more factors of the set of factors.

FIG. 3.56 is an example flow diagram of example logic illustrating an example embodiment of process 35500 of FIG. 3.55. More particularly, FIG. 3.56 illustrates a process 35600 that includes the process 35500, wherein the determining sponsor supplied content that includes context specific content based at least in part on values of one or more of a set of factors further comprises operations performed by or at one or more of the following block(s).

At block 35601, the process performs determining sponsor supplied content associated with an offer for sale of a product and/or service. In some embodiments the content received from a sponsor is associated with an offer for sale of a product and/or service. This may occur, for example, if the content is an advertisement, a website for selling goods, etc.

FIG. 3.57 is an example flow diagram of example logic illustrating an example embodiment of process 3100 of FIG. 3.1. More particularly, FIG. 3.57 illustrates a process 35700 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 35701, the process performs determining an indication of at least one advertisement as the sponsor supplied content. In some embodiments the advertisement may be provided by a remote tool or application connected via the network 30 to the GBCPS 110 such as a third party advertising system (e.g. system 43) or server. The advertisement may be any type of electronic advertisement including for example, text, images, sound, etc. Advertisements may be supplied directly or indirectly as indicators to advertisements that can be served by server computing systems.

FIG. 3.58 is an example flow diagram of example logic illustrating an example embodiment of process 35700 of FIG. 3.57. More particularly, FIG. 3.58 illustrates a process 35800 that includes the process 35700, wherein the determining an indication of at least one advertisement as the sponsor supplied content further comprises operations performed by or at one or more of the following block(s).

At block 35801, the process performs selecting of the at least one advertisement from a plurality of advertisements as the sponsor supplied content. The advertisement may be a direct or indirect indication of an advertisement that is somehow related to the product and/or service indicated by the indicated portion of the gesture. When a third party server, such as a third party advertising system, is used to supply the opportunity for commercialization, a plurality of advertisements may be delivered (e.g., forwarded, sent, communicated, etc.) to the GBCPS 110 before being presented by the GBCPS 110.

FIG. 3.59 is an example flow diagram of example logic illustrating an example embodiment of process 35700 of FIG. 3.57. More particularly, FIG. 3.59 illustrates a process 35900 that includes the process 35700, wherein the determining an indication of at least one advertisement as the sponsor supplied content further comprises operations performed by or at one or more of the following block(s).

At block 35901, the process performs determining an advertisement that comprises textual, image, and/or auditory content as the sponsor supplied content. For example, In some embodiments, the determining an indication of at least one advertisement as the sponsor supplied content may be an image with or without text, a video, a data stream of any sort, or audio clips.

FIG. 3.60 is an example flow diagram of example logic illustrating an example embodiment of process 3100 of FIG. 3.1. More particularly, FIG. 3.60 illustrates a process 36000 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 36001, the process performs determining an indication of interactive entertainment as the sponsor supplied content. The interactive entertainment may include, for example, a computer game, an on-line quiz show, a lottery, a movie to watch, and so forth.

FIG. 3.61 is an example flow diagram of example logic illustrating an example embodiment of process 3100 of FIG. 3.1. More particularly, FIG. 3.61 illustrates a process 36100 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 36101, the process performs determining an indication of a role-playing game as the sponsor supplied content. A role-playing game may include, for example, an online multi-player role playing game.

FIG. 3.62 is an example flow diagram of example logic illustrating an example embodiment of process 3100 of FIG. 3.1. More particularly, FIG. 3.62 illustrates a process 36200 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 36201, the process performs determining an indication of at least one of a computer-assisted competition and/or a bidding opportunity as the sponsor supplied content. The bidding opportunity, for example, a competition or gambling event, etc., may be computer based, computer-assisted, and/or manual. For example, In some embodiments, the GBCPS 110 may offer a mechanism whereby one or more entities can bid on particular product and/or service indicated by keywords similar to opportunities offered by search engines, or by gesturelets. In the latter case, a opportunity for commercialization may be associated with a given gesturelet based upon some kind of “best match” algorithm. In other embodiments, bidding may be implemented by matching an opportunity for commercialization to an image or audio representation using, for example, pattern matching.

FIG. 3.63 is an example flow diagram of example logic illustrating an example embodiment of process 3100 of FIG. 3.1. More particularly, FIG. 3.63 illustrates a process 36300 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 36301, the process performs determining an indication of a purchase and/or an offer as the sponsor supplied content. The purchase or offer may take any form, for example, a book advertisement, or a web page, and may be for products and/or services.

FIG. 3.64 is an example flow diagram of example logic illustrating an example embodiment of process 36300 of FIG. 3.63. More particularly, FIG. 3.64 illustrates a process 36400 that includes the process 36300, wherein the determining an indication of a purchase and/or an offer as the sponsor supplied content further comprises operations performed by or at one or more of the following block(s).

At block 36401, the process performs determining at least one of information, an item for sale, a service for offer and/or a service for sale, a prior purchase of the user, and/or a current purchase. Any type of information, item, or service (online or offline, machine generated or human generated) can be offered and/or purchased in this manner. If human generated, the advertisement may be to a computer representation of the human generated service, for example, a contract or a calendar entry, or the like.

FIG. 3.65 is an example flow diagram of example logic illustrating an example embodiment of process 36300 of FIG. 3.63. More particularly, FIG. 3.65 illustrates a process 36500 that includes the process 36300, wherein the determining an indication of a purchase and/or an offer as the sponsor supplied content further comprises operations performed by or at one or more of the following block(s).

At block 36501, the process performs determining the indication of the purchase and/or the offer from an entity that is part of a social network of the user. The purchase may be related to (e.g., associated with, directed to, mentioned by, a contact directly or indirectly related to, etc.) someone that belongs to a social network associated with the user, for example through the one or more networks 30.

FIG. 3.66 is an example flow diagram of example logic illustrating an example embodiment of process 3100 of FIG. 3.1. More particularly, FIG. 3.66 illustrates a process 36600 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 36601, the process performs receiving the sponsor supplied content as at least one of a word, a phrase, an utterance, an image, a video, a pattern, and/or an audio signal. The logic may be performed by any one of the modules of the GBCPS 110. For example, the opportunity for commercialization determination module 112 of the of the GBCPS 110 described with reference to FIG. 2 may determine the sponsor supplied content associated with the opportunity for commercialization (e.g., an advertisement, web page, or the like) in the form of a word, phrase, utterance (e.g., a sound not necessarily comprehensible as a word), image, video, pattern, or audio signal.

FIG. 3.67 is an example flow diagram of example logic illustrating an example embodiment of process 3100 of FIG. 3.1. More particularly, FIG. 3.67 illustrates a process 36700 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 36701, the process performs receiving the sponsor supplied content as at least one of a location, a pointer, a symbol, and/or another type of reference. The logic may be performed by any one of the modules of the GBCPS 110. In this case, the indication is one of a location, a pointer, a symbol, (e.g., an absolute or relative location, a location in memory locally or remotely, or the like) intended to enable the GBNS to find, obtain, or locate the opportunity for commercialization in order to cause it to be presented.

FIG. 3.68 is an example flow diagram of example logic illustrating an example embodiment of process 3100 of FIG. 3.1. More particularly, FIG. 3.68 illustrates a process 36800 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 36801, the process performs receiving the sponsor supplied content by receiving at least one of a word, a phrase, an utterance, an image, a video, a pattern, and/or an audio signal. The logic may be performed by any one of the modules of the GBCPS 110. For example, the opportunity for commercialization determination module 112 of the of the GBCPS 110 described with reference to FIG. 2 may determine the opportunity for commercialization (e.g., an advertisement, web page, or the like) and return an indication in the form of a word, phrase, utterance (e.g., a sound not necessarily comprehensible as a word), image, video, pattern, or audio signal.

FIG. 3.69 is an example flow diagram of example logic illustrating an example embodiment of process 3100 of FIG. 3.1. More particularly, FIG. 3.69 illustrates a process 36900 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 36901, the process performs determining a sponsor supplied content based upon a set of factors that include context of other text, graphics, and/or objects within the presented content. This logic may be performed, for example, by the current context determination module 233 of the factor determination module 113 of the GBCPS 110 described with reference to FIG. 2 to determine (e.g., retrieve, designate, resolve, etc.) context related information from the currently presented content, including other text, audio, graphics, and/or objects and to use that information to determine a sponsor supplied content.

FIG. 3.70 is an example flow diagram of example logic illustrating an example embodiment of process 3100 of FIG. 3.1. More particularly, FIG. 3.70 illustrates a process 37000 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 37001, the process performs determining a sponsor supplied content based upon a set of factors including an attribute of the gesture. This logic may be performed, for example, by the gesture attributes determination module 237 of the factor determination module 113 of the GBCPS 110 described with reference to FIG. 2 to determine (e.g., retrieve, designate, resolve, etc.) context related information from the attributes of the gesture itself (e.g., color, size, direction, shape, and so forth) and to use that information to determine a sponsor supplied content.

FIG. 3.71 is an example flow diagram of example logic illustrating an example embodiment of process 37000 of FIG. 3.70. More particularly, FIG. 3.71 illustrates a process 37100 that includes the process 37000, wherein the determining a sponsor supplied content based upon a set of factors including an attribute of the gesture, further comprises operations performed by or at one or more of the following block(s).

At block 37101, the process performs determining a sponsor supplied content based upon a set of factors including a size of the gesture. Size of the gesture may include, for example, width and/or length, and other measurements appropriate to the input device 20*.

FIG. 3.72 is an example flow diagram of example logic illustrating an example embodiment of process 37000 of FIG. 3.70. More particularly, FIG. 3.72 illustrates a process 37200 that includes the process 37000, wherein the determining a sponsor supplied content based upon a set of factors including an attribute of the gesture, further comprises operations performed by or at one or more of the following block(s).

At block 37201, the process performs determining a sponsor supplied content based upon a set of factors including a direction of the gesture. Direction of the gesture may include, for example, up or down, east or west, and other measurements or commands appropriate to the input device 20*.

FIG. 3.73 is an example flow diagram of example logic illustrating an example embodiment of process 37000 of FIG. 3.70. More particularly, FIG. 3.73 illustrates a process 37300 that includes the process 37000, wherein the determining a sponsor supplied content based upon a set of factors including an attribute of the gesture, further comprises operations performed by or at one or more of the following block(s).

At block 37301, the process performs determining a sponsor supplied content based upon a set of factors including a color of the gesture. Color of the gesture may include, for example, a pen and/or ink color as well as other measurements appropriate to the input device 20*.

FIG. 3.74 is an example flow diagram of example logic illustrating an example embodiment of process 37000 of FIG. 3.70. More particularly, FIG. 3.74 illustrates a process 37400 that includes the process 37000, wherein the determining a sponsor supplied content based upon a set of factors including an attribute of the gesture, further comprises operations performed by or at one or more of the following block(s).

At block 37401, the process performs determining sponsor supplied content based upon a set of factors including a measure of steering of the gesture. Steering of the gesture may occur when, for example, an initial gesture is indicated (e.g., on a mobile device) and the user desires to correct or nudge it in a certain direction.

FIG. 3.75 is an example flow diagram of example logic illustrating an example embodiment of process 37400 of FIG. 3.74. More particularly, FIG. 3.75 illustrates a process 37500 that includes the process 37400, wherein the determining sponsor supplied content based upon a set of factors including a measure of steering of the gesture, further comprises operations performed by or at one or more of the following block(s).

At block 37501, the process performs determining a sponsor supplied content based upon a steering of the gesture including smudging the input device. Smudging of the gesture may occur when, for example, an initial gesture is indicated (e.g., on a mobile device) and the user desires to correct or nudge it in a certain direction by, for example smudging the gesture using for example, a finger. This type of action may be particularly useful on a touch screen input device.

FIG. 3.76 is an example flow diagram of example logic illustrating an example embodiment of process 37400 of FIG. 3.74. More particularly, FIG. 3.76 illustrates a process 37600 that includes the process 37400, wherein the determining sponsor supplied content based upon a set of factors including a measure of steering of the gesture, further comprises operations performed by or at one or more of the following block(s).

At block 37601, the process performs determining a sponsor supplied content based upon steering of the gesture as performed by a handheld gaming accessory. In this case the steering is performed by a handheld gaming accessory such as a particular type of input device 20*. For example, the gaming accessory may include a joy stick, a handheld controller, or the like.

FIG. 3.77 is an example flow diagram of example logic illustrating an example embodiment of process 37000 of FIG. 3.70. More particularly, FIG. 3.77 illustrates a process 37700 that includes the process 37000, wherein the determining a sponsor supplied content based upon a set of factors including an attribute of the gesture, further comprises operations performed by or at one or more of the following block(s).

At block 37701, the process performs determining a sponsor supplied content based upon a set of factors including an adjustment of the gesture. Once a gesture has been made, it may be adjusted (e.g., modified, extended, smeared, smudged, redone) by any mechanism, including, for example, adjusting the gesture itself, or, for example, by modifying what the gesture indicates, for example, using a context menu, selecting a portion of the indicated gesture, and so forth.

FIG. 3.78 is an example flow diagram of example logic illustrating an example embodiment of process 3100 of FIG. 3.1. More particularly, FIG. 3.78 illustrates a process 37800 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 37801, the process performs determining a sponsor supplied content based upon a set of factors including presentation device capabilities. This logic may be performed, for example, by the system attributes determination module 234 of the factor determination module 113 of the GBCPS 110 described with reference to FIG. 2. In some embodiments the GBCPS 110 determines a sponsor supplied content by looking at context information relating to device capabilities. Presentation device capabilities may include, for example, whether the device is connected to speakers or a network such as the Internet, the size, whether the device supports color, is a touch screen, and so forth.

FIG. 3.79 is an example flow diagram of example logic illustrating an example embodiment of process 37800 of FIG. 3.78. More particularly, FIG. 3.79 illustrates a process 37900 that includes the process 37800, wherein the determining a sponsor supplied content based upon a set of factors including presentation device capabilities, further comprises operations performed by or at one or more of the following block(s).

At block 37901, the process performs determining a sponsor supplied content based upon presentation device capabilities including the size of the presentation device. Presentation device capabilities may include, for example, whether the device is connected to speakers or a network such as the Internet, the size of the device, whether the device supports color, is a touch screen, and so forth.

FIG. 3.80 is an example flow diagram of example logic illustrating an example embodiment of process 37800 of FIG. 3.78. More particularly, FIG. 3.80 illustrates a process 38000 that includes the process 37800, wherein the determining a sponsor supplied content based upon a set of factors including presentation device capabilities, further comprises operations performed by or at one or more of the following block(s).

At block 38001, the process performs determining a sponsor supplied content based upon presentation device capabilities including determining whether text or audio is being presented. In addition to determining whether text or audio is being presented, presentation device capabilities may include, for example, whether the device is connected to speakers or a network such as the Internet, the size of the device, whether the device supports color, is a touch screen, and so forth.

FIG. 3.81 is an example flow diagram of example logic illustrating an example embodiment of process 3100 of FIG. 3.1. More particularly, FIG. 3.81 illustrates a process 38100 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 38101, the process performs determining a sponsor supplied content based upon a set of factors including prior history associated with the user. This logic may be performed, for example, by the prior history determination module 232 of the factor determination module 113 of the GBCPS 110 described with reference to FIG. 2. In some embodiments the GBCPS 110 determines a sponsor supplied content by looking at context information relating to prior history associated with the user. Prior history may be associated with (e.g., coincident with, related to, appropriate to, etc.) the user, for example, prior purchase, navigation, or search history or demographic information.

FIG. 3.82 is an example flow diagram of example logic illustrating an example embodiment of process 38100 of FIG. 3.81. More particularly, FIG. 3.82 illustrates a process 38200 that includes the process 38100, wherein the determining a sponsor supplied content based upon a set of factors including prior history associated with the user, further comprises operations performed by or at one or more of the following block(s).

At block 38201, the process performs determining a sponsor supplied content based upon prior history including prior search history associated with the user. Factors such as what content or purchase opportunities the user has reviewed and looked for may be considered. Other factors may be considered as well.

FIG. 3.83 is an example flow diagram of example logic illustrating an example embodiment of process 38100 of FIG. 3.81. More particularly, FIG. 3.83 illustrates a process 38300 that includes the process 38100, wherein the determining a sponsor supplied content based upon a set of factors including prior history associated with the user, further comprises operations performed by or at one or more of the following block(s).

At block 38301, the process performs determining a sponsor supplied content based upon prior history including prior navigation history associated with the user. Factors such as what content or purchase opportunities the user has navigated to may be considered. Other factors may be considered as well.

FIG. 3.84 is an example flow diagram of example logic illustrating an example embodiment of process 38100 of FIG. 3.81. More particularly, FIG. 3.84 illustrates a process 38400 that includes the process 38100, wherein the determining a sponsor supplied content based upon a set of factors including prior history associated with the user, further comprises operations performed by or at one or more of the following block(s).

At block 38401, the process performs determining a sponsor supplied content based upon prior history including prior purchase history associated with the user. Factors such as what products and/or services the user has bought or considered buying (determined, for example, by what the user has viewed) may be considered. Other factors may be considered as well.

FIG. 3.85 is an example flow diagram of example logic illustrating an example embodiment of process 38100 of FIG. 3.81. More particularly, FIG. 3.85 illustrates a process 38500 that includes the process 38100, wherein the determining a sponsor supplied content based upon a set of factors including prior history associated with the user, further comprises operations performed by or at one or more of the following block(s).

At block 38501, the process performs determining a sponsor supplied content based upon prior history including demographic information associated with the user. This logic may be performed, for example, by the prior history determination module 232 of the factor determination module 113 of the GBCPS 110 described with reference to FIG. 2 to determine a set of criteria based upon the demographic history associated with the user. In some embodiments the GBCPS 110 determines a sponsor supplied content by looking at context information relating to this demographic information. Factors such as what the age, gender, location, citizenship, religious preferences (if specified) may be considered. Other factors may be considered as well.

FIG. 3.86 is an example flow diagram of example logic illustrating an example embodiment of process 38500 of FIG. 3.85. More particularly, FIG. 3.86 illustrates a process 38600 that includes the process 38500, wherein the determining a sponsor supplied content based upon prior history including demographic information associated with the user, further comprises operations performed by or at one or more of the following block(s).

At block 38601, the process performs determining a sponsor supplied content based upon demographic information including at least one of age, gender, a location associated with the user, and/or contact information associated with the user. This logic may be performed, for example, by the prior history determination module 232 of the factor determination module 113 of the GBCPS 110 described with reference to FIG. 2 to determine a set of criteria based upon the demographic history associated with the user. In some embodiments the GBCPS 110 determines a sponsor supplied content by looking at context information relating to this demographic information. Factors such as what the age, gender, location, citizenship, religious preferences (if specified) may be considered. Other factors may be considered as well.

FIG. 3.87 is an example flow diagram of example logic illustrating an example embodiment of process 3100 of FIG. 3.1. More particularly, FIG. 3.87 illustrates a process 38700 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 38701, the process performs determining a sponsor supplied content based upon a set of factors including prior device communication history. This logic may be performed, for example, by the system attributes determination module 234 of the factor determination module 113 of the GBCPS 110 described with reference to FIG. 2. In some embodiments the GBCPS 110 determines a sponsor supplied content by looking at context information relating to prior device communication history. Prior device communication history may include aspects such as how often the computing system running the GBCPS 110 has been connected to the Internet, whether multiple client devices are connected to it—some times, at all times, etc., and how often the computing system is connected with various remote search capabilities.

FIG. 3.88 is an example flow diagram of example logic illustrating an example embodiment of process 3100 of FIG. 3.1. More particularly, FIG. 3.88 illustrates a process 38800 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 38801, the process performs determining a sponsor supplied content based upon a set of factors including time of day. This logic may be performed, for example, by the factor determination module 113 of the GBCPS 110 described with reference to FIG. 2 to determine sponsor supplied content based upon time of day. Time of day may include any type of measurement, for example, mins, hours, shifts, day, night, or the like.

FIG. 3.89 is an example flow diagram of example logic illustrating an example embodiment of process 3100 of FIG. 3.1. More particularly, FIG. 3.89 illustrates a process 38900 that includes the process 3100, wherein the dynamically determining sponsor supplied content associated with an opportunity for commercialization that corresponds to at least one of the identified first topic, second topic, object, and/or action further comprises operations performed by or at one or more of the following block(s).

At block 38901, the process performs determining a sponsor supplied content based upon a set of factors, taking into consideration a weight associated with each factor. This logic may be performed, for example, by the factor determination module 113 of the GBCPS 110 described with reference to FIG. 2. For example, In some embodiments some attributes of the gesture may be more important, hence weighted more heavily, than other attributes, such as the prior purchase history of the user. In other embodiments, other factors may have more importance that others, hence weighted more heavily. Any form of weighting, whether explicit or implicit (e.g., numeric, discreet values, adjectives, or the like) may be used.

FIG. 3.90 is an example flow diagram of example logic illustrating an example embodiment of process 3100 of FIG. 3.1. More particularly, FIG. 3.90 illustrates a process 39000 that includes the process 3100, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises operations performed by or at one or more of the following block(s).

At block 39001, the process performs presenting the sponsor supplied content associated with the opportunity for commercialization as a visual overlay on a portion of the presented electronic content. This logic may be performed, for example, by the presentation module 114 of the GBCPS 110 described with reference to FIG. 2. The overlay may be in any form including a pane, window, menu, dialog, frame, etc. and may partially or totally obscure the underlying presented content.

FIG. 3.91 is an example flow diagram of example logic illustrating an example embodiment of process 39000 of FIG. 3.90. More particularly, FIG. 3.91 illustrates a process 39100 that includes the process 39000, wherein the presenting the sponsor supplied content associated with the opportunity for commercialization as a visual overlay on a portion of the presented electronic content, further comprises operations performed by or at one or more of the following block(s).

At block 39101, the process performs making the visual overlay visible using animation techniques. This logic may be performed, for example, by the presentation module 114 of the GBCPS 110 described with reference to FIG. 2. Animation techniques may include any type of animation technique appropriate for the presentation, including, for example, moving a presentation construct from one portion of a presentation device to another, zooming, wiggling, vibrating, giving the appearance of flying, other types of movement, and the like. The animation techniques may include leaving trailing footprint information (e.g., artifacts) for the user to enhance the detection and/or appearance of the animation, may be of varying speeds, involve different shapes, sounds, color, or the like.

FIG. 3.92 is an example flow diagram of example logic illustrating an example embodiment of process 39000 of FIG. 3.90. More particularly, FIG. 3.92 illustrates a process 39200 that includes the process 39000, wherein the presenting the sponsor supplied content associated with the opportunity for commercialization as a visual overlay on a portion of the presented electronic content further comprises operations performed by or at one or more of the following block(s).

At block 39201, the process performs causing the overlay to appear to slide from one side of the presentation device onto the presented content. This logic may be performed, for example, by the presentation module 114 of the GBCPS 110 described with reference to FIG. 2. The overlay may be a window, frame, popup, dialog box, or any other presentation construct that may be made gradually more visible as it is moved into the visible presentation area. FIGS. 1D1-1D8 and 1E1-1E2 show examples of such animation. Once there, the presentation construct may obscure, not obscure, or partially obscure the other presented content. Sliding may include moving smoothly or not. The side of the presentation device may be the physical edge or a virtual edge.

FIG. 3.93 is an example flow diagram of example logic illustrating an example embodiment of process 39200 of FIG. 3.92. More particularly, FIG. 3.93 illustrates a process 39300 that includes the process 39200, wherein the causing the overlay to appear to slide from one side of the presentation device onto the presented content further comprises operations performed by or at one or more of the following block(s).

At block 39301, the process performs displaying sliding artifacts to demonstrate that the overlay is sliding. This logic may be performed, for example, by the presentation module 114 of the GBCPS 110 described with reference to FIG. 2. In some embodiments the process includes showing artifacts as the overlay is sliding into place in order to illustrate movement. Artifacts may be portions or edges of the overlay, repeated as the overlay is moved, such as those shown in FIGS. 1C and 1D1-1D8.

FIG. 3.94 is an example flow diagram of example logic illustrating an example embodiment of process 39000 of FIG. 3.90. More particularly, FIG. 3.94 illustrates a process 39400 that includes the process 39000, wherein the presenting the sponsor supplied content associated with the opportunity for commercialization as a visual overlay on a portion of the presented electronic content further comprises operations performed by or at one or more of the following block(s).

At block 39401, the process performs presenting the overlay as a rectangular overlay. This logic may be performed, for example, by the presentation module 114 of the GBCPS 110 described with reference to FIG. 2. In some embodiments the overlay is shaped as a rectangle.

FIG. 3.95 is an example flow diagram of example logic illustrating an example embodiment of process 39000 of FIG. 3.90. More particularly, FIG. 3.95 illustrates a process 39500 that includes the process 39000, wherein the presenting the sponsor supplied content associated with the opportunity for commercialization as a visual overlay on a portion of the presented electronic content further comprises operations performed by or at one or more of the following block(s).

At block 39501, the process performs presenting the overlay as a non-rectangular overlay. This logic may be performed, for example, by the presentation module 114 of the GBCPS 110 described with reference to FIG. 2. In some embodiments the overlay is shaped as a rectangle.

FIG. 3.96 is an example flow diagram of example logic illustrating an example embodiment of process 39000 of FIG. 3.90. More particularly, FIG. 3.96 illustrates a process 39600 that includes the process 39000, wherein the presenting the sponsor supplied content associated with the opportunity for commercialization as a visual overlay on a portion of the presented electronic content further comprises operations performed by or at one or more of the following block(s).

At block 39601, the process performs presenting the overlay in a manner that resembles the shape of the identified object. This logic may be performed, for example, by the presentation module 114 of the GBCPS 110 described with reference to FIG. 2. In some embodiments the overlay is shaped to approximately or partially follow the contour of the object that is the target of the gesture. For example, if the representation is a product image, the overlay may have edges that follow the contour of product displayed in the image.

FIG. 3.97 is an example flow diagram of example logic illustrating an example embodiment of process 39000 of FIG. 3.90. More particularly, FIG. 3.97 illustrates a process 39700 that includes the process 39000, wherein the presenting the sponsor supplied content associated with the opportunity for commercialization as a visual overlay on a portion of the presented electronic content further comprises operations performed by or at one or more of the following block(s).

At block 39701, the process performs presenting the overlay as a transparent overlay. This logic may be performed, for example, by the presentation module 114 of the GBCPS 110 described with reference to FIG. 2. In some embodiments the overlay is implemented to be transparent so that some portion or all of the content under the overlay shows through. Transparency techniques such as bitblt filters may be used.

FIG. 3.98 is an example flow diagram of example logic illustrating an example embodiment of process 39000 of FIG. 3.90. More particularly, FIG. 3.98 illustrates a process 39800 that includes the process 39000, wherein the presenting the sponsor supplied content associated with the opportunity for commercialization as a visual overlay on a portion of the presented electronic content further comprises operations performed by or at one or more of the following block(s).

At block 39801, the process performs presenting the background of the overlay as a different color than the background of the portion of the presented electronic content. This logic may be performed, for example, by the presentation module 114 of the GBCPS 110 described with reference to FIG. 2. In some embodiments the background (e.g., what lies beneath and around the image or text displayed in the overlay) is a different color so that is potentially easier to distinguish from the presented content, such as the indication of the gestured input.

FIG. 3.99 is an example flow diagram of example logic illustrating an example embodiment of process 39000 of FIG. 3.90. More particularly, FIG. 3.99 illustrates a process 39900 that includes the process 39000, wherein the presenting the sponsor supplied content associated with the opportunity for commercialization as a visual overlay on a portion of the presented electronic content further comprises operations performed by or at one or more of the following block(s).

At block 39901, the process performs presenting the overlay as appearing to occupy only a portion of a presentation construct used to present the presented electronic content. This logic may be performed, for example, by the presentation module 114 of the GBCPS 110 described with reference to FIG. 2. The portion occupied may be a small or large area of the presentation construct (e.g., window, frame, pane, or dialog box) and may be some or all of the presentation construct.

FIG. 3.100 is an example flow diagram of example logic illustrating an example embodiment of process 39000 of FIG. 3.90. More particularly, FIG. 3.100 illustrates a process 310000 that includes the process 39000, wherein the presenting the sponsor supplied content associated with the opportunity for commercialization as a visual overlay on a portion of the presented electronic content further comprises operations performed by or at one or more of the following block(s).

At block 310001, the process performs constructing the overlay at least in part from information from a social network associated with the user. This logic may be performed, for example, by the presentation module 114 of the GBCPS 110 described with reference to FIG. 2. For example, the overlay may be colored, shaped, or the type of overlay or layout chosen based upon preferences of the user noted in the user's social network or preferred by the user's contacts in the user's social network.

FIG. 3.101 is an example flow diagram of example logic illustrating an example embodiment of process 3100 of FIG. 3.1. More particularly, FIG. 3.101 illustrates a process 310100 that includes the process 3100, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises operations performed by or at one or more of the following block(s).

At block 310101, the process performs presenting the sponsor supplied content associated with the opportunity for commercialization in at least one of an auxiliary window, pane, frame, and/or other auxiliary presentation construct. This logic may be performed, for example, by the presentation module 114 of the GBCPS 110 described with reference to FIG. 2. Once generated, the auxiliary presentation construct may be presented in an animated fashion, overlaid upon other content, placed non-contiguously or juxtaposed to other content. See, for example, FIG. 1F.

FIG. 3.102 is an example flow diagram of example logic illustrating an example embodiment of process 310100 of FIG. 3.101. More particularly, FIG. 3.102 illustrates a process 310200 that includes the process 310100, wherein the presenting the sponsor supplied content associated with the opportunity for commercialization in at least one of an auxiliary window, pane, frame, and/or other auxiliary presentation construct further comprises operations performed by or at one or more of the following block(s).

At block 310201, the process performs presenting the sponsor supplied content in an auxiliary presentation construct separated from the presented electronic content. For example, the sponsor supplied content may be presented in a separate window or frame to enable the user to see the original content in addition to the opportunity for commercialization (such as an advertisement). See, for example, FIG. 1F. The separate construct may be overlaid or completely distant and distinct from the presented electronic content.

FIG. 3.103 is an example flow diagram of example logic illustrating an example embodiment of process 310100 of FIG. 3.101. More particularly, FIG. 3.103 illustrates a process 310300 that includes the process 310100, wherein the presenting the sponsor supplied content associated with the opportunity for commercialization in at least one of an auxiliary window, pane, frame, and/or other auxiliary presentation construct further comprises operations performed by or at one or more of the following block(s).

At block 310301, the process performs presenting the sponsor supplied content in an auxiliary presentation construct juxtaposed to the presented electronic content. For example, the sponsor supplied content may be presented in a separate window or frame to enable the user to see the original content alongside the opportunity for commercialization (such as an advertisement). See, for example, FIG. 1F.

FIG. 3.104 is an example flow diagram of example logic illustrating an example embodiment of process 3100 of FIG. 3.1. More particularly, FIG. 3.104 illustrates a process 310400 that includes the process 3100, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises operations performed by or at one or more of the following block(s).

At block 310401, the process performs presenting the sponsor supplied content based upon a social network associated with the user. This logic may be performed, for example, by the presentation module 114 of the GBCPS 110 described with reference to FIG. 2. For example, the type and or content presentation may be selected based upon preferences of the user noted in the user's social network or those preferred by the user's contacts in the user's social network. For example, if the user's “friends” insist on all advertisements being shown in separate windows, then the opportunity for commercialization presented to this user may be shown (by default) that way as well.

FIG. 3.105 is an example flow diagram of example logic illustrating an example embodiment of process 3100 of FIG. 3.1. More particularly, FIG. 3.105 illustrates a process 310500 that includes the process 3100, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises operations performed by or at one or more of the following block(s).

At block 310501, the process performs presenting the sponsor supplied content as a portion of a web site. This logic may be performed, for example, by the presentation module 114 of the GBCPS 110 described with reference to FIG. 2. In some embodiments the GBCPS 110 presents the sponsor supplied content within the context of a website, so that the opportunity for commercialization appears to be associated with the web site.

FIG. 3.106 is an example flow diagram of example logic illustrating an example embodiment of process 3100 of FIG. 3.1. More particularly, FIG. 3.106 illustrates a process 310600 that includes the process 3100, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises operations performed by or at one or more of the following block(s).

At block 310601, the process performs presenting the sponsor supplied content as a part of an electronic document. This logic may be performed, for example, by the presentation module 114 of the GBCPS 110 described with reference to FIG. 2. In some embodiments the GBCPS 110 presents the sponsor supplied content within the context of a document, so that the opportunity for commercialization appears to be associated with the document.

FIG. 3.107 is an example flow diagram of example logic illustrating an example embodiment of process 3100 of FIG. 3.1. More particularly, FIG. 3.107 illustrates a process 310700 that includes the process 3100, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises operations performed by or at one or more of the following block(s).

At block 310701, the process performs presenting the sponsor supplied content as at least one of an image, text, and/or utterance. This logic may be performed, for example, by the presentation module 114 of the GBCPS 110 described with reference to FIG. 2. In some embodiments the GBCPS 110 presents the sponsor supplied content as an image, text, sound, phrase, utterance, grunt, etc.

FIG. 3.108 is an example flow diagram of example logic illustrating an example embodiment of process 3100 of FIG. 3.1. More particularly, FIG. 3.108 illustrates a process 310800 that includes the process 3100, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises operations performed by or at one or more of the following block(s).

At block 310801, the process performs presenting the determining sponsor supplied content in conjunction with the identified first topic, second topic, object, and/or action as not part of a purchasing activity. This logic may be performed, for example, by the presentation module 114 of the GBCPS 110 described with reference to FIG. 2. In some embodiments the GBCPS 110 presents the sponsor supplied content in but not as part of a purchase. For example, the GBCPS 110 may present the sponsor supplied content in response to informational queries, browsing, navigating, etc.

FIG. 3.109 is an example flow diagram of example logic illustrating an example embodiment of process 3100 of FIG. 3.1. More particularly, FIG. 3.109 illustrates a process 310900 that includes the process 3100, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises operations performed by or at one or more of the following block(s).

At block 310901, the process performs presenting the sponsor supplied content via at least one of a mobile device, a hand-held device, a device embedded as part of the computing system, electronic panel, electronic display, electronic control panel, and/or a remote device associated with the computing system. This logic may be performed, for example, by the specific device handlers 212 of the input module 111 of the GBCPS 110 described with reference to FIG. 2.

FIG. 3.110 is an example flow diagram of example logic illustrating an example embodiment of process 3100 of FIG. 3.1. More particularly, FIG. 3.110 illustrates a process 311000 that includes the process 3100, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises operations performed by or at one or more of the following block(s).

At block 311001, the process performs presenting the sponsor supplied content via at least one of a speaker, electronic reader, or a Braille printer. This logic may be performed, for example, by the specific device handlers 212 of the input module 111 of the GBCPS 110 described with reference to FIG. 2.

FIG. 3.111 is an example flow diagram of example logic illustrating an example embodiment of process 3100 of FIG. 3.1. More particularly, FIG. 3.111 illustrates a process 311100 that includes the process 3100, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises operations performed by or at one or more of the following block(s).

At block 311101, the process performs presenting the sponsor supplied content on a presentation device that is separate and distinct from the presentation device used to present the one or more instances of electronic content. This logic may be performed, for example, by the specific device handlers 212 of the input module 111 of the GBCPS 110 described with reference to FIG. 2. There may be a separate device used to present the sponsor supplied content or the opportunity for commercialization.

FIG. 3.112 is an example flow diagram of example logic illustrating an example embodiment of process 3100 of FIG. 3.1. More particularly, FIG. 3.112 illustrates a process 311200 that includes the process 3100, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises operations performed by or at one or more of the following block(s).

At block 311201, the process performs presenting the sponsor supplied content on a same device as the presentation device used to present the one or more instances of electronic content. This logic may be performed, for example, by the specific device handlers 212 of the input module 111 of the GBCPS 110 described with reference to FIG. 2. The same device may be used to present the sponsor supplied content or the opportunity for commercialization as the original electronic content.

FIG. 3.113 is an example flow diagram of example logic illustrating an example embodiment of process 3100 of FIG. 3.1. More particularly, FIG. 3.113 illustrates a process 311300 that includes the process 3100, wherein the presenting via a presentation device associated with the computing system one or more instances of electronic content containing information relating to a first topic in which a user has indicated an interest further comprises operations performed by or at one or more of the following block(s).

At block 311301, the process performs presenting one or more instances of electronic content that contains text. For example, the presenting may include a picture of a product or service along with a description of the good and/or service, including for example, a price, location, quantity, descriptors (e.g., color, size, etc.), or the like.

FIG. 3.114 is an example flow diagram of example logic illustrating an example embodiment of process 3100 of FIG. 3.1. More particularly, FIG. 3.114 illustrates a process 311400 that includes the process 3100, wherein the presenting via a presentation device associated with the computing system one or more instances of electronic content containing information relating to a first topic in which a user has indicated an interest further comprises operations performed by or at one or more of the following block(s).

At block 311401, the process performs presenting one or more instances of electronic content that contains an image. For example, the presenting may include a picture that shows attributes of the product and/or service such as color, size, location, brand, availability, rating, and the like.

FIG. 3.115 is an example flow diagram of example logic illustrating an example embodiment of process 3100 of FIG. 3.1. More particularly, FIG. 3.115 illustrates a process 311500 that includes the process 3100, wherein the presenting via a presentation device associated with the computing system one or more instances of electronic content containing information relating to a first topic in which a user has indicated an interest further comprises operations performed by or at one or more of the following block(s).

At block 311501, the process performs presenting one or more instances of electronic content that contains audio. For example, the presenting may include an audio clip related to the product for example, an explanation of the product and/or service such as how to use it, testimonials, or the like.

FIG. 3.116 is an example flow diagram of example logic illustrating an example embodiment of process 3100 of FIG. 3.1. More particularly, FIG. 3.116 illustrates a process 311600 that includes the process 3100, wherein the receiving, from an input device capable of providing gesture input, an indication of a user inputted gesture that corresponds to an indicated portion of the presented electronic content further comprises operations performed by or at one or more of the following block(s).

At block 311601, the process performs receiving a user inputted gesture that approximates a circle shape. This logic may be performed, for example, by the device handlers 212 of the input module 111 of the GBCPS 110 described with reference to FIG. 2 to detect whether a received gesture is in a form that approximates a circle shape.

FIG. 3.117 is an example flow diagram of example logic illustrating an example embodiment of process 3100 of FIG. 3.1. More particularly, FIG. 3.117 illustrates a process 311700 that includes the process 3100, wherein the receiving, from an input device capable of providing gesture input, an indication of a user inputted gesture that corresponds to an indicated portion of the presented electronic content further comprises operations performed by or at one or more of the following block(s).

At block 311701, the process performs receiving a user inputted gesture that approximates an oval shape. This logic may be performed, for example, by the device handlers 212 of the input module 111 of the GBCPS 110 described with reference to FIG. 2 to detect whether a received gesture is in a form that approximates an oval shape

FIG. 3.118 is an example flow diagram of example logic illustrating an example embodiment of process 3100 of FIG. 3.1. More particularly, FIG. 3.118 illustrates a process 311800 that includes the process 3100, wherein the receiving, from an input device capable of providing gesture input, an indication of a user inputted gesture that corresponds to an indicated portion of the presented electronic content further comprises operations performed by or at one or more of the following block(s).

At block 311801, the process performs receiving a user inputted gesture that approximates a closed path. This logic may be performed, for example, by the device handlers 212 of the input module 111 of the GBCPS 110 described with reference to FIG. 2 to detect whether a received gesture is in a form that approximates a closed path of points and/or line segments.

FIG. 3.119 is an example flow diagram of example logic illustrating an example embodiment of process 3100 of FIG. 3.1. More particularly, FIG. 3.119 illustrates a process 311900 that includes the process 3100, wherein the receiving, from an input device capable of providing gesture input, an indication of a user inputted gesture that corresponds to an indicated portion of the presented electronic content further comprises operations performed by or at one or more of the following block(s).

At block 311901, the process performs receiving a user inputted gesture that approximates a polygon. This logic may be performed, for example, by the device handlers 212 of the input module 111 of the GBCPS 110 described with reference to FIG. 2 to detect whether a received gesture is in a form that approximates a polygon.

FIG. 3.120 is an example flow diagram of example logic illustrating an example embodiment of process 3100 of FIG. 3.1. More particularly, FIG. 3.120 illustrates a process 312000 that includes the process 3100, wherein the receiving, from an input device capable of providing gesture input, an indication of a user inputted gesture that corresponds to an indicated portion of the presented electronic content further comprises operations performed by or at one or more of the following block(s).

At block 312001, the process performs receiving an audio gesture. This logic may be performed, for example, by the gesture input detection and resolution module 210 of the input module 111 of the GBCPS 110 described with reference to FIG. 2 to detect whether a received gesture is an audio gesture, such as received via audio device, microphone 20b.

FIG. 3.121 is an example flow diagram of example logic illustrating an example embodiment of process 312000 of FIG. 3.120. More particularly, FIG. 3.121 illustrates a process 312100 that includes the process 312000, wherein the receiving an audio gesture further comprises operations performed by or at one or more of the following block(s).

At block 312101, the process performs receiving an audio gesture that is an uttered word, phrase, or sound. This logic may be performed, for example, by the gesture input detection and resolution module 210 of the input module 111 of the GBCPS 110 described with reference to FIG. 2 to detect whether a received audio gesture, such as received via audio device, microphone 20b, indicates (e.g., designates or otherwise selects) a word or phrase indicating some portion of the presented content.

FIG. 3.122 is an example flow diagram of example logic illustrating an example embodiment of process 312000 of FIG. 3.120. More particularly, FIG. 3.122 illustrates a process 312200 that includes the process 312000, wherein the receiving an audio gesture further comprises operations performed by or at one or more of the following block(s).

At block 312201, the process performs receiving an audio gesture that specifies a direction. This logic may be performed, for example, by the gesture input detection and resolution module 210 of the input module 111 of the GBCPS 110 described with reference to FIG. 2 to detect whether a direction received from an audio input device, such as audio input device 20b. The direction may be a single letter, number, word, phrase, or any type of instruction or indication of where to move a cursor or locator device.

FIG. 3.123 is an example flow diagram of example logic illustrating an example embodiment of process 312000 of FIG. 3.120. More particularly, FIG. 3.123 illustrates a process 312300 that includes the process 312000, wherein the receiving an audio gesture further comprises operations performed by or at one or more of the following block(s).

At block 312301, the process performs receiving an audio gesture by at least one of a mouse, a touch sensitive display, a wireless device, a human body part, a microphone, a stylus, and/or a pointer. This logic may be performed, for example, by the gesture input detection and resolution module 210 of the input module 111 of the GBCPS 110 described with reference to FIG. 2 to detect and resolve audio gesture input from, for example, devices 20*.

FIG. 3.124 is an example flow diagram of example logic illustrating an example embodiment of process 3100 of FIG. 3.1. More particularly, FIG. 3.124 illustrates a process 312400 that includes the process 3100, wherein the receiving, from an input device capable of providing gesture input, an indication of a user inputted gesture that corresponds to an indicated portion of the presented electronic content further comprises operations performed by or at one or more of the following block(s).

At block 312401, the process performs receiving the indication of the user inputted gestured from an input device that comprises at least one of a mouse, a touch sensitive display, a wireless device, a human body part, a microphone, a stylus, and/or a pointer. This logic may be performed, for example, by the specific device handlers 212 of the input module 111 of the GBCPS 110 described with reference to FIG. 2 to detect and resolve gesture input from, for example, devices 20*. Other input devices may also be accommodated. Wireless devices may include devices such as cellular phones, notebooks, mobile devices, tablets, computers, remote controllers, and the like. Human body parts may include, for example, a head, a finger, an arm, a leg, and the like, especially useful for those challenged to provide gestures by other means. Touch sensitive displays may include, for example, touch sensitive screens that are part of other devices (e.g., in a computer or in a phone) or that are standalone devices.

FIG. 3.125 is an example flow diagram of example logic illustrating an example embodiment of process 3100 of FIG. 3.1. More particularly, FIG. 3.125 illustrates a process 312500 that includes the process 3100, wherein the presenting via a presentation device associated with the computing system one or more instances of electronic content containing information relating to a first topic in which a user has indicated an interest further comprises operations performed by or at one or more of the following block(s).

At block 312501, the process performs presenting the one or more instances of electronic content via a browser. This logic may be performed, for example, by the specific device handlers 212 of the input module 111 of the GBCPS 110 described with reference to FIG. 2.

FIG. 3.126 is an example flow diagram of example logic illustrating an example embodiment of process 3100 of FIG. 3.1. More particularly, FIG. 3.126 illustrates a process 312600 that includes the process 3100, wherein the presenting via a presentation device associated with the computing system one or more instances of electronic content containing information relating to a first topic in which a user has indicated an interest further comprises operations performed by or at one or more of the following block(s).

At block 312601, the process performs presenting the one or more instances of electronic content via at least one of a mobile device, a hand-held device, a device embedded as part of the computing system, and/or a remote device associated with the computing system. This logic may be performed, for example, by the specific device handlers 212 of the input module 111 of the GBCPS 110 described with reference to FIG. 2.

FIG. 3.127 is an example flow diagram of example logic illustrating an example embodiment of process 3100 of FIG. 3.1. More particularly, FIG. 3.127 illustrates a process 312700 that includes the process 3100, wherein the presenting via a presentation device associated with the computing system one or more instances of electronic content containing information relating to a first topic in which a user has indicated an interest further comprises operations performed by or at one or more of the following block(s).

At block 312701, the process performs presenting the one or more instances of electronic content via at least one of a speaker, electronic reader, or a Braille printer. This logic may be performed, for example, by the specific device handlers 212 of the input module 111 of the GBCPS 110 described with reference to FIG. 2.

FIG. 3.128 is an example flow diagram of example logic illustrating an example embodiment of process 3100 of FIG. 3.1. More particularly, FIG. 3.128 illustrates a process 312800 that includes the process 3100, wherein the presenting via a presentation device associated with the computing system one or more instances of electronic content containing information relating to a first topic in which a user has indicated an interest further comprises operations performed by or at one or more of the following block(s).

At block 312801, the process performs presenting the one or more instances of electronic content presented via a presentation device associated with at least one of a computer, notebook, tablet, wireless device, cellular phone, mobile device, hand-held device, electronic control panel, electronic display, electronic appliance, and/or wired device. This logic may be performed, for example, by the input module 111 of the GBCPS 110 described with reference to FIG. 2. In some embodiments, the electronic control panel, display, or appliance may include interfaces provided on house-hold type appliances such as a refrigerator or television, or work type appliances such as a copier, scanner, etc.

FIG. 3.129 is an example flow diagram of example logic illustrating an example embodiment of process 3100 of FIG. 3.1. More particularly, FIG. 3.129 illustrates a process 312900 that includes the process 3100, and which further includes operations performed by or at the following block(s).

At block 312901, the process performs performing the method by a client. As described elsewhere, a client may be hardware, software, or firmware, physical or virtual, and may be part or the whole of a computing system. A client may be an application or a device.

FIG. 3.130 is an example flow diagram of example logic illustrating an example embodiment of process 3100 of FIG. 3.1. More particularly, FIG. 3.130 illustrates a process 313000 that includes the process 3100, and which further includes operations performed by or at the following block(s).

At block 313001, the process performs performing the method by a server. As described elsewhere, a server may be hardware, software, or firmware, physical or virtual, and may be part or the whole of a computing system. A server may be service as well as a system.

### Example Computing System

FIG. 4 is an example block diagram of an example computing system for practicing embodiments of a Gesture Based Content Presentation System as described herein. Note that a general purpose or a special purpose computing system suitably instructed may be used to implement an GBCPS, such as GBCPS 110 of FIG. 1G. Further, the GBCPS may be implemented in software, hardware, firmware, or in some combination to achieve the capabilities described herein.

The computing system 100 may comprise one or more server and/or client computing systems and may span distributed locations. In addition, each block shown may represent one or more such blocks as appropriate to a specific embodiment or may be combined with other blocks. Moreover, the various blocks of the GBCPS 110 may physically reside on one or more machines, which use standard (e.g., TCP/IP) or proprietary interprocess communication mechanisms to communicate with each other.

In the embodiment shown, computer system 100 comprises a computer memory (“memory”) 101, a display 402, one or more Central Processing Units (“CPU”) 403, Input/Output devices 404 (e.g., keyboard, mouse, CRT or LCD display, etc.), other computer-readable media 405, and one or more network connections 406. The GBCPS 110 is shown residing in memory 101. In other embodiments, some portion of the contents, some of, or all of the components of the GBCPS 110 may be stored on and/or transmitted over the other computer-readable media 405. The components of the GBCPS 110 preferably execute on one or more CPUs 403 and manage providing one or more opportunities for commercialization, as described herein. Other code or programs 430 and potentially other data stores, such as data repository 420, also reside in the memory 101, and preferably execute on one or more CPUs 403. Of note, one or more of the components in FIG. 4 may not be present in any specific implementation. For example, some embodiments embedded in other software may not provide means for user input or display.

In a typical embodiment, the GBCPS 110 includes one or more input modules 111, one or more opportunity for commercialization determination modules 112, one or more factor determination modules 113, and one or more presentation modules 114. In at least some embodiments, some data is provided external to the GBCPS 110 and is available, potentially, over one or more networks 30. Other and/or different modules may be implemented. In addition, the GBCPS 110 may interact via a network 30 with application or client code 455 that can absorb opportunity for commercialization results or indicated gesture information, for example, for other purposes, one or more client computing systems or client devices 20*, and/or one or more third-party content provider systems 465, such as third party advertising systems or other purveyors of opportunities for commercialization. Also, of note, the history data repository 44 may be provided external to the GBCPS 110 as well, for example in a knowledge base accessible over one or more networks 30.

In an example embodiment, components/modules of the GBCPS 110 are implemented using standard programming techniques. However, a range of programming languages known in the art may be employed for implementing such example embodiments, including representative implementations of various programming language paradigms, including but not limited to, object-oriented (e.g., Java, C++, C#, Smalltalk, etc.), functional (e.g., ML, Lisp, Scheme, etc.), procedural (e.g., C, Pascal, Ada, Modula, etc.), scripting (e.g., Perl, Ruby, Python, JavaScript, VBScript, etc.), declarative (e.g., SQL, Prolog, etc.), etc.

The embodiments described above may also use well-known or proprietary synchronous or asynchronous client-server computing techniques. However, the various components may be implemented using more monolithic programming techniques as well, for example, as an executable running on a single CPU computer system, or alternately decomposed using a variety of structuring techniques known in the art, including but not limited to, multiprogramming, multithreading, client-server, or peer-to-peer, running on one or more computer systems each having one or more CPUs. Some embodiments are illustrated as executing concurrently and asynchronously and communicating using message passing techniques. Equivalent synchronous embodiments are also supported by an GBCPS implementation.

In addition, programming interfaces to the data stored as part of the GBCPS 110 (e.g., in the data repositories 44 and 41) can be available by standard means such as through C, C++, C#, Visual Basic.NET and Java APIs; libraries for accessing files, databases, or other data repositories; through scripting languages such as XML; or through Web servers, FTP servers, or other types of servers providing access to stored data. The repositories 44 and 41 may be implemented as one or more database systems, file systems, or any other method known in the art for storing such information, or any combination of the above, including implementation using distributed computing techniques.

Also the example GBCPS 110 may be implemented in a distributed environment comprising multiple, even heterogeneous, computer systems and networks. Different configurations and locations of programs and data are contemplated for use with techniques of described herein. In addition, the server and/or client components may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) etc. Other variations are possible. Also, other functionality could be provided by each component/module, or existing functionality could be distributed amongst the components/modules in different ways, yet still achieve the functions of an GBCPS.

Furthermore, in some embodiments, some or all of the components of the GBCPS 110 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

All of the above U.S. patents, U.S. patent application publications, U.S. patent applications, foreign patents, foreign patent applications and non-patent publications referred to in this specification and/or listed in the Application Data Sheet, are incorporated herein by reference, in their entireties.

From the foregoing it will be appreciated that, although specific embodiments have been described herein for purposes of illustration, various modifications may be made without deviating from the spirit and scope of the claims. For example, the methods and systems for presenting sponsor supplied content associated with commercial opportunities in a gesture-based user interface discussed herein are applicable to other architectures other than a windowed or client-server architecture. Also, the methods and systems discussed herein are applicable to differing protocols, communication media (optical, wireless, cable, etc.) and devices (such as wireless handsets, electronic organizers, personal digital assistants, tablets, portable email machines, game machines, pagers, navigation devices such as GPS receivers, etc.).

1. A method in a computing system for presenting opportunities for commercialization in conjunction with browsing and/or searching for information, the method comprising:
presenting via a presentation device associated with the computing system one or more instances of electronic content containing information relating to a first topic in which a user has indicated an interest;
receiving, from an input device capable of providing gesture input, an indication of a user inputted gesture that corresponds to an indicated portion of the presented electronic content, the indicated portion of electronic content identifying a second topic related to the first topic, an object related to the first topic, and/or an action related to the first topic;
dynamically determining sponsor supplied content associated with an opportunity for commercialization that corresponds to at least one of the identified first topic, second topic, object, and/or action; and
presenting the determined sponsor supplied content associated with the opportunity for commercialization in conjunction with the identified first topic, second topic, object, and/or action, therein providing an opportunity for commercialization that relates to the first topic to which the user has indicated interest.

2. The method of claim 1, wherein the presenting via a presentation device associated with the computing system one or more instances of electronic content containing information relating to a first topic in which a user has indicated an interest further comprises:
presenting one or more web pages and/or portions of an electronic document.

3. (canceled)

4. The method of claim 1, wherein the presenting via a presentation device associated with the computing system one or more instances of electronic content containing information relating to a first topic in which a user has indicated an interest further comprises:
presenting electronic content containing information indicating that the user has an interest to seek knowledge, buy something, and/or seek additional information.

5. The method of claim 1, wherein the presenting via a presentation device associated with the computing system one or more instances of electronic content containing information relating to a first topic in which a user has indicated an interest further comprises:
presenting one or more instances of electronic content in response to the user submitting a query.

6. The method of claim 5, wherein the dynamically determining sponsor supplied content associated with an opportunity for commercialization that corresponds to at least one of the identified first topic, second topic, object, and/or action further comprises:
determining sponsor supplied content and/or an opportunity for commercialization that provides an answer to the query, will aid the user in answering the query, and/or that offers access to an anecdote, story, article, book, and/or document relating to the query.

7.-8. (canceled)

9. The method of claim 1, wherein the receiving, from an input device capable of providing gesture input, an indication of a user inputted gesture that corresponds to an indicated portion of the presented electronic content further comprises:
receiving an indication of a user inputted gesture that corresponds to an indicated portion of the presented electronic content identifying a second topic that is responsive to a search for further information relating to the first topic.

10. The method of claim 1, wherein the receiving, from an input device capable of providing gesture input, an indication of a user inputted gesture that corresponds to an indicated portion of the presented electronic content further comprises:
receiving an indication of a user inputted gesture that corresponds to an indicated portion of the presented electronic content identifying an object and/or an action associated with a product and/or service that the user can purchase or bid on.

11. The method of claim 1, wherein the receiving, from an input device capable of providing gesture input, an indication of a user inputted gesture that corresponds to an indicated portion of the presented electronic content further comprises:
receiving an indication of a user inputted gesture that corresponds to an indicated portion of the presented electronic content identifying an object and/or an action associated with a product and/or service that the user can visit or obtain more information about.

12. The method of claim 1, wherein the dynamically determining sponsor supplied content associated with an opportunity for commercialization that corresponds to at least one of the identified first topic, second topic, object, and/or action further comprises:
determining sponsor supplied content and/or an opportunity for commercialization by at least one of predicting what the user is interested in based upon historical data, looking up information, and/or based upon a statistical model.

13. The method of claim 12, wherein the dynamically determining sponsor supplied content associated with an opportunity for commercialization that corresponds to at least one of the identified first topic, second topic, object, and/or action further comprises:
determining sponsor supplied content and/or an opportunity for commercialization by predicting what the user is interested in based upon or by looking up information including historical data that includes at least one of user data, navigation data, data from other users similarly situated, related entity data, and/or values of the one or more of the set of factors.

14. (canceled)

15. The method of claim 12, wherein the dynamically determining sponsor supplied content associated with an opportunity for commercialization that corresponds to at least one of the identified first topic, second topic, object, and/or action further comprises:
determining sponsor supplied content and/or an opportunity for commercialization by using a statistical model that indicates a likelihood of at least one of where the user is likely to navigate to or a next topic, object, or action the user is likely to explore.

16. The method of claim 15, wherein the determining sponsor supplied content and/or an opportunity for commercialization by using a statistical model that indicates a likelihood of at least one of where the user is likely to navigate to or a next topic, object, or action the user is likely to explore further comprises:
determining sponsor supplied content and/or an opportunity for commercialization using a predictive statistical model that includes at least one of a decision tree, neural network, Bayesian network.

17. The method of claim 1, wherein the dynamically determining sponsor supplied content associated with an opportunity for commercialization that corresponds to at least one of the identified first topic, second topic, object, and/or action further comprises:
determining sponsor supplied content and/or an opportunity for commercialization by examination of navigation history of the user and comparing the navigation history of the user with the navigation history of other users to determine one or more likely next topics the user is likely to explore.

18. (canceled)

19. The method of claim 1, wherein the dynamically determining sponsor supplied content associated with an opportunity for commercialization that corresponds to at least one of the identified first topic, second topic, object, and/or action further comprises:
determining the sponsor supplied content associated with an opportunity for commercialization in advance of receiving an indication of the gestured input.

20. (canceled)

21. The method of claim 1, wherein the dynamically determining sponsor supplied content associated with an opportunity for commercialization that corresponds to at least one of the identified first topic, second topic, object, and/or action further comprises:
determining the sponsor supplied content associated with an opportunity for commercialization by retrieving the content from a storage device associated with the computing system.

22. The method of claim 1, further comprising: dynamically determining the sponsor supplied content and/or the opportunity for commercialization in near real-time after receiving the user inputted gesture.

23. The method of claim 22, wherein the dynamically determining sponsor supplied content associated with an opportunity for commercialization that corresponds to at least one of the identified first topic, second topic, object, and/or action further comprises:
determining that the electronic content relates to a live event.

24.-25. (canceled)

26. The method of claim 22, wherein the dynamically determining sponsor supplied content associated with an opportunity for commercialization that corresponds to at least one of the identified first topic, second topic, object, and/or action further comprises:
determining the sponsor supplied content and/or the opportunity for commercialization to one or more sponsors using real-time bidding.

27. (canceled)

28. The method of claim 1, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises:
presenting the determined sponsor supplied content associated with the opportunity for commercialization in conjunction with identified first topic, second topic, object, and/or action with a time lag after the gestured input has been received.

29.-30. (canceled)

31. The method of claim 1, further comprising: charging a sponsor based upon a likelihood the determined sponsor supplied content and/or opportunity for commercialization will be participated in by the user.

32. The method of claim 1, further comprising: charging a sponsor based upon presence and/or values of one or more of a set of factors.

33. The method of claim 1, wherein the dynamically determining sponsor supplied content associated with an opportunity for commercialization that corresponds to at least one of the identified first topic, second topic, object, and/or action further comprises:
determining sponsor supplied content and/or an opportunity for commercialization that provides access to an anecdote, story, article, book, and/or document.

34. The method of claim 1, wherein the dynamically determining sponsor supplied content associated with an opportunity for commercialization that corresponds to at least one of the identified first topic, second topic, object, and/or action further comprises:
determining sponsor supplied content and/or an opportunity for commercialization that provides access to a product and/or service related to identified first topic, second topic, object, and/or action.

35. The method of claim 1, wherein the dynamically determining sponsor supplied content associated with an opportunity for commercialization that corresponds to at least one of the identified first topic, second topic, object, and/or action further comprises:
determining sponsor supplied content associated with an opportunity for commercialization that provides a best match to the at least one of the identified first topic, second topic, object, and/or action.

36. The method of claim 35, wherein the determining sponsor supplied content associated with an opportunity for commercialization that provides a best match to the at least one of the identified first topic, second topic, object, and/or action further comprises:
determining which sponsor supplied content and/or opportunity for commercialization provides a cheapest price related to the identified first topic, the second topic, the object, and/or the action, a result that is closest in location, and/or a result that is most similar in content to the identified first topic, the second topic, the object, and/or the action.

37.-44. (canceled)

45. The method of claim 1, wherein the dynamically determining sponsor supplied content associated with an opportunity for commercialization that corresponds to at least one of the identified first topic, second topic, object, and/or action further comprises:
receiving sponsor supplied content from an advertising server.

46. The method of claim 1, wherein the dynamically determining sponsor supplied content associated with an opportunity for commercialization that corresponds to at least one of the identified first topic, second topic, object, and/or action further comprises:
determining sponsor supplied content that includes content received from an entity other than the sponsor.

47. The method of claim 46, wherein the determining sponsor supplied content that includes content received from an entity other than the sponsor further comprises:
determining sponsor supplied content that includes content received via an interface for accessing context specific content and/or an application programming interface.

48.-50. (canceled)

51. The method of claim 1, wherein the dynamically determining sponsor supplied content associated with an opportunity for commercialization that corresponds to at least one of the identified first topic, second topic, object, and/or action further comprises:
determining a sponsor supplied content that includes one or more of advertising content, a game, interactive entertainment, a computer-assisted competition, a bidding opportunity, a documentary, help text, an indication of price, textual content, an image, a video, and/or auditory content.

52. The method of claim 1, wherein the dynamically determining sponsor supplied content associated with an opportunity for commercialization that corresponds to at least one of the identified first topic, second topic, object, and/or action further comprises:
receiving an indication of a request from a not-for-profit organization as the sponsor supplied content.

53. The method of claim 1, wherein the dynamically determining sponsor supplied content associated with an opportunity for commercialization that corresponds to at least one of the identified first topic, second topic, object, and/or action further comprises:
receiving an indication of a person, place, or thing as the sponsor supplied content.

54. The method of claim 1, wherein the dynamically determining sponsor supplied content associated with an opportunity for commercialization that corresponds to at least one of the identified first topic, second topic, object, and/or action further comprises:
receiving text, an image, and/or audio as the sponsor supplied content.

55. The method of claim 1, wherein the dynamically determining sponsor supplied content associated with an opportunity for commercialization that corresponds to at least one of the identified first topic, second topic, object, and/or action further comprises:
determining sponsor supplied content that includes context specific content based at least in part on values of one or more of a set of factors.

56. (canceled)

57. The method of claim 1, wherein the dynamically determining sponsor supplied content associated with an opportunity for commercialization that corresponds to at least one of the identified first topic, second topic, object, and/or action further comprises:
determining an indication of at least one advertisement, purchase and/or an offer as the sponsor supplied content.

58.-59. (canceled)

60. The method of claim 1, wherein the dynamically determining sponsor supplied content associated with an opportunity for commercialization that corresponds to at least one of the identified first topic, second topic, object, and/or action further comprises:
determining an indication of interactive entertainment, a role-playing game, a computer-assisted competition, and/or a bidding opportunity as the sponsor supplied content.

61.-65. (canceled)

66. The method of claim 1, wherein the dynamically determining sponsor supplied content associated with an opportunity for commercialization that corresponds to at least one of the identified first topic, second topic, object, and/or action further comprises:
receiving the sponsor supplied content as at least one of a word, a phrase, an utterance, an image, a video, a pattern, an audio signal, a location, a pointer, a symbol, and/or another type of reference.

67.-68. (canceled)

69. The method of claim 1, wherein the dynamically determining sponsor supplied content associated with an opportunity for commercialization that corresponds to at least one of the identified first topic, second topic, object, and/or action further comprises:
determining a sponsor supplied content based upon a set of factors that include context of other text, graphics, and/or objects within the presented content.

70. The method of claim 1, wherein the dynamically determining sponsor supplied content associated with an opportunity for commercialization that corresponds to at least one of the identified first topic, second topic, object, and/or action further comprises:
determining a sponsor supplied content based upon a set of factors including an attribute of the gesture, presentation device capabilities, prior history associated with the user, prior device communication history, time of day.

71.-89. (canceled)

90. The method of claim 1, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises:
presenting the sponsor supplied content associated with the opportunity for commercialization as a visual overlay on a portion of the presented electronic content.

91.-100. (canceled)

101. The method of claim 1, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises:
presenting the sponsor supplied content associated with the opportunity for commercialization in at least one of an auxiliary window, pane, frame, and/or other auxiliary presentation construct.

102-103. (canceled)

104. The method of claim 1, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises:
presenting the sponsor supplied content based upon a social network associated with the user.

105.-107. (canceled)

108. The method of claim 1, wherein the presenting the determined sponsor supplied content associated with the opportunity for commercialization in conjunction with the identified first topic, second topic, object, and/or action, therein providing an opportunity for commercialization that relates to the first topic to which the user has indicated interest further comprises:
presenting the determining sponsor supplied content in conjunction with the identified first topic, second topic, object, and/or action as not part of a purchasing activity.

109.-115. (canceled)

116. The method of claim 1, wherein the receiving, from an input device capable of providing gesture input, an indication of a user inputted gesture that corresponds to an indicated portion of the presented electronic content further comprises:
receiving a user inputted gesture that approximates a at least one of a circle shape, an oval shape, a closed path, and/or a polygon.

117.-119. (canceled)

120. The method of claim 1, wherein the receiving, from an input device capable of providing gesture input, an indication of a user inputted gesture that corresponds to an indicated portion of the presented electronic content further comprises:
receiving an audio gesture.

121.-127. (canceled)

128. The method of claim 1, wherein the presenting via a presentation device associated with the computing system one or more instances of electronic content containing information relating to a first topic in which a user has indicated an interest further comprises:
presenting the one or more instances of electronic content presented via a presentation device associated with at least one of a speaker, electronic reader, Braille printer, computer, notebook, tablet, wireless device, cellular phone, mobile device, hand-held device, electronic control panel, electronic display, electronic appliance, and/or wired device, mobile device, hand-held device, device embedded as part of the computing system, and/or remote device associated with the computing system.

129. The method of claim 1, further comprising:
performing the method by a client or by a server.

130.-390. (canceled)
